(19) United States
(12) Patent Application Publication
(10) Pub. No.: US 2001/0024178 A1
(43) Pub. Date: Sep. 27, 2001

(54) Display system and method for managing display

(75) Inventors: Yukihisa Takeuchi, Nagoya (JP); Tsutomu Nanataki, Nagoya (JP); Iwao Ohwada, Nagoya (JP)

Correspondence Address: BURR & BROWN, PO BOX 7068, SYRACUSE, NY, 13261-7068, US

(73) Assignee: NGK Insulators, Ltd.

(21) Appl. No.: 09/803,091

(22) Filed: Mar. 8, 2001

(30) Foreign Application Priority Data
Mar. 10, 2000 (JP) 2000-067778
Dec. 25, 2000 (JP) 2000-393396

(51) Int. Cl. G09G 3/20

(52) U.S. Cl. 345/55

(57) ABSTRACT

A display system comprises an interface circuit for receiving various data from a network to make output to a downstream circuit system; a data separation circuit for making separation from data outputted from the interface circuit into a file (still picture file and moving picture file) concerning image and control data; an output control circuit for making control (control for still picture and control for moving picture) for a display controller, for example, in a unit of display component on the basis of the control data from the data separation circuit; and a compressed file decoder circuit installed upstream from an image data-processing circuit, for expanding the compressed file concerning image to make restoration into still picture data and moving picture data.

### BACKGROUND OF THE INVENTION

1. Field of the Invention

The present invention relates to a display system including a display and a method for managing a display. In particular, the present invention relates to a display system and a method for managing a display, which are preferably applied, for example, to a display for displaying a screen image corresponding to an image signal on an optical guide plate by controlling a displacement action of an actuator element in a direction to make contact or separation with respect to the optical guide plate in accordance with an attribute of the image signal to be inputted so that leakage light is controlled at a predetermined portion of the optical guide plate.

2. Description of the Related Art

Those hitherto known as the display device include, for example, display devices such as cathode ray tubes (CRT), liquid crystal display devices, and plasma displays.

Those known as the cathode ray tube include, for example, ordinary television receivers and monitor units for computers. Although the cathode ray tube has a bright screen, it consumes a large amount of electric power. Further, the cathode ray tube involves such a problem that the depth of the entire display device is large as compared with the size of the screen. The cathode ray tube also involves, for example, such problems that the resolution is deteriorated at the peripheral portion of a displayed image, the image or the graphic is distorted, the memory function is not effected, and it is impossible to make a large display, because of the following reason.

That is, the electron beam, which is radiated from the electron gun, is greatly deflected. Therefore, the light emission spot (beam spot) is widened at the portion at which the electron beam arrives at the fluorescent screen of the Braun tube, and the image is displayed obliquely. As a result, the distortion occurs in the displayed image. Further, there is a certain limit to maintain the large space in the Braun tube in vacuum.

On the other hand, the liquid crystal display device is advantageous in that the entire device can be miniaturized, and the display device consumes a small amount of electric power. However, the liquid crystal display device involves problems such that it is inferior in luminance of the screen, and the field angle of the screen is narrow. Further, the liquid crystal display device involves such a difficulty that the arrangement of a driving circuit is extremely complicated, because the gradational expression is performed based on the voltage level.

For example, when a digital data line is used, the driving circuit therefor comprises a latching circuit for holding component RGB data (each 8-bit) for a predetermined period of time, a voltage selector, a multiplexer for making changeover to a voltage level of a type corresponding to a number of gradations, and an output circuit for adding output data from the multiplexer to the digital data line. In this case, when the number of gradations is increased, it is necessary to perform the switching operation at an extremely large number of levels in the multiplexer. The circuit construction is complicated in accordance therewith.

When an analog data line is used, the driving circuit therefor comprises a shift register for aligning, in the horizontal direction, component RGB data (each 8-bit) to be successively inputted, a latching circuit for holding parallel data from the shift register for a predetermined period of time, a level shifter for adjusting the voltage level, a D/A converter for converting output data from the level shifter into an analog signal, and an output circuit for adding the output signal from the D/A converter to the analog data line. In this case, a predetermined voltage corresponding to the gradation is obtained by using an operational amplifier in the D/A converter. However, when the range of the gradation is widened, it is necessary to use an operational amplifier which outputs a highly accurate voltage, resulting in such drawbacks that the structure is complicated and the price is expensive as well.

The plasma display has the following advantages. That is, it is possible to realize a small size, because the display section itself occupies a small volume. Further, the display is comfortably viewed, because the display surface is flat. Especially, the alternating current type plasma display also has such an advantage that it is unnecessary to use any refresh memory owing to the memory function of the cell.

As for the plasma display described above, in order to allow the cell to have the memory function, it is necessary to continue the electric discharge by switching the polarity of the applied voltage in an alternating manner. For this purpose, it is necessary to provide a first pulse generator for generating the sustain pulse in the X direction, and a second pulse generator for generating the sustain pulse in the Y direction. The plasma display involves such a problem that the arrangement of the driving circuit is inevitably complicated.

On the other hand, in order to solve the problems concerning the CRT, the liquid crystal display device, and the plasma display as described above, the present applicant has suggested a novel display device (see, for example, Japanese Laid-Open Patent Publication No. 7-287176). As shown in FIG. 74, this display device includes actuator elements 1000 which are arranged for respective picture elements. Each of the actuator elements 1000 comprises a main actuator element 1008 including a piezoelectric/electrostrictive layer 1002 and an upper electrode 1004 and a lower electrode 1006 formed on upper and lower surfaces of the piezoelectric/electrostrictive layer 1002 respectively, and a substrate 1014 including a vibrating section 1010 and a fixed section 1012 disposed under the main actuator element 1008. The lower electrode 1006 of the main actuator element 1008 contacts with the vibrating section 1010. The main actuator element 1008 is supported by the vibrating section 1010.

The substrate 1014 is composed of ceramics in which the vibrating section 1010 and the fixed section 1012 are integrated into one unit. A recess 1016 is formed in the substrate 1014 so that the vibrating section 1010 is thin-walled.

A displacement-transmitting section 1020 for obtaining a predetermined size of contact area with respect to an optical guide plate 1018 is connected to the upper electrode 1004 of the main actuator element 1008. In the illustrative display device shown in FIG. 74, the displacement-transmitting section 1020 is arranged such that it is located closely near to the optical guide plate 1018 in the ordinary state in which the actuator element 1000 stands still, while it contacts with the optical waveguide plate 1018 in the excited state at a distance of not more than the wavelength of the light.

The light 1022 is introduced, for example, from a lateral end of the optical guide plate 1018. In this arrangement, all of the light 1022 is totally reflected at the inside of the optical guide plate 1018 without being transmitted through front and back surfaces thereof by controlling the magnitude of the refractive index of the optical guide plate 1018. In this state, a voltage signal corresponding to an attribute of an image signal is selectively applied to the actuator element 1000 by the aid of the upper electrode 1004 and the lower electrode 1006 so that the actuator element 1000 is allowed to stand still in the ordinary state or make displacement in the excited state. Thus, the displacement-transmitting section 1020 is controlled for its contact and separation with respect to the optical guide plate 1018. Accordingly, the scattered light (leakage light) 1024 is controlled at a predetermined portion of the optical guide plate 1018, and a screen image corresponding to the image signal is displayed on the optical guide plate 1018.

This display device has, for example, the following advantages. That is, (1) it is possible to decrease the electric power consumption, (2) it is possible increase the screen luminance, and (3) it is unnecessary to increase the number of picture elements (image pixels) as compared with the black-and-white screen when a color screen is constructed.

For example, as shown in FIG. 75, the peripheral circuit of the display device as described above comprises a display section 1030 in which a large number of picture elements are arranged, a vertical shift circuit 1034 provided with vertical selection lines 1032 which are led in a number corresponding to necessary rows and which are common for a large number of picture elements (picture element group) for constructing one row, and a horizontal shift circuit 1038 provided with signal lines 1036 which are led in a number corresponding to necessary columns and which are common for a large number of picture elements (picture element group) for constructing one column.

As for the display device as described above, a large screen display is constructed by arranging a large number of display devices in some cases. In such a case, the form of display on a large screen is either a still picture or a moving picture.

In the maintenance for the conventional large screen display, a maintenance operator goes hurriedly to the working site to make repair even in the case of any simple operation. Therefore, the cost required for the maintenance is extremely expensive, which is unfavorable to popularize the display.

### SUMMARY OF THE INVENTION

The present invention has been made taking the foregoing problems into consideration, an object of which is to provide a display system and a method for managing a display, which make it possible to make display in which a still picture and a moving picture exist in a mixed manner.

Another object of the present invention is to provide a display system and a method for managing a display, which make it possible to easily perform, for example, the maintenance for a single large screen display or a plurality of large screen displays, for example, via a network so as to successfully contribute to the popularization of the large screen display.

According to the present invention, there is provided a display system comprising a display; and a display area-separating section for separating a display area of the display into a moving picture display area and a still picture display area.

Accordingly, it is possible to perform the display in which the still picture and the moving picture exist in a mixed manner. It is possible to diversify the display form.

It is also preferable that when the display is constructed by arranging a large number of display components; the display area-separating section separates the display area of the display into the moving picture display area and the still picture display area on the basis of address data to indicate the display components. In this arrangement, the moving picture display area and the still picture display area can be changed arbitrarily and easily. For example, when the display is used for the purpose of advertisement or the like, it is possible to easily realize a display form which conforms to the demand of the owner of the advertisement.

In this arrangement, it is also preferable that the display area-separating section is subjected to collective centralized control by a central facility connected to a network. By doing so, the moving picture display area and the still picture display area can be arbitrarily changed in a collective manner respectively for a plurality of displays installed at a variety of districts. The management of the display is greatly simplified.

According to another aspect of the present invention, there is provided a display system comprising a display; a monitoring section for monitoring a power source current of the display; and a collective failure-diagnosing section for transmitting status information obtained by the monitoring section via a network to a central facility.

Accordingly, it is possible to collectively monitor the failure states of a plurality of displays installed at a variety of districts. It is possible to quickly respond to the failure.

According to still another aspect of the present invention, there is provided a display system comprising a display; and a driving voltage-adjusting section for adjusting a driving voltage supplied to the display to compensate decrease in luminance.

In this arrangement, it is unnecessary for a person who performs the maintenance to correct the luminance one by one. The display can be managed easily and reliably.

Especially, when the driving voltage-adjusting section is subjected to collective centralized control by a central facility connected to a network, it is possible to collectively correct the luminance for a plurality of displays installed at a variety of districts. Therefore, it is possible to greatly reduce the operation concerning the correction of the luminance.

It is also preferable that the driving voltage-adjusting section is schedule-managed by the aid of a timer. In this arrangement, for example, the luminance can be corrected by designating the midnight or the like. Therefore, it is unnecessary that the luminance of the display is corrected in a state of being viewed by any person. It is possible to avoid, for example, such an inconvenience that the display state of a certain advertisement is in a bad condition.

It is also preferable that when the display is a display comprising an optical guide plate for introducing light from a light source thereinto, and a driving section provided opposingly to a first plate surface of the optical guide plate and arranged with actuator elements of a number corresponding to a large number of picture elements, wherein a screen image corresponding to an image signal is displayed on the optical guide plate by controlling a displacement action of the actuator element in a direction to make contact or separation with respect to the optical guide plate in accordance with an attribute of the image signal to be inputted so that leakage light is controlled at a predetermined portion of the optical guide plate; the driving voltage-adjusting section adjusts the driving voltage on the basis of a displacement state of arbitrary one of the actuator elements.

It is also preferable that the driving voltage-adjusting section adjusts the driving voltage on the basis of a light emission luminance in a predetermined state of the display.

According to still another aspect of the present invention, there is provided a display system comprising a display comprising an optical guide plate for introducing light from a light source thereinto, and a driving section provided opposingly to a first plate surface of the optical guide plate and arranged with actuator elements of a number corresponding to a large number of picture elements, wherein a screen image corresponding to an image signal is displayed on the optical guide plate by controlling a displacement action of the actuator element in a direction to make contact or separation with respect to the optical guide plate in accordance with an attribute of the image signal to be inputted so that leakage light is controlled at a predetermined portion of the optical guide plate; a preliminary light source; a current-monitoring section for monitoring a current of the light source; and a preliminary light source control unit for selectively turning on or turning off the preliminary light source on the basis of information from the current-monitoring section.

Accordingly, in an unexpected situation, for example, when the light source is subjected to any disconnection, or when the luminance is suddenly decreased, the preliminary light source is selectively turned on to avoid the disconnection of the light source and the decrease in luminance. Therefore, it is possible to maintain the presentation on the display during a period from the point of time of the occurrence of the deficiency until the maintenance is started.

It is also preferable that a part or all of the preliminary light sources are a preliminary light source provided for the purpose of countermeasure for fading. It is also preferable that the display system further comprises a cooling fan; and a cooling control unit for selectively driving the cooling fan on the basis of selective turning on of the preliminary light source. Accordingly, it is possible to suppress the sudden temperature change. It is possible to use the display system for a long period of time. Further, it is possible to suppress, for example, uneven luminance which would be otherwise caused by the temperature change.

According to still another aspect of the present invention, there is provided a display system comprising a display; a memory for storing luminance correction data for correcting a luminance dispersion of the display; and a table creation mechanism for rewriting the luminance correction data.

Accordingly, even when the luminance characteristic is changed due to the time-dependent change or the temperature change, it is possible to rewrite the luminance correction data corresponding to the change. Therefore, it is possible to maintain the display luminance at approximately the same level as that at the initial stage.

It is also preferable that the table creation mechanism is subjected to collective centralized control by a central facility connected to a network. Alternatively, it is also preferable that the table creation mechanism is schedule-managed by the aid of a timer.

It is also preferable that when the display is a display comprising an optical guide plate for introducing light from a light source thereinto, and a driving section provided opposingly to a first plate surface of the optical guide plate and arranged with actuator elements of a number corresponding to a large number of picture elements, wherein a screen image corresponding to an image signal is displayed on the optical guide plate by controlling a displacement action of the actuator element in a direction to make contact or separation with respect to the optical guide plate in accordance with an attribute of the image signal to be inputted so that leakage light is controlled at a predetermined portion of the optical guide plate; the table creation mechanism rewrites the luminance correction data on the basis of a displacement state of arbitrary one of the actuator elements.

In this arrangement, it is also preferable that the table creation mechanism rewrites the luminance correction data on the basis of a light emission luminance in a predetermined state of the display. Further, it is also preferable that the table creation mechanism rewrites the luminance correction data also in consideration of color balance adjustment.

According to still another aspect of the present invention, there is provided a display system comprising a display comprising an optical guide plate for introducing light from a light source thereinto, and a driving section provided opposingly to a first plate surface of the optical guide plate and arranged with actuator elements of a number corresponding to a large number of picture elements, wherein a screen image corresponding to an image signal is displayed on the optical guide plate by controlling a displacement action of the actuator element in a direction to make contact or separation with respect to the optical guide plate in accordance with an attribute of the image signal to be inputted so that leakage light is controlled at a predetermined portion of the optical guide plate, and wherein the actuator element makes the displacement action in a first direction when a voltage of positive polarization or negative polarization with respect to a reference electric potential is applied; and a switching means for making changeover to the voltage of positive polarization or the voltage of negative polarization at an arbitrary timing.

Accordingly, even when the response speed of the actuator element is decreased, or any unsuccessful separation takes place, then the changeover is made to the voltage of positive polarization or the voltage of negative polarization by the aid of the switching means. Therefore, the displacement ability of the actuator element is restored, and it is possible to restore the response speed to that at the initial stage.

It is also preferable that the switching means is subjected to collective centralized control by a central facility connected to a network. Alternatively, it is also preferable that the switching means is schedule-managed by the aid of a timer.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 shows a perspective view illustrating a schematic arrangement of a display to which a display system according to an embodiment of the present invention is applied;

FIG. 2 shows a sectional view illustrating an arrangement of a display component;

FIG. 3 illustrates an arrangement of picture elements of the display component;

FIG. 4 shows a sectional view depicting a first illustrative arrangement of an actuator element and a picture element assembly;

FIG. 5 shows an example of a planar configuration of a pair of electrodes formed on the actuator element;

FIG. 6A illustrates an example in which comb teeth of the pair of electrodes are arranged along the major axis of a shape-retaining layer;

FIG. 6B illustrates another example;

FIG. 7A illustrates an example in which comb teeth of the pair of electrodes are arranged along the minor axis of a shape-retaining layer;

FIG. 7B illustrates another example;

FIG. 8 shows a sectional view illustrating another arrangement of a display component;

FIG. 9 shows a sectional view depicting a second illustrative arrangement of an actuator element and a picture element assembly;

FIG. 10 shows a sectional view depicting a third illustrative arrangement of an actuator element and a picture element assembly;

FIG. 11 shows a sectional view depicting a fourth illustrative arrangement of an actuator element and a picture element assembly;

FIG. 12 illustrates an arrangement obtained when crosspieces are formed at four corners of the picture element assemblies respectively;

FIG. 13 illustrates another arrangement of the crosspiece;

FIG. 14 shows a table illustrating the relationship concerning the offset potential (bias potential) outputted from a row electrode drive circuit, the electric potentials of an ON signal and an OFF signal outputted from a column electrode-driving circuit, and the voltage applied between a row electrode and a column electrode;

FIG. 15 shows a circuit diagram illustrating an arrangement of a driving unit according to first and second embodiments;

FIG. 16 shows a block diagram illustrating an arrangement of a driver IC of a column electrode-driving circuit of the driving unit according to the first embodiment;

FIG. 17 especially shows an example in which one frame is divided into a plurality of subfields in order to explain the gradation control in the driving unit according to the first embodiment;

FIG. 18 shows a block diagram illustrating a signal processing circuit of the driving unit according to the first embodiment;

FIG. 19 shows a table illustrating another example of the relationship concerning the offset potential (bias potential) outputted from a row electrode drive circuit, the electric potentials of an ON signal and an OFF signal outputted from a column electrode-driving circuit, and the voltage applied between a row electrode and a column electrode;

FIG. 20 shows a table illustrating still another example of the relationship concerning the offset potential (bias potential) outputted from a row electrode drive circuit, the electric potentials of an ON signal and an OFF signal outputted from a column electrode-driving circuit, and the voltage applied between a row electrode and a column electrode;

FIG. 21 especially shows an example in which one frame is equally divided into a plurality of linear subfields in order to explain the gradation control in the driving unit according to the second embodiment;

FIG. 22A illustrates a bit array in which the gradation level is 62 in dot data prepared by the driving unit according to the second embodiment;

FIG. 22B illustrates a bit array in which the gradation level is 8 as well;

FIG. 23 shows a block diagram illustrating a signal processing circuit in a driving unit according to second and fourth embodiments;

FIG. 24 shows a block diagram illustrating an arrangement of a driver IC to be used for the driving unit according to the second embodiment;

FIG. 25 shows a block diagram illustrating an arrangement of a data transfer section to be used for the driving unit according to the second embodiment;

FIG. 26 illustrates data division in a first data output circuit;

FIG. 27 illustrates the data transfer form from the first data output circuit to the second data output circuit;

FIG. 28 shows a circuit diagram illustrating an arrangement of a driving unit according to third and fourth embodiments;

FIG. 29 especially shows an example in which one frame is divided into two fields and one field is divided into a plurality of subfields in order to explain the gradation control in the driving unit according to the third embodiment;

FIG. 30 shows a block diagram illustrating a signal processing circuit in the driving unit according to the third embodiment;

FIG. 31 shows a table illustrating the relationship concerning the electric potentials of a select signal and an nonselect signal outputted from a row electrode drive circuit, the electric potentials of an ON signal and an OFF signal outputted from a column electrode-driving circuit, and the voltage applied between the row electrode and the column electrode;

FIG. 32 shows a table illustrating another example of the relationship concerning the electric potentials of a select signal and an nonselect signal outputted from a row electrode drive circuit, the electric potentials of an ON signal and an OFF signal outputted from a column electrode-driving circuit, and the voltage applied between the row electrode and the column electrode;

FIG. 33 shows a table illustrating still another example of the relationship concerning the electric potentials of a select signal and an nonselect signal outputted from a row electrode drive circuit, the electric potentials of an ON signal and an OFF signal outputted from a column electrode-driving circuit, and the voltage applied between the row electrode and the column electrode;

FIG. 34 especially shows an example in which one frame is divided into two fields and one field is equally divided into a plurality of linear subfields in order to explain the gradation control in the driving unit according to the fourth embodiment;

FIG. 35 shows a block diagram illustrating a signal processing circuit in the driving unit according to the fourth embodiment;

FIG. 36 illustrates an arrangement of picture elements of a display component to which a driving unit according to a fifth embodiment is applied;

FIG. 37 especially shows an example in which one frame is divided into three fields and one field is divided into a plurality of subfields in order to explain the gradation control in the driving unit according to the fifth embodiment;

FIG. 38 shows a circuit diagram illustrating an arrangement of a driving unit according to fifth and sixth embodiments;

FIG. 39 shows a block diagram illustrating a signal processing circuit in the driving unit according to the fifth embodiment;

FIG. 40 especially shows an example in which one frame is divided into three field and one field is equally divided into a plurality of linear subfields in order to explain the gradation control in the driving unit according to the sixth embodiment;

FIG. 41 shows a block diagram illustrating a signal processing circuit in the driving unit according to the sixth embodiment;

FIG. 42A shows a sectional view illustrating an example of a display component based on the use of static electricity depicting a case in which the display component is in a light emission state;

FIG. 42B shows a sectional view depicting a case in which the display component is in a light off state;

FIG. 43A shows a sectional view illustrating another example of a display component based on the use of static electricity depicting a case in which the display component is in a light emission state;

FIG. 43B shows a sectional view depicting a case in which the display component is in a light off state;

FIG. 44 shows a sectional view illustrating another arrangement of an actuator element;

FIG. 45 shows a block diagram for illustrating a luminance-correcting means;

FIG. 46 shows a characteristic illustrating an example of luminance distribution of respective dots;

FIG. 47 shows a characteristic illustrating another example of luminance distribution of respective dots;

FIG. 48 shows a block diagram for illustrating a linear correcting means;

FIG. 49A shows a light emission luminance characteristic of a certain dot;

FIG. 49B shows a characteristic illustrating a weighting factor for linearizing the light emission luminance characteristic;

FIG. 49C shows a characteristic illustrating a light emission luminance distribution after being linearized;

FIG. 50A shows a light emission luminance characteristic of a television signal applied with gamma control;

FIG. 50B shows a characteristic illustrating a weighting factor for counteracting the gamma control;

FIG. 50C shows a characteristic illustrating a light emission luminance distribution after being linearized;

FIG. 51 shows a block diagram for illustrating a dimming control means;

FIG. 52A shows a timing chart illustrating an example of the timing for switching the light source;

FIG. 52B shows a timing chart illustrating an example of the combination of linear subfields selected depending on the gradation level;

FIG. 53A shows a timing chart illustrating another example of the timing for switching the light source;

FIG. 53B shows a timing chart illustrating another example of the combination of linear subfields selected depending on the gradation level;

FIG. 54A shows a waveform illustrating a signal applied to the column electrode in the ordinary driving;

FIG. 54B shows a waveform illustrating a signal applied to the row electrode;

FIG. 54C shows a waveform illustrating a voltage applied to the dot;

FIG. 55A shows an applied voltage waveform in the ordinary operation;

FIG. 55B shows a light intensity distribution thereof;

FIG. 56A shows a waveform illustrating a signal applied to the column electrode when the preparatory period is provided;

FIG. 56B shows a waveform illustrating a signal applied to the row electrode;

FIG. 56C shows a waveform illustrating a voltage applied to the dot;

FIG. 57A shows an applied voltage waveform when the preparatory period is provided;

FIG. 57B shows a light intensity distribution thereof;

FIG. 58 shows an example of the circuit used for the row electrode drive circuit;

FIG. 59 shows a block diagram illustrating a display system according to a first embodiment;

FIG. 60 shows a block diagram illustrating a display system according to a second embodiment;

FIG. 61 shows a block diagram illustrating a display system according to a third embodiment;

FIG. 62 shows a block diagram illustrating a first modified embodiment of the display system according to the third embodiment;

FIG. 63 shows a block diagram illustrating a second modified embodiment of the display system according to the third embodiment;

FIG. 64 shows a block diagram illustrating a display system according to a fourth embodiment;

FIG. 65 shows a block diagram illustrating a display system according to a fifth embodiment;

FIG. 66 shows the relationship between the angle of visibility and the areal size of measurement by a luminance meter;

FIG. 67 shows characteristics illustrating the result of measurement of the relative luminance value with respect to the angle of visibility;

FIG. 68 shows a characteristic illustrating a displacement characteristic of the actuator element;

FIG. 69A shows a voltage waveform applied to the actuator element;

FIG. 69B shows a displacement characteristic of the actuator element with respect to the applied voltage;

FIG. 70 shows, with partial omission, a perspective view illustrating a display based on the divided panel system;

FIG. 71 shows a chromaticity characteristic of the display according to the embodiment of the present invention;

FIG. 72 depicts a first illustrative arrangement of the display based on the divided panel system;

FIG. 73 depicts a second illustrative arrangement of the display based on the divided panel system;

FIG. 74 shows an arrangement illustrating a display device concerning a suggested example; and

FIG. 75 shows a block diagram illustrating a peripheral circuit of the display device.

### DESCRIPTION OF THE PREFERRED EMBODIMENTS

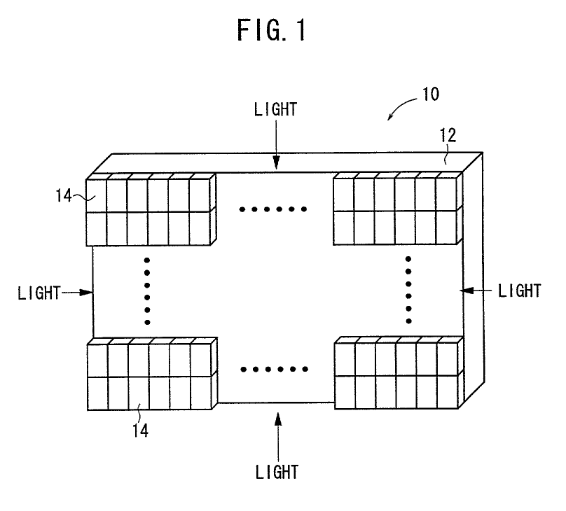

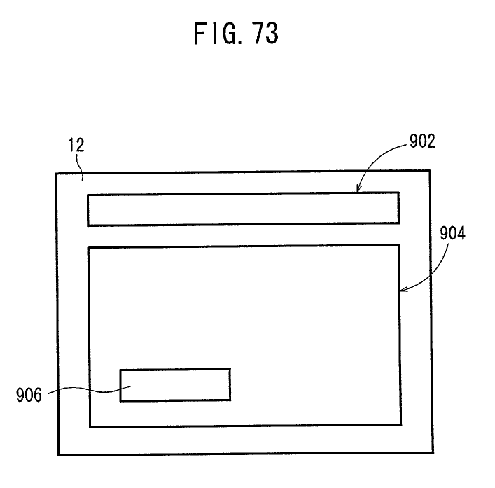

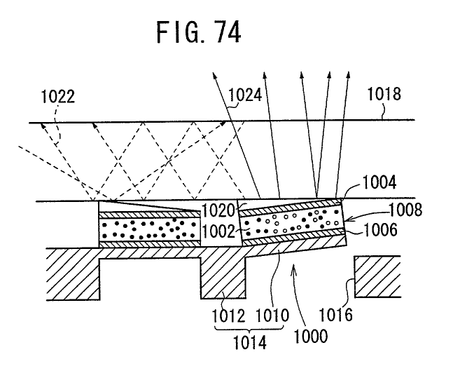

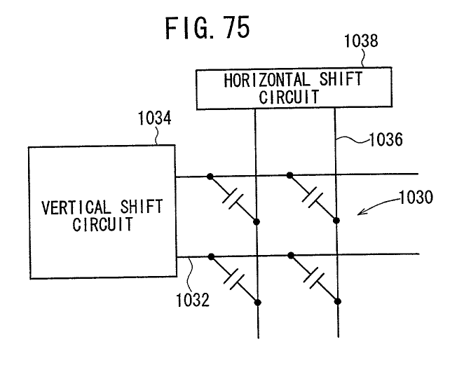

Illustrative embodiments of the display system and the method for managing the display according to the present invention will be explained below with reference to FIGS. 1 to 73. Prior thereto, explanation will be made with reference to FIGS. 1 to 13 for an arrangement of a display to which the display system and the method for managing the display according to the present invention are applied.

As shown in FIG. 1, the display 10 comprises a plurality of display components 14 arranged on a back surface of an optical waveguide plate 12 having a display area as the display 10.

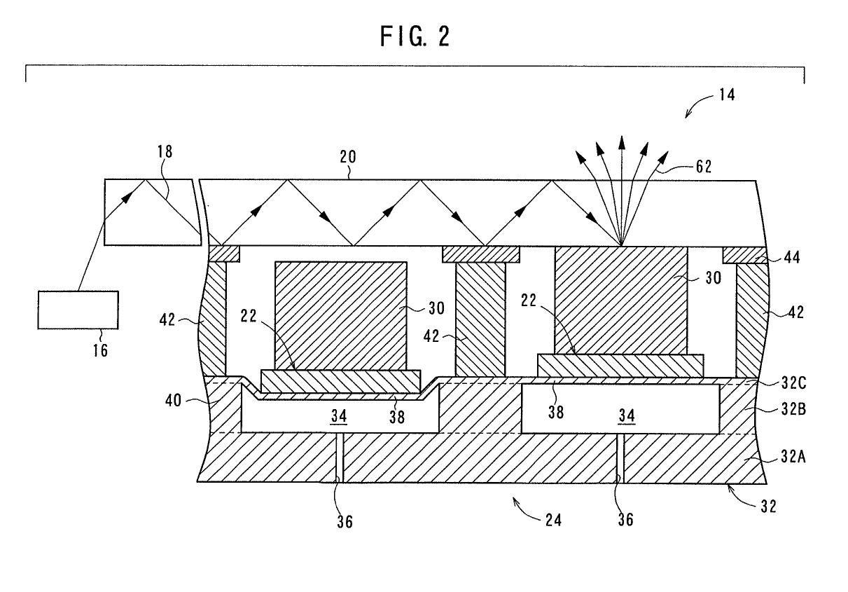

As shown in FIG. 2, each of the display components 14 comprises an optical guide plate 20 for introducing light 18 from a light source 16 thereinto, and a driving section 24 provided opposingly to the back surface of the optical guide plate 20 and including a large number of actuator elements 22 which are arranged corresponding to picture elements (image pixels) in a matrix configuration or in a zigzag configuration.

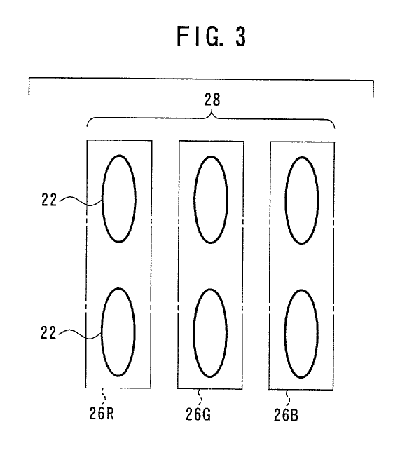

The arrangement of the picture element array is as follows, for example, as shown in FIG. 3. That is, one dot 26 is constructed by two actuator elements 22 which are aligned in the vertical direction. One picture element 28 is constructed by three dots 26 (red dot 26R, green dot 26G, and blue dot 26B) which are aligned in the horizontal direction. In the display component 14, the picture elements 28 are aligned such that sixteen individuals (48 dots) are arranged in the horizontal direction, and sixteen individuals (16 dots) are arranged in the vertical direction.

In the display 10, as shown in FIG. 1, for example, in order to conform to the VGA standard, forty individuals of the display components 14 are arranged in the horizontal direction, and thirty individuals of the display components 14 are arranged in the vertical direction on the back surface of the optical waveguide plate 12 so that 640 picture elements (1920 dots) are aligned in the horizontal direction, and 480 picture elements (480 dots) are aligned in the vertical direction.

Those which are uniform and which have a large light transmittance in the visible light region, such as glass plates and acrylic plates are used for the optical waveguide plate 12. The respective display components 14 are mutually connected to one another, for example, by means of wire bonding, soldering, end surface connector, or back surface connector so as to make it possible to supply signals between the mutual display components 14.

It is preferable that the refractive index of the optical waveguide plate 12 is similar to that of the optical guide plate 20 of each of the display components 14. When the optical waveguide plate 12 and the optical waveguide plates 20 are bonded to one another, it is also preferable to use a transparent adhesive. Preferably, the adhesive is uniform and it has a high transmittance in the visible light region in the same manner as the optical waveguide plate 12 and the optical guide plate 20. It is also desirable that the refractive index of the adhesive is set to be similar to those of the optical waveguide plate 12 and the optical guide plate 20 in order to ensure the brightness of the screen.

In each of the display components 14, as shown in FIG. 2, a picture element assembly 30 is stacked on each of the actuator elements 22. The picture element assembly 30 functions such that the contact area with the optical guide plate 20 is increased to give an areal size corresponding to the picture element.

The driving section 24 includes an actuator substrate 32 composed of, for example, ceramics. The actuator elements 22 are arranged at positions corresponding to the respective picture elements 28 on the actuator substrate 32. The actuator substrate 32 has its first principal surface which is arranged to oppose to the back surface of the optical guide plate 20. The first principal surface is a continuous surface (flushed surface). Hollow spaces 34 for forming respective vibrating sections as described later on are provided at positions corresponding to the respective picture elements 28 at the inside of the actuator substrate 32. The respective hollow spaces 34 communicate with the outside via through-holes 36 each having a small diameter and provided at the second principal surface of the actuator substrate 32.

The portion of the actuator substrate 32, at which the hollow space 34 is formed, is thin-walled. The other portion of the actuator substrate 32 is thick-walled. The thin-walled portion has a structure which tends to undergo vibration in response to external stress, and it functions as a vibrating section 38. The portion other than the hollow space 34 is thick-walled, and it functions as a fixed section 40 for supporting the vibrating section 38.

That is, the actuator substrate 32 has a stacked structure comprising a substrate layer 32A as a lowermost layer, a spacer layer 32B as an intermediate layer, and a thin plate layer 32C as an uppermost layer. The actuator substrate 32 can be recognized as an integrated structure including the hollow spaces 34 formed at the positions in the spacer layer 32B corresponding to the actuator elements 22. The substrate layer 32A functions as a substrate for reinforcement, as well as it functions as a substrate for wiring. The actuator substrate 32 may be sintered in an integrated manner, or it may be additionally attached.

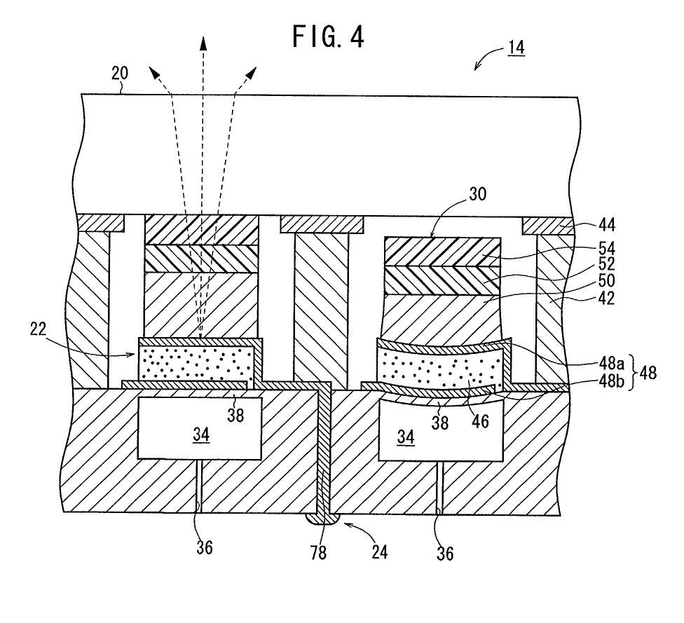

Specified embodiments of the actuator element 22 and the picture element assembly 30 will now be explained with reference to FIGS. 4 to 13. The embodiments shown in FIGS. 4 to 13 are illustrative of a case in which a gap-forming layer 44 is provided between the optical guide plate 20 and a crosspiece 42 as described later on.

At first, as shown in FIG. 4, each of the actuator elements 22 comprises the vibrating section 38 and the fixed section 40 described above, as well as a shape-retaining layer 46 composed of, for example, a piezoelectric/electrostrictive layer or an anti-ferroelectric layer directly formed on the vibrating section 38, and a pair of electrodes 48 (a row electrode 48a and a column electrode 48b) formed on an upper surface and a lower surface of the shape-retaining layer 46.

As shown in FIG. 4, the pair of electrodes 48 may have a structure in which they are formed on upper and lower sides of the shape-retaining layer 46, or they are formed on only one side of the shape-retaining layer 46. Alternatively, the pair of electrodes 48 may be formed on only the upper portion of the shape-retaining layer 46.

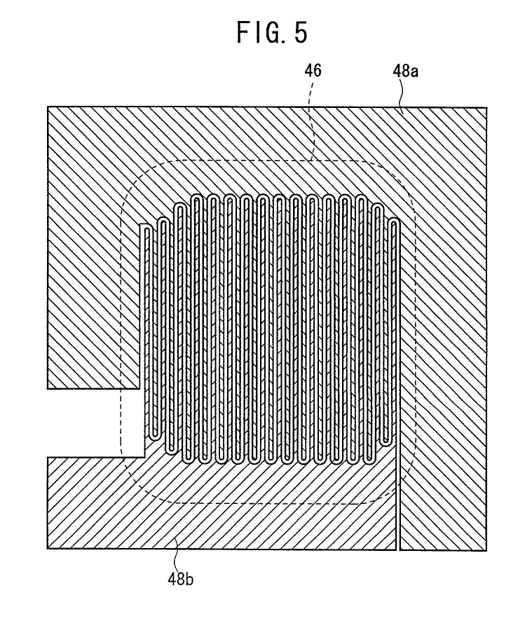

When the pair of electrodes 48 are formed on only the upper portion of the shape-retaining layer 46, the planar configuration of the pair of electrodes 48 may be a shape in which a large number of comb teeth are opposed to one another in a complementary manner as shown in FIG. 5. Alternatively, it is possible to adopt, for example, the spiral configuration and the branched configuration as disclosed in Japanese Laid-Open Patent Publication No. 10-78549 as well.

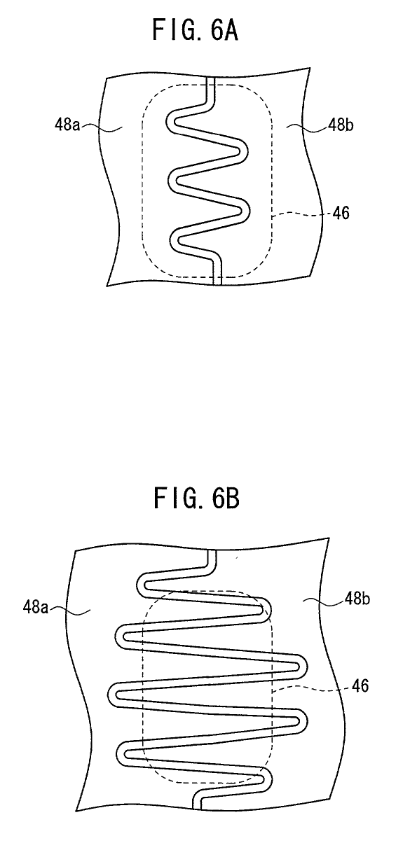

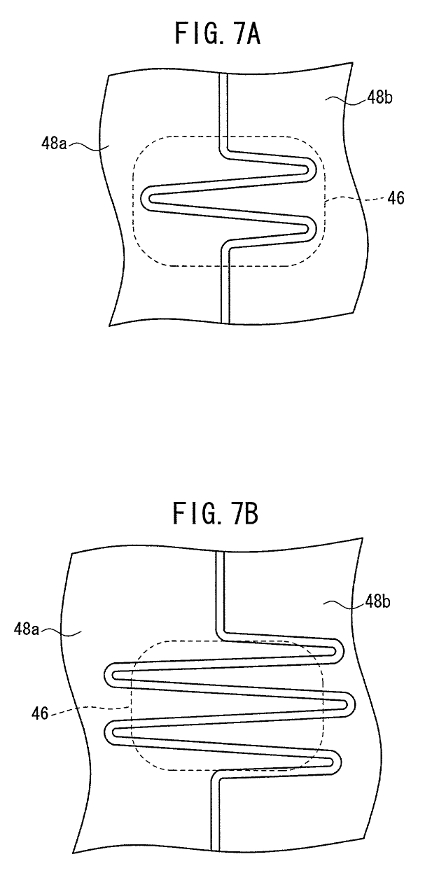

When the planar configuration of the shape-retaining layer 46 is, for example, an elliptic configuration, and the pair of electrodes 48 are formed to have a comb teeth-shaped configuration, then it is possible to use, for example, a form in which the comb teeth of the pair of electrodes 48 are arranged along the major axis of the shape-retaining layer 46 as shown in FIGS. 6A and 6B, and a form in which the comb teeth of the pair of electrodes 48 are arranged along the minor axis of the shape-retaining layer 46 as shown in FIGS. 7A and 7B.

It is possible to use, for example, the form in which the comb teeth of the pair of electrodes 48 are included in the planar configuration of the shape-retaining layer 46 as shown in FIGS. 6A and 7A, and the form in which the comb teeth of the pair of electrodes 48 protrude from the planar configuration of the shape-retaining layer 48 as shown in FIGS. 6B and 7B. The forms shown in FIGS. 6B and 7B are more advantageous to effect the bending displacement of the actuator element 22.

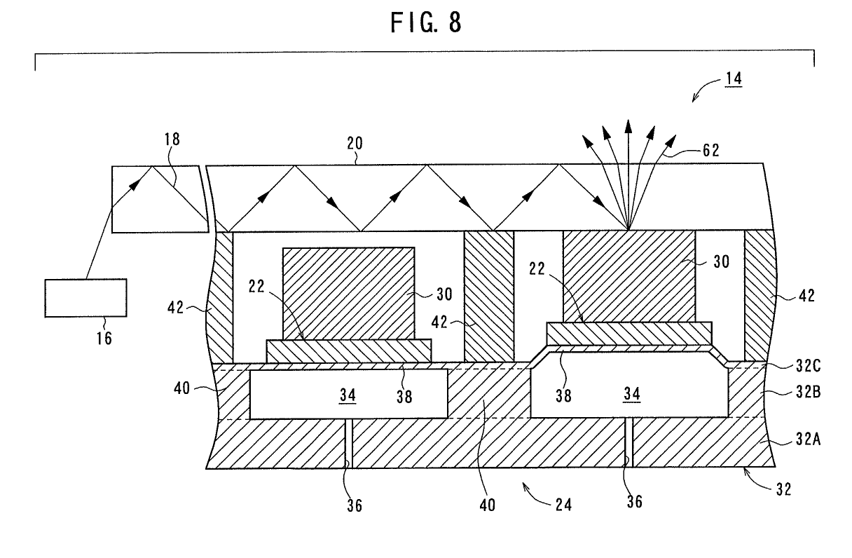

As shown in FIG. 4, for example, when the pair of electrodes 48 are constructed such that the row electrode 48a is formed on the upper surface of the shape-retaining layer 46, and the column electrode 48b is formed on the lower surface of the shape-retaining layer 46, the actuator element 22 can be subjected to bending displacement in a first direction so that it is convex toward the hollow space 34 as shown in FIG. 2. Alternatively, as shown in FIG. 8, the actuator element 22 can be subjected to bending displacement in a second direction so that it is convex toward the optical guide plate 20. The example shown in FIG. 8 is illustrative of a case in which the gap-forming layer 44 (see FIG. 4) is not formed.

On the other hand, as shown in FIG. 4, for example, the picture element assembly 30 can be constructed by a stack comprising a white scattering element 50 as a displacement-transmitting section formed on the actuator element 22, a color filter 52, and a transparent layer 54.

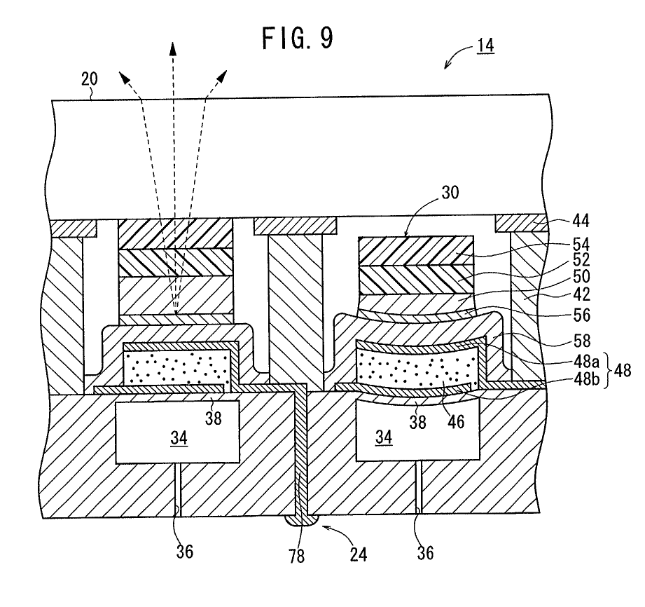

Further, as shown in FIG. 9, a light-reflective layer 56 may be allowed to intervene as a lower layer of the white scattering element 50. In this arrangement, it is desirable that an insulative layer 58 is formed between the light-reflective layer 56 and the actuator element 22.

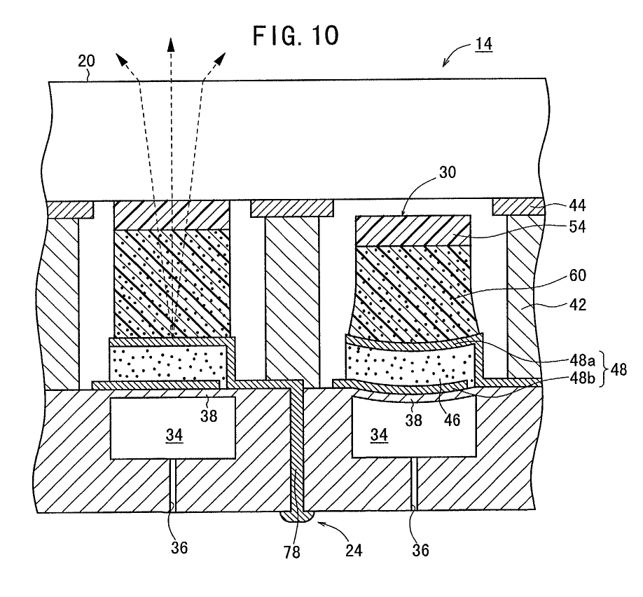

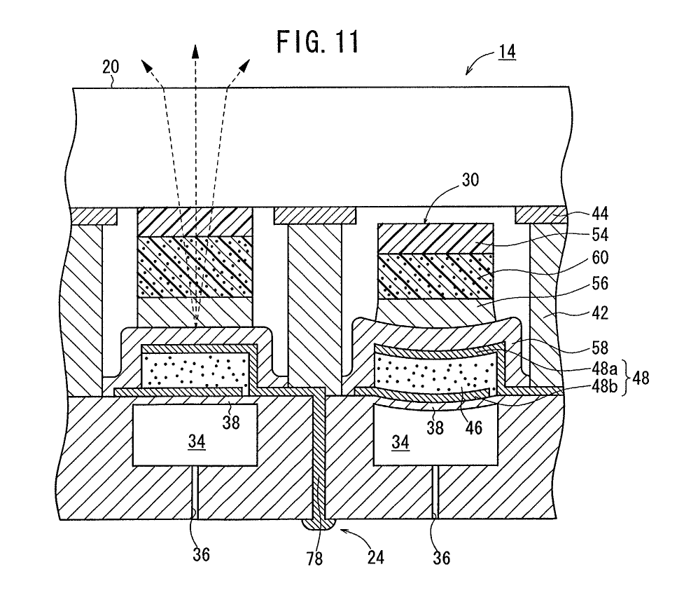

Another example of the picture element assembly 30 is, for example, as shown in FIG. 10. That is, the picture element assembly 30 can be also constructed by a stack comprising a color scattering element 60 to also serve as a displacement-transmitting section formed on the actuator element 22, and a transparent layer 54. Also in this case, as shown in FIG. 11, a light-reflective layer 56 and an insulative layer 58 may be allowed to intervene between the actuator element 22 and the color scattering element 60.

As shown in FIGS. 2, 4, and 8, the display component 14 comprises the crosspieces 42 which are formed at the portions other than the picture element assembly 30 between the optical guide plate 20 and the actuator substrate 32. The example shown in FIG. 8 is illustrative of a case in which the optical guide plate 20 is directly secured to the upper surfaces of the crosspieces 42. It is preferable that the material for the crosspiece 42 is not deformed by heat and pressure.

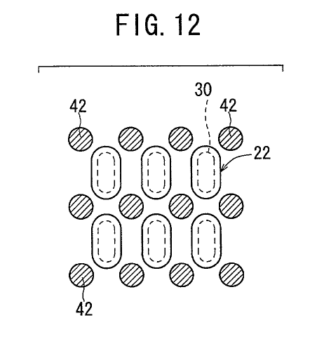

The crosspieces 42 can be formed, for example, at portions around four corners of the picture element assembly 30. The portions around four corners of the picture element assembly 30 are herein exemplified, for example, by positions corresponding to the respective corners as shown in FIG. 12, for example, when the picture element assembly 30 has a substantially rectangular or elliptic planar configuration. FIG. 12 is illustrative of a form in which one crosspiece 42 is shared by the adjoining picture element assembly 30.

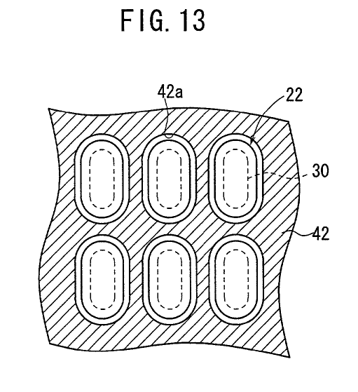

Another example of the crosspiece 42 is shown in FIG. 13. That is, the crosspiece 42 may be provided with windows 42a each of which surrounds at least one picture element assembly 30. The representative illustrative arrangement is as follows. That is, for example, the crosspiece 42 itself is formed to have a plate-shaped configuration. Windows (openings) 42a, each having a shape similar to the outer configuration of the picture element assembly 30, are formed at the positions corresponding to the picture element assemblies 30. Accordingly, all of the side surfaces of the picture element assembly 30 are consequently surrounded by the crosspiece 42. Thus, the actuator substrate 32 and the optical guide plate 20 are secured to one another more tightly.

Explanation will now be made for the respective constitutive members of the display component 14, especially for the selection of the material or the like for the respective constitutive member.

At first, the light 18 to be introduced into the optical guide plate 20 may be any one of those of ultraviolet, visible, and infrared regions. Those usable as the light source 16 include, for example, incandescent lamp, deuterium discharge lamp, fluorescent lamp, mercury lamp, metal halide lamp, halogen lamp, xenon lamp, tritium lamp, light emitting diode, laser, plasma light source, hot cathode tube (or one arranged with carbon nano tube-field emitter in place of filament-shaped hot cathode), and cold cathode tube.

It is preferable that the vibrating section 38 is composed of a highly heat-resistant material, because of the following reason. That is, when the actuator element 22 has the structure in which the vibrating section 38 is directly supported by the fixed section 40 without using any material such as an organic adhesive which is inferior in heat resistance, the vibrating section 38 is preferably composed of a highly heat-resistant material in order that the vibrating section 38 is not deteriorated in quality at least during the formation of the shape-retaining layer 46.

It is preferable that the vibrating section 38 is composed of an electrically insulative material in order to electrically separate the wiring connected to the row electrode 48a of the pair of electrodes 48 formed on the actuator substrate 22, from the wiring (for example, data line) connected to the column electrode 48b.

Therefore, the vibrating section 38 may be composed of a material such as a highly heat-resistant metal and a porcelain enamel produced by coating a surface of such a metal with a ceramic material such as glass. However, the vibrating section 38 is optimally composed of ceramics.

Those usable as the ceramics for constructing the vibrating section 38 include, for example, stabilized zirconium oxide, aluminum oxide, magnesium oxide, titanium oxide, spinel, mullite, aluminum nitride, silicon nitride, glass, and mixtures thereof. Stabilized zirconium oxide is especially preferred because of, for example, high mechanical strength obtained even when the thickness of the vibrating section 38 is thin, high toughness, and small chemical reactivity with the shape-retaining layer 46 and the pair of electrodes 48. The term “stabilized zirconium oxide” includes fully stabilized zirconium oxide and partially stabilized zirconium oxide. Stabilized zirconium oxide has a crystal structure such as cubic crystal, and hence it does not cause phase transition.

On the other hand, zirconium oxide causes phase transition between monoclinic crystal and tetragonal crystal at about 1000° C. Cracks appear during the phase transition in some cases. Stabilized zirconium oxide contains 1 to 30 mole % of a stabilizer such as calcium oxide, magnesium oxide, yttrium oxide, scandium oxide, ytterbium oxide, cerium oxide, and oxides of rare earth metals. In order to enhance the mechanical strength of the vibrating section 22, the stabilizer preferably comprises yttrium oxide. In this composition, yttrium oxide is contained preferably in an amount of 1.5 to 6 mole %, and more preferably 2 to 4 mole %. It is preferable that aluminum oxide is further contained in an amount of 0.1 to 5 mole %.

The crystal phase may be, for example, a mixed phase of cubic crystal+monoclinic crystal, a mixed phase of tetragonal crystal+monoclinic crystal, and a mixed phase of cubic crystal+tetragonal crystal+monoclinic crystal. However, among them, most preferred are those having a principal crystal phase composed of tetragonal crystal or a mixed phase of tetragonal crystal+cubic crystal, from viewpoints of strength, toughness, and durability.

When the vibrating section 38 is composed of ceramics, a large number of crystal grains construct the vibrating section 38. In order to increase the mechanical strength of the vibrating section 38, the crystal grains preferably have an average grain diameter of 0.05 to 2 μm, and more preferably 0.1 to 1 μm.

The fixed section 40 is preferably composed of ceramics. The fixed section 40 may be composed of the same ceramic material as that used for the vibrating section 38, or the fixed section 40 may be composed of a ceramic material different from that used for the vibrating section 38. Those usable as the ceramic material for constructing the fixed section 40 include, for example, stabilized zirconium oxide, aluminum oxide, magnesium oxide, titanium oxide, spinel, mullite, aluminum nitride, silicon nitride, glass, and mixtures thereof, in the same manner as the material for the vibrating section 38.

Especially, those preferably adopted for the actuator substrate 32 used in the display component 14 include, for example, materials containing a major component of zirconium oxide, materials containing a major component of aluminum oxide, and materials containing a major component of a mixture thereof. Among them, those containing a major component of zirconium oxide are more preferable.

Clay or the like is added as a sintering aid in some cases. However, it is necessary to control components of the sintering aid in order not to contain an excessive amount of those liable to form glass such as silicon oxide and boron oxide because of the following reason. That is, although the materials which are liable to form glass are advantageous to join the actuator substrate 32 to the shape-retaining layer 46, the materials facilitate the reaction between the actuator substrate 32 and the shape-retaining layer 46, making it difficult to maintain a predetermined composition of the shape-retaining layer 46. As a result, the materials make a cause to deteriorate the element characteristics.

That is, it is preferable that silicon oxide or the like in the actuator substrate 32 is restricted to have a weight ratio of not more than 3%, and more preferably not more than 1%. The term “major component” herein refers to a component which exists in a proportion of not less than 50% in weight ratio.

As described above, those usable as the shape-retaining layer 46 include piezoelectric/electrostrictive layers and anti-ferroelectric layers. However, when the piezoelectric/electrostrictive layer is used as the shape-retaining layer 46, those usable as the piezoelectric/electrostrictive layer include ceramics containing, for example, lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstate, and lead cobalt niobate, or any combination of them.

It is needless to say that the major component contains the compound as described above in an amount of not less than 50% by weight. Among the ceramic materials described above, the ceramic material containing lead zirconate is most frequently used as the constitutive material for the piezoelectric/electrostrictive layer for constructing the shape-retaining layer 46.

When the piezoelectric/electrostrictive layer is composed of ceramics, it is also preferable to use ceramics obtained by appropriately adding, to the ceramics described above, oxide of, for example, lanthanum, calcium, strontium, molybdenum, tungsten, barium, niobium, zinc, nickel, and manganese, or any combination thereof or another type of compound thereof.

For example, it is preferable to use ceramics containing a major component composed of lead magnesium niobate, lead zirconate, and lead titanate and further containing lanthanum and strontium.

The piezoelectric/electrostrictive layer may be either dense or porous. When the piezoelectric/electrostrictive layer is porous, its porosity is preferably not more than 40%.

When the anti-ferroelectric layer is used as the shape-retaining layer 46, it is desirable to use, as the anti-ferroelectric layer, a compound containing a major component composed of lead zirconate, a compound containing a major component composed of lead zirconate and lead stannate, a compound obtained by adding lanthanum to lead zirconate, and a compound obtained by adding lead zirconate and lead niobate to a component composed of lead zirconate and lead stannate.

Especially, when an anti-ferroelectric film, which contains the component composed of lead zirconate and lead stannate as represented by the following composition, is applied as a film-type element such as the actuator element 22, it is possible to perform the driving at a relatively low voltage:

Pb_{0.99}Nb_{0.02}[(ZrₓSn₁₋ₓ)_{1-y}Ti_{y}]_{0.98}O₃

wherein, 0.5<x<0.6, 0.05<y<0.063, 0.01<Nb<0.03. Therefore, application of such an anti-ferroelectric film is especially preferred.

The anti-ferroelectric film may be porous. When the anti-ferroelectric film is porous, it is desirable that the porosity is not more than 30%.

Those usable as the method for forming the shape-retaining layer 46 on the vibrating section 38 include various types of the thick film formation method such as the screen printing method, the dipping method, the application method, and the electrophoresis method, and various types of the thin film formation method such as the ion beam method, the sputtering method, the vacuum evaporation method, the ion plating method, the chemical vapor deposition method (CVD), and the plating.

In this embodiment, when the shape-retaining layer 46 is formed on the vibrating section 38, the thick film formation method is preferably adopted, based on, for example, the screen printing method, the dipping method, the application method, and the electrophoresis method, because of the following reason.

That is, in the techniques described above, the shape-retaining layer 46 can be formed by using, for example, paste, slurry, suspension, emulsion, or sol containing a major component of piezoelectric ceramic particles having an average grain size of 0.01 to 5 μm, preferably 0.05 to 3 μm, in which it is possible to obtain good piezoelectric operation characteristics.

Especially, the electrophoresis method makes it possible to form the film at a high density with a high shape accuracy, and it further has the features as described in technical literatures such as “Electrochemistry and Industrial Physical Chemistry, Vol. 53, No. 1 (1985), pp. 63-68, written by Kazuo ANZAI” and “Proceedings of First Study Meeting on Higher Order Ceramic Formation Method Based on Electrophoresis (1998), pp. 5-6 and pp. 23-24”. Therefore, the technique may be appropriately selected and used considering, for example, the required accuracy and the reliability.

It is preferable that the thickness of the vibrating section 38 has a dimension identical to that of the thickness of the shape-retaining layer 46, because of the following reason. That is, if the thickness of the vibrating section 38 is extremely thicker than the thickness of the shape-retaining layer 46 (if the former is different from the latter by not less than one figure), when the shape-retaining layer 46 makes shrinkage upon sintering, then the vibrating section 38 behaves to inhibit the shrinkage. For this reason, the stress at the boundary surface between the shape-retaining layer 46 and the actuator substrate 22 is increased, and consequently they are easily peeled off from each other. On the contrary, when the dimension of the thickness is in an identical degree between the both, it is easy for the actuator substrate 32 (vibrating section 38) to follow the shrinkage of the shape-retaining layer 46 upon sintering. Accordingly, such dimension of the thickness is preferred to achieve integration. Specifically, the vibrating section 38 preferably has a thickness of 1 to 100 μm, more preferably 3 to 50 μm, and much more preferably 5 to 20 μm. On the other hand, the shape-retaining layer 46 preferably has a thickness of 5 to 100 μm, more preferably 5 to 50 μm, and much more preferably 5 to 30 μm.

The row electrode 48a and the column electrode 48b formed on the upper surface and the lower surface of the shape-retaining layer 46, or the pair of electrodes 34 formed on the shape-retaining layer 46 are allowed to have an appropriate thickness depending on the use or application. However, the thickness is preferably 0.01 to 50 μm, and more preferably 0.1 to 5 μm. The row electrode 48a and the column electrode 48b are preferably composed of a conductive metal which is solid at room temperature. The metal includes, for example, metal simple substances or alloys containing, for example, aluminum, titanium, chromium, iron, cobalt, nickel, copper, zinc, niobium, molybdenum, ruthenium, rhodium, silver, stannum, tantalum, tungsten, iridium, platinum, gold, and lead. It is needless to say that these elements may be contained in an arbitrary combination.

The optical guide plate 20 has an optical refractive index with which the light 18 introduced into the inside thereof is totally reflected by the front and back surfaces without being transmitted to the outside of the optical guide plate 20. It is necessary for the optical guide plate 20 to use those having a large and uniform light transmittance in the wavelength region of the light 18 to be introduced. The material for the optical guide plate 20 is not specifically limited provided that it satisfies the foregoing characteristic. However, specifically, those generally used for the optical guide plate 20 include, for example, glass, quartz, light-transmissive plastics such as acrylic plastics, light-transmissive ceramics, structural materials comprising a plurality of layers composed of materials having different refractive indexes, and those having a surface coating layer.

The color layer such as the color filter 52 and the color scattering element 60 included in the picture element assembly 30 is the layer which is used to extract only the light in a specified wavelength region, and it includes, for example, those which develop the color by absorbing, transmitting, reflecting, or scattering the light at a specified wavelength, and those which convert incident light into light having a different wavelength. The transparent member, the semitransparent member, and the opaque member can be used singly or in combination.

The color layer is constructed, for example, as follows. That is, the color layer includes, for example, those obtained by dispersing or dissolving a dyestuff or a fluorescent material such as dye, pigment, and ion in rubber, organic resin, light-transmissive ceramic, glass, liquid or the like, those obtained by applying the dyestuff or the fluorescent material on the surface of the foregoing material, those obtained by sintering, for example, the powder of the dyestuff or the fluorescent material, and those obtained by pressing and solidifying the powder of the dyestuff or the fluorescent material. As for the material quality and the structure, the materials may be used singly, or the materials may be used in combination.

The difference between the color filter 52 and the color scattering element 60 lies in whether or not the luminance value of leakage light obtained by reflection and scattering effected by only the color layer is not less than 0.5-fold the luminance value of leakage light obtained by reflection and scattering effected by the entire structure including the picture element assembly 30 and the actuator element 22, when the light emission state is given by allowing the picture element assembly 30 to make contact with the optical guide plate 20 into which the light 18 is introduced. If the former luminance value is not less than 0.5-fold the latter luminance value, the color layer is defined to be the color scattering element 60. If the former luminance value is less than 0.5-fold the latter luminance value, the color layer is defined to be the color filter 52.

The measuring method is specifically exemplified as follows. That is, it is assumed that when the color layer is singly allowed to make contact with the back surface of the optical guide plate 20 into which the light 18 is introduced, A(nt) represents the front luminance of the light which passes from the color layer through the optical guide plate 20 and which leaks to the front surface. Further, it is assumed that when the picture element assembly 30 is allowed to make contact with the surface of the color layer on the side opposite to the side to make contact with the optical guide plate 20, B(nt) represents the front luminance of the light which leaks to the front surface. If A≧0.5×B is satisfied, the color layer is the color scattering element 60. If A<0.5×B is satisfied, the color layer is the color filter 52.

The front luminance is the luminance measured by arranging a luminance meter so that the line to connect the color layer to the luminance meter for measuring the luminance is perpendicular to the surface of the optical guide plate 20 to make contact with the color layer (the detection surface of the luminance meter is parallel to the plate surface of the optical guide plate 20).

The color scattering element 60 is advantageous in that the color tone and the luminance are scarcely changed depending on the thickness of the layer. Accordingly, those applicable as the method for forming the layer includes various methods such as the screen printing which requires inexpensive cost although it is difficult to strictly control the layer thickness.

Owing to the arrangement in which the color scattering element 60 also serves as the displacement-transmitting section, it is possible to simplify the process for forming the layer. Further, it is possible to obtain a thin entire layer thickness. Therefore, the thickness of the entire display component 14 can be made thin. Further, it is possible to avoid the decrease in displacement amount of the actuator element 22, and improve the response speed.

The color filter 52 has the following advantages. That is, when the layer is formed on the side of the optical guide plate 20, the layer can be easily formed, because the optical guide plate 20 is flat, and it has high surface smoothness. Thus, the range of process selection is widened, and the cost becomes inexpensive. Further, it is easy to control the layer thickness which may affect the color tone and the luminance.

The method for forming the film of the color layer such as the color filter 52 and the color scattering element 60 is not specifically limited, to which it is possible to apply a variety of known film formation methods. Those usable include, for example, a film lamination method in which the color layer in a chip form or in a film form is directly stuck on the surface of the optical guide plate 20 or the actuator element 22, as well as a method for forming the color layer in which, for example, powder, paste, liquid, gas, or ion to serve as a raw material for the color layer is formed into a film in accordance with the thick film formation method such as the screen printing, the photolithography method, the spray dipping, and the application, or in accordance with the thin film formation method such as the ion beam, the sputtering, the vacuum evaporation, the ion plating, CVD, and the plating.

Alternatively, it is also preferable that a light emissive layer is provided for a part or all of the picture element assembly 30. Those usable as the light-emissive layer include a fluorescent layer. The fluorescent layer includes those which are excited by invisible light (ultraviolet light and infrared light) to emit visible light, and those which are excited by visible light to emit visible light. However, any of them may be used.

A fluorescent pigment may be also used for the light-emissive layer. The use of the fluorescent pigment is effective for those added with fluorescent light having a wavelength approximately coincident with the color of the pigment itself, i.e., the color of reflected light such that the color stimulus is large corresponding thereto, and the light emission is vivid. Therefore, the fluorescent pigment is used more preferably to obtain the high luminance for the display component and the display. A general daylight fluorescent pigment is preferably used.

A stimulus fluorescent material, a phosphorescent material, or a luminous pigment is also used for the light-emissive layer. These materials may be either organic materials or inorganic materials.

Those preferably used include those formed with the light-emissive layer by using the light-emissive material as described above singly, those formed with the light-emissive layer by using the light-emissive material as described above dispersed in resin, and those formed with the light-emissive layer by using the light-emissive material as described above dissolved in resin.

The afterglow or decay time of the light-emissive material is preferably not more than 1 second, more preferably 30 milliseconds. More preferably, the afterglow or decay time is not more than several milliseconds.

When the light-emissive layer is used as a part or all of the picture element assembly 30, the light source 16 is not specifically limited provided that it includes the light having a wavelength capable of exciting the light-emissive layer and it has an energy density sufficient for excitation. Those usable include, for example, cold cathode tube, hot cathode tube (or one arranged with carbon nano tube-field emitter in place of filament-shaped hot cathode), metal halide lamp, xenon lamp, laser including infrared laser, black light, halogen lamp, incandescent lamp, deuterium discharge lamp, fluorescent lamp, mercury lamp, tritium lamp, light emitting diode, and plasma light source.

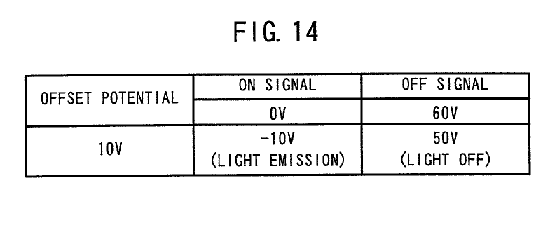

Next, the operation of the display 10 will be briefly explained with reference to FIG. 2. As shown in FIG. 14, the description of the operation is illustrative of a case in which the offset potential, which is used and applied to the row electrode 48a of each of the actuator elements 22, is, for example, 10 V, and the electric potentials of the ON signal and the OFF signal, which are used and applied to the column electrode 48b of each of the actuator elements 22, are 0 V and 60 V respectively.

Therefore, the low level voltage (−10 V) is applied between the column electrode 48b and the row electrode 48a in the actuator element 22 in which the ON signal is applied to the column electrode 48b. The high level voltage (50 V) is applied between the column electrode 48b and the row electrode 48a in the actuator element 22 in which the OFF signal is applied to the column electrode 48b.

At first, the light 18 is introduced, for example, from the end portion of the optical guide plate 20. In this embodiment, all of the light 18 is totally reflected at the inside of the optical guide plate 20 without being transmitted through the front and back surfaces thereof by controlling the magnitude of the refractive index of the optical guide plate 20, in the state in which the picture element assembly 30 does not make contact with the optical guide plate 20. The reflection factor n of the optical guide plate 20 is desirably 1.3 to 1.8, and more desirably 1.4 to 1.7.

In this embodiment, in the natural state of the actuator element 22, the end surface of the picture element assembly 30 contacts with the back surface of the optical guide plate 20 at the distance of not more than the wavelength of the light 18. Therefore, the light 18 is reflected by the surface of the picture element assembly 30, and it behaves as scattered light 62. A part of the scattered light 62 is reflected again in the optical guide plate 20. However, almost all of the scattered light 62 is not reflected by the optical guide plate 20, and it is transmitted through the front surface (face) of the optical guide plate 20. Accordingly, all of the actuator elements 22 are in the ON state, and the ON state is expressed in a form of light emission. Further, the color of the light emission corresponds to the color of the color filter 52 or the color scattering element 60 included in the picture element assembly 30, or the color of the light emissive layer described above. In this case, all of the actuator elements 22 are in the ON state. Therefore, the white color is displayed on the screen of the display 10.

Starting from this state, when the OFF signal is applied to the actuator element 22 corresponding to a certain dot 26, the concerning actuator element 22 makes the bending displacement to be convex toward the hollow space 20 as shown in FIG. 2, i.e., it makes the bending displacement in the first direction. The end surface of the picture element assembly 30 is separated from the optical guide plate 20, and the concerning actuator element 22 is in the OFF state. The OFF state is expressed in a form of light off.

That is, in the display 10, the presence or absence of light emission (leakage light) at the front surface of the optical guide plate 20 can be controlled depending on the presence or absence of the contact of the picture element assembly 30 with the optical guide plate 20.

Especially, in the display 10, one unit for making the displacement action of the picture element assembly 30 in the direction to make contact or separation with respect to the optical guide plate 20 is arranged in the vertical direction to be used as one dot. The array of the three dots in the horizontal direction (red dot 26R, green dot 26G, and blue dot 26B) is used as one picture element. A large number of the picture elements are arranged in a matrix configuration or in a zigzag configuration concerning the respective rows. Therefore, it is possible to display a color screen image (characters and graphics) corresponding to the image signal on the front surface of the optical guide plate 20, i.e., on the display surface, in the same manner as in the cathode ray tube, the liquid crystal display device, and the plasma display, by controlling the displacement action in each of the picture elements in accordance with the attribute of the inputted image signal.

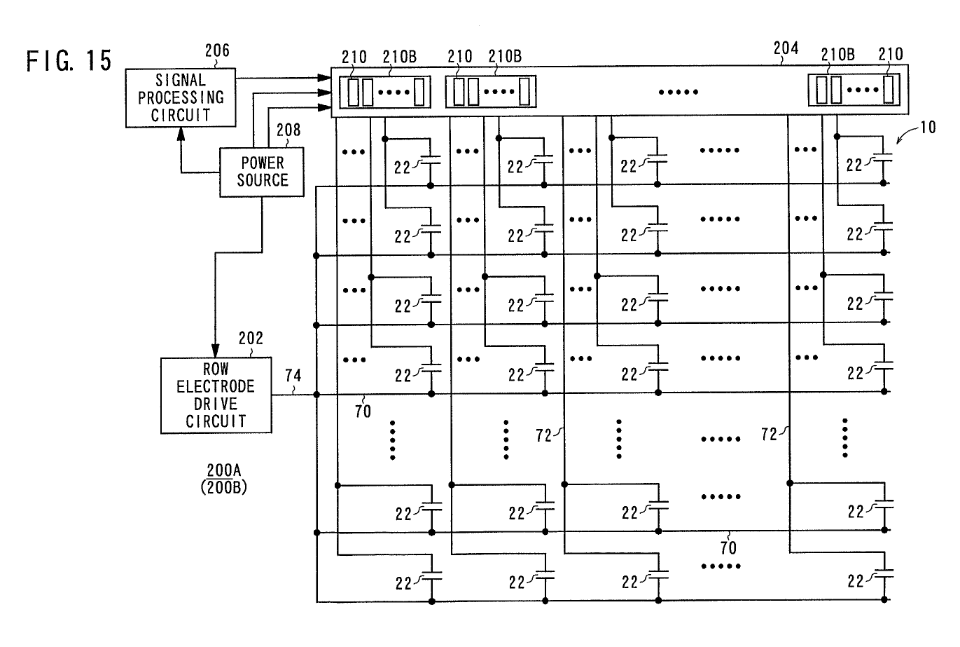

In the display 10, as shown in FIG. 15, the wirings connected to the row electrode 48a and the column electrode 48b include wirings 70 of a number corresponding to the number of rows of the large number of actuator elements 22, and data lines 72 of a number corresponding to the number of all of the actuator elements 22. The wirings 70 are connected to a common wiring 74 at an intermediate position.

In the display 10, the column electrodes 48b of the actuator elements 22 are connected to the data lines 72. The common wiring 70 is connected to the actuator elements 22 corresponding to one row. The data lines 72 are formed, for example, on the back surface side of the actuator substrate 32.

The wiring 70 is led from the row electrode 48a in relation to the actuator element 22 in the previous column, and it is connected to the row electrode 48a in relation to the concerning actuator element 22, giving a form of being wired in series concerning one row. The column electrode 48b and the data line 72 are electrically connected to one another via the through-hole 78 formed in the actuator substrate 32.

An unillustrated insulating film, which is composed of, for example, a silicon oxide film, a glass film, or a resin film, is allowed to intervene at the portion of intersection between each of the wirings 70 and each of the data lines 72 in order to effect insulation between the mutual wirings 70, 72.

As shown in FIG. 15, a driving unit 200A according to a first embodiment comprises a row electrode drive circuit 202 mounted at the periphery of the display 10, a column electrode-driving circuit 204, and a signal processing circuit 206 for controlling at least the column electrode-driving circuit 204.

The row electrode drive circuit 202 is constructed so that the offset potential (bias potential) is supplied to the row electrodes 48a of all of the actuator elements 22 via the common wiring 74 and the respective wirings 70. One type of offset power source voltage is supplied by the aid of a power source 208.

The column electrode-driving circuit 204 includes driver outputs 210 of a number corresponding to the number of all of the dots, and a plurality of driver IC's 210B incorporated with a predetermined number of driver outputs 210. The column electrode-driving circuit 204 is constructed so that the data signal is outputted in parallel to the respective data lines 72 of the display 10 to supply the data signal to all of the dots respectively.

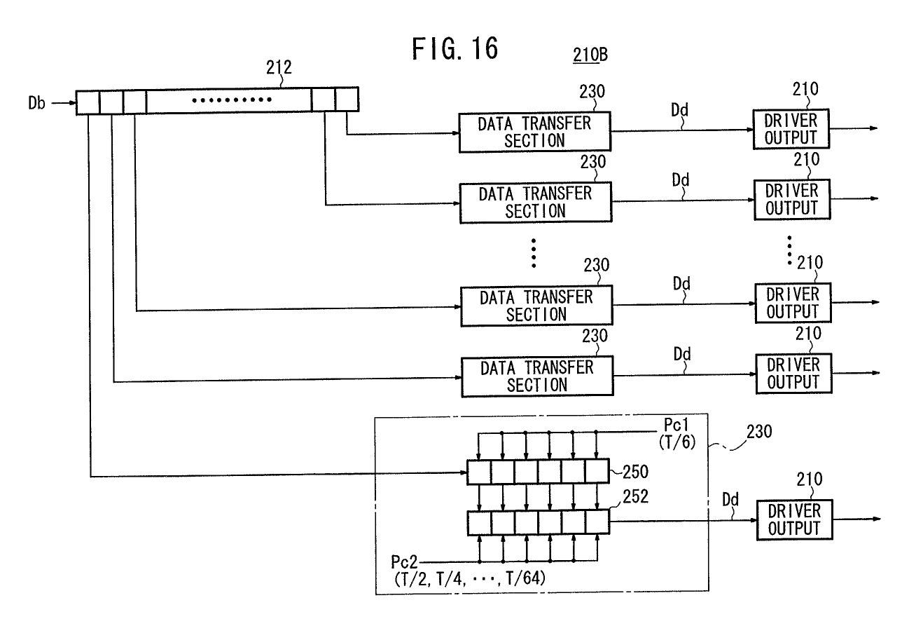

As shown in FIG. 16, each of the driver IC's 210B has, for example, a shift register 212 composed of 240 bits. A data transfer section 230 and a driver output 210 are connected to each of the bits of the shift register 212 respectively. Each bit data of the data of 240 bits (block data Db), which is supplied to the shift register 212, is dot data Dd to be supplied to the corresponding dot respectively.

The data transfer section 230 may comprise two shift registers (first and second shift registers 250, 252).

The first shift register 250 may be composed of a shift register of the series input parallel output in which the dot data Dd is received in series in accordance with the bit shift operation based on a constant shift clock Pc1 (=T/6), and the 6-bit dot data Dd is outputted in parallel at a stage at which the 6-bit dot data Dd is received.

The second shift register 252 may be composed of a shift register of the parallel input series output in which the dot data Dd stored in the first shift register 250 is received in parallel, and the bit information of the dot data Dd is successively outputted on the basis of a shift clock Pc2 having the timing (T/2, T/4, . . . , T/64) corresponding to the temporal length of the subfield SF1 to SF6.

That is, the second shift register 252 is operated as follows. The bit information of 0th bit stored in LSB is supplied as it is to the corresponding driver output 210 of the column electrode-driving circuit 204 at the point of time of the transfer from the first shift register 250. The overall bit information is bit-shifted to the right side at the point of time of the elapse of the first shift clock Pc2 (=T/2). The bit information of 1st bit, which is located at LSB, is supplied as it is to the driver output 210.

Subsequently, the overall bit information is bit-shifted to the right side at the point of time of the elapse of the shift clock Pc2 (=T/4). The bit information of 2nd bit, which is located at LSB, is supplied as it is to the driver output 210. Similarly, every time when the shift clock Pc2 successively elapses to T/8, T/16, T/32, and T/64, the overall bit information is bit-shifted. The bit information of 3rd bit, 4th bit, 5th bit, and 6th bit, which is located at LSB every time when the bit shift is performed, is successively supplied to the driver output 210.

Two types of data power source voltages are supplied to each of the driver outputs 210 by the aid of the power source 208 as well.

It is necessary to ensure a wide area to lead the data lines 72, because the data lines 72 are connected to all of the dots from the column electrode-driving circuit 204. Further, it is necessary to consider the influence of the time constant (for example, the attenuation of the signal) caused by the wiring resistance and the wiring capacity brought about by the increase in wiring length of the data lines 72. However, in this embodiment, the display 10 is divided into 1200 individuals of the display components 14. Therefore, it is enough that the leading of the data lines 72 from the column electrode-driving circuit 204 is considered in the unit of the display component 14. It is unnecessary to ensure any area to form the wide wiring. It is also enough that the wiring capacity and the wiring resistance are considered in the unit of the display component 14. Therefore, the attenuation of the signal or the like is not caused.

The two types of the data power source voltages are a high level voltage which is sufficient to allow the actuator element 22 to make the bending displacement downwardly, and a low level voltage which is sufficient to restore the actuator element 22 to the original state, as described later on.

The signal processing circuit 206 is constructed to control the column electrode-driving circuit 204 so that the gradation control is performed at least in accordance with the temporal modulation system.

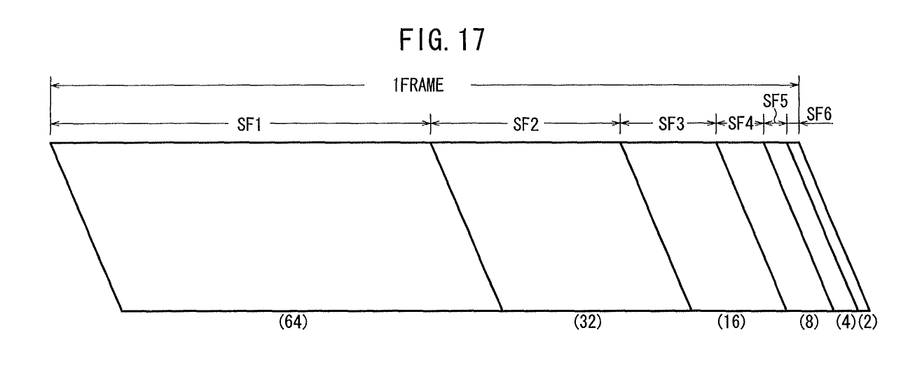

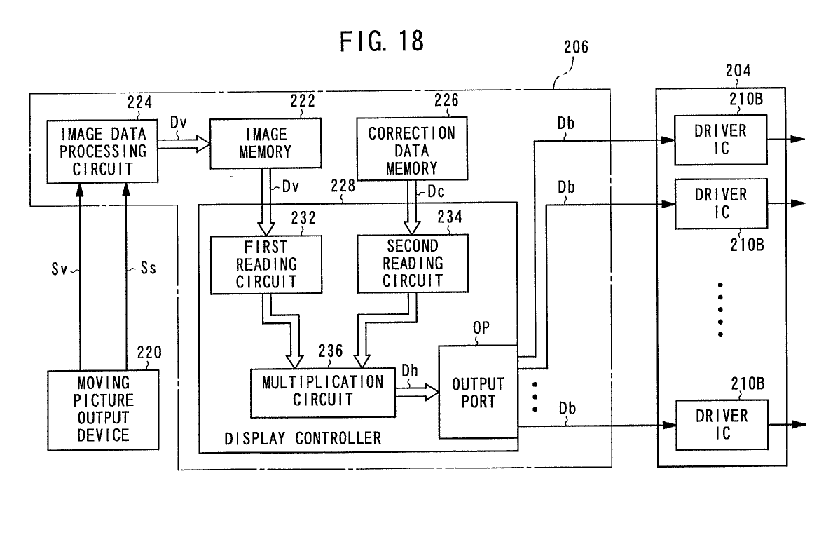

The gradation control based on the temporal modulation system will now be explained with reference to FIGS. 17 and 18. At first, it is assumed that the display period for one sheet of image is one frame, and one divided period, which is obtained by dividing one frame, for example, into six, is a subfield. On this assumption, the setting is made such that the initial subfield (first subfield SF1) is the longest, and the following subfields are shortened at a ratio of ½ as the number of subfield increases.

The length of the subfield is represented by the magnitude of the data value as follows. That is, as shown in FIG. 17, the setting is made such that when the period of the first subfield SF1 is, for example, “64”, then the second subfield SF2 is “32”, the third subfield SF3 is “16”, the fourth subfield SF4 is “8”, the fifth subfield SF5 is “4”, and the sixth subfield SF6 is “2”.

In the signal processing circuit 206, the display time corresponding to each of the gradation levels is allotted to the respective subfields SF1 to SF6 for all of the dots to prepare the dot data. The dot data is outputted as each of the data signals in the period of each of the subfields SF1 to SF6 by the aid of the column electrode-driving circuit 204.

Taking notice of one dot data, the display time corresponding to the gradation level of the dot is assigned to the time width allotted to each of the subfields. Therefore, there are a case in which the assignment is made to all of the subfields and a case in which the assignment is made to some of the subfields.

For example, when the gradation level of the concerning dot is, for example, 126, all of the subfields SF1 to SF6 are selected. The dot data resides in a bit string of “000000”. When the gradation level is 78, the first, fourth, fifth, and sixth subfields SF1, SF4, SF5, SF6 are selected. The dot data resides in a bit string of “011000”.

The data signal is an analog signal which is changed to the high level and the low level depending on each bit information of the bit string for constructing the dot data. If the bit information is logically “0”, the low level voltage (ON signal) is given. If the bit information is logically “1”, the high level voltage (OFF signal) is given.

That is, the following output form is available for the data signal outputted to the concerning actuator element 22. That is, for example, the ON signal (low level voltage) is outputted for the selected subfield, and the OFF signal (high level voltage) is outputted for the unselected subfield.

Specifically, as shown in FIG. 18, the signal processing circuit 206 comprises an image data processing circuit 224 for inputting a synchronization signal Ss and a moving picture signal Sv (for example, an analog moving picture signal) based on the progressive system from a moving picture output device 220 to make conversion into digital image data Dv in a unit of frame to be written into an image memory 222 (frame buffer), a correction data memory 226 for recording gradation correction data Dc set in a unit of dot, and a display controller 228 for reading the image data Dv from the image memory 222 and the gradation correction data Dc from the correction data memory 226 to multiply them to obtain corrected image data Dh.

The moving picture output device 220 is exemplified, for example, by personal computers and VTR for receiving and outputting the moving picture recorded on a recording medium or the moving picture sent by communication (including, for example, radio wave and cable).

The display controller 228 includes a first reading circuit 232 for reading the image data Dv from the image memory 222, a second reading circuit 234 for reading the gradation correction data Dc from the correction data memory 226, and a multiplication circuit 236 for multiplying the image data Dv and the gradation correction data Dc read from the first and second reading circuits 232, 234 to obtain corrected image data Dh, and an output port 238 for outputting the corrected image data Dh obtained by the multiplication circuit 236 in parallel.

The data transfer rate in the driving unit 200A according to the first embodiment will now be considered. It is necessary to transfer the 6-bit data per one dot during the period T of one frame, the following expression is given:

43 Hz×6 bit×(640×3×480)=238 Mbps.

When an IC having an operation clock of, for example 1 MHz is used for the column electrode-driving circuit 204, it is necessary to perform 1-bit transfer in parallel of 238 MHz/1 MHz=238.

Therefore, the output port OP of the display controller 228 has 238 individuals of output terminals for data transfer. The corrected image data Dh outputted from the multiplication circuit 236 is realigned corresponding to the respective output terminals to make output in parallel as the block data Db from the respective output terminals. In this case, the rate of transfer (transfer rate) in 1-bit unit in parallel from each of the output terminals is 1 MHz.

The driving unit 200A according to the first embodiment is basically constructed as described above. Next, its function and effect will be explained.

At first, the synchronization signal Ss and the moving picture signal Sv from the moving picture output device 220 are inputted into the image data processing circuit 224. The image data processing circuit 224 converts the inputted moving picture signal Sv into the digital image data Dv in the unit of frame on the basis of the synchronization signal Ss, and the image data Dv is written into the image memory 222 (frame buffer).

The display controller 228 reads the image data Dv written in the image memory 222 and the gradation correction data Dc from the correction data memory 226, and it multiplies them to obtain the corrected image data Dh (image data arranged with 6-bit dot data in the unit of one dot).

The corrected image data Dh is realigned at the output port OP in the data form corresponding to the output terminals respectively. After that, the corrected image data Dh is outputted from the output port OP in parallel of 238 individuals at the transfer rate of 1 bit/1 MHz, and it is supplied to each of the corresponding driver IC's 210B.

In each of the driver IC's 210B, the block data Db, which is sent from the output port OP, is supplied to the shift register 212. At a stage at which 240 individuals of the bit strings are aligned in the shift register 212, the bit strings are sent in parallel as the dot data Dd to the corresponding data transfer sections 230 respectively.

That is, each of the data transfer sections 230 performs the operation such that the dot data Dd sent from the shift register 212 is read at the constant shift clock Pc1, and the dot data Dd is outputted at the timing corresponding to the start timing (T/2, T/4, . . . , T/64) of each of the subfields SF1 to SF6.

The dot data Dd outputted from each of the data transfer sections 230 is supplied to each of the corresponding driver outputs 210. The driver output 210 makes conversion into the data signal based on the bit information contained in the dot data Dd to make output to each of the corresponding dots via the data line 72.

That is, the bit information contained in the corresponding dot data Dd is supplied as the data signal to each of the dots while being subjected to increment in synchronization with the start timing of each of the subfields SF1 to SF6.

Accordingly, a color screen image corresponding to the image data Dv is displayed on the screen of the display 10.

As described above, in the driving unit 200A according to the first embodiment, one dot 26 is constructed by one or more actuator elements 22, and one picture element 28 is constructed by one or more dots 26. In this arrangement, the driving unit 200A comprises the row electrode drive circuit 202 for applying the offset potential (bias potential) to all of the actuator elements 22, the column electrode-driving circuit 204 for outputting the data signal composed of the ON signal and the OFF signal for each dot on the basis of the image data Dv, and the signal processing circuit 206 for controlling the row electrode drive circuit 202 and the column electrode-driving circuit 204. The column electrode-driving circuit 204 is controlled so that the gradation control is performed at least in accordance with the temporal modulation system by the aid of the signal processing circuit 206. Therefore, it is enough to use one type of the offset power source voltage as the power source voltage to be supplied to the row electrode-driving circuit 202. Accordingly, it is easy to realize the custom IC architecture for the row electrode-driving circuit 202. It is possible to increase the degree of freedom for the design and the production of the driving unit 200A. It is possible to realize low electric power consumption as well.

Further, as for the column driver IC (column electrode-driving circuit 204), it is unnecessary to use, for IC itself, any expensive one such as those having the high function, for example, PWM modulation. Basically, it is possible to use multiple-output low price IC merely having a data input shift register and a level shifter. These components are also advantageous to miniaturize the mounting contour size of bare chip, TCP or the like. It is easy to save the space for the portion on which the driving IC is mounted. Therefore, it is also easy to realize a thin type of the display 10. This results in the reduction of the production cost of the display 10.

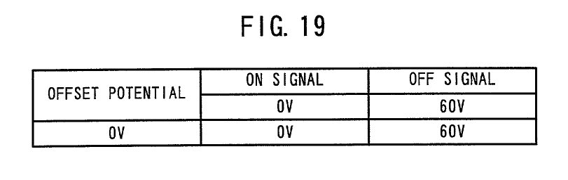

The embodiment described above is illustrative of the case in which the offset potential, which is applied to the row electrode 48a of each of the actuator elements 22, is 10 V. Alternatively, as shown in FIG. 19, the offset potential may be 0 V. In this case, the ground electric potential may be used as the offset potential. Therefore, it is possible to decrease the number of power sources by one.

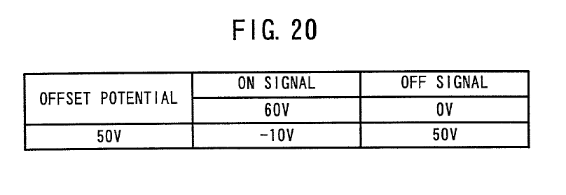

Further alternatively, for example, as shown in FIG. 20, it is also preferable that the polarization of the voltage application is inverted. For example, the offset potential may be +50 V, and the respective potentials of the ON signal and the OFF signal may be 60 V and 0 V. In this case, the polarization direction of the shape-retaining layer 46 is also inverted.

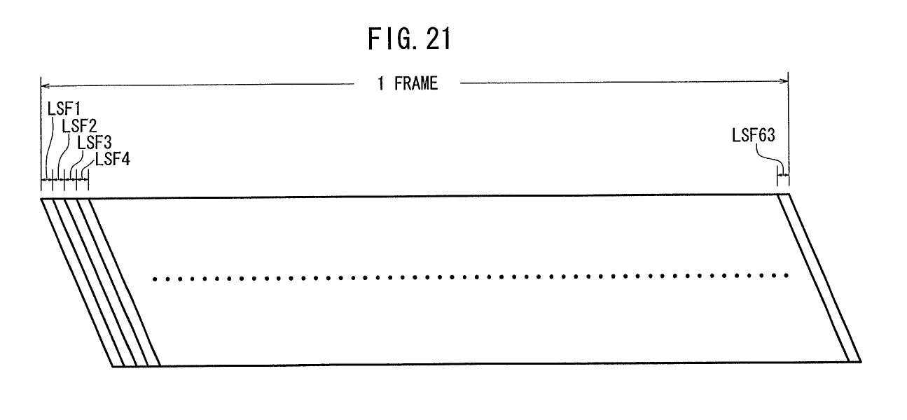

Next, a driving unit 200B according to a second embodiment will be explained with reference to FIGS. 21 to 27.

In the driving unit 200B according to the second embodiment, the gradation control based on the temporary modulation system in the signal processing circuit 206 is partially different. As shown in FIG. 21, it is assumed that the display period for one sheet of image is one frame, and one divided period, which is obtained by equally dividing the one frame into a plurality of ones, is a linear subfield. On this assumption, the signal processing circuit 206 continuously allots the display time corresponding to each of the gradation levels for each of the dots to the necessary linear subfield to prepare the dot data.

For example, when the maximum gradation is 64-gradation, 63 individuals of linear subfields LSF1 to LSF63 are allotted to the period of one frame. The dot data Dd is constructed by 1-bit data per one linear subfield.

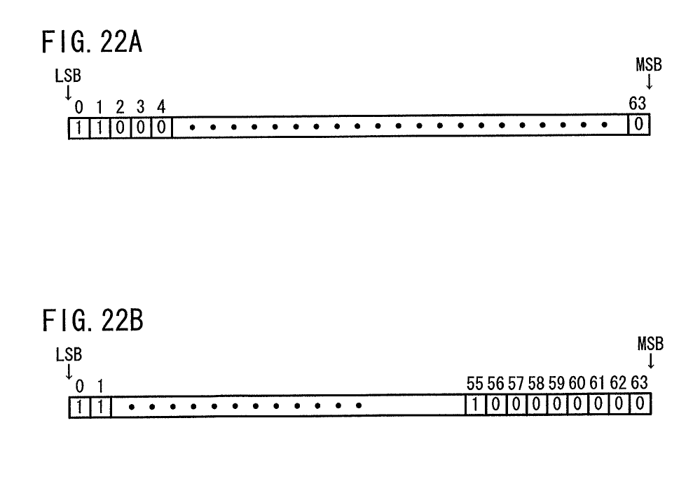

Specifically, when the gradation level of a certain dot is 62, as shown in FIG. 22A, the dot data is prepared such that 0-bit and 1-bit are “1” respectively, and the remaining continuous 2-bit to 63-bit are “0”. When the gradation level is 8, as shown in FIG. 22B, the dot data is prepared such that continuous 0-bit to 55-bit are “1”, and the remaining continuous 56-bit to 63-bit are “0”.

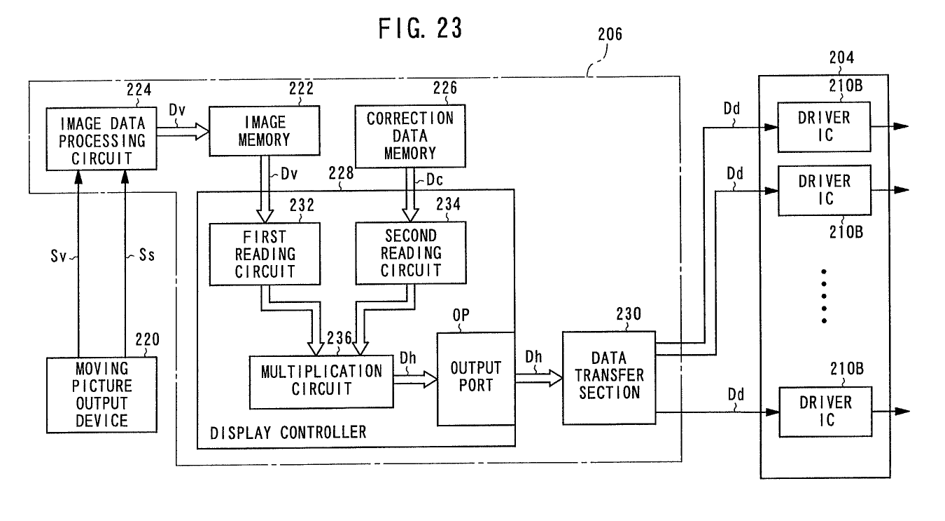

As shown in FIG. 23, the driving unit 200B according to the second embodiment is constructed in approximately the same manner as the driving unit 200A according to the first embodiment (see FIG. 18). However, the arrangement of the data output system of the signal processing circuit 206 and the arrangement of each driver IC 210B of the column electrode-driving circuit 204 differ as follows.

That is, a data transfer section 230 is connected to the downstream stage of the data output system of the signal processing circuit 206, i.e., the display controller 228. The multiplication circuit 236 of the display controller 228 multiplies the image data Dv and the gradation correction data Dc read from the first and second reading circuits 232, 234 to give the corrected image data Dh (image data arranged with the dot data of a bit number corresponding to the maximum gradation in a unit of dot) which is outputted as it is to the downstream data transfer section 230 via the output port OP.

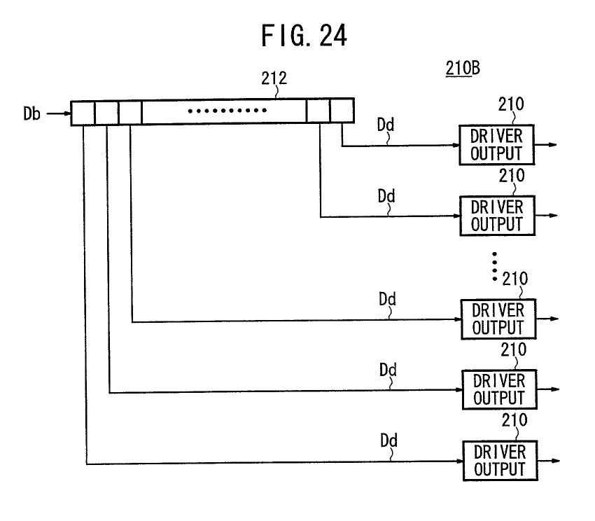

As shown in FIG. 24, the driver IC 210B has a shift register 212 of, for example, 240 bits. A driver output 210 is connected to each bit of the shift register 212.

The data transfer rate in the driving unit 200B according to the second embodiment will now be considered. It is required to transmit 1-bit data in a period of 1/64 frame (T/64), and thus the following expression is given:

(43×64 Hz)×1 bit×(640×3×480)=2.5 Gbps.

For example, when an IC having an operation clock of 1 MHz is used for the column electrode-driving circuit 204, it is necessary to perform 1-bit transmission in parallel of 2.5 GHz/1 MHz=2500.

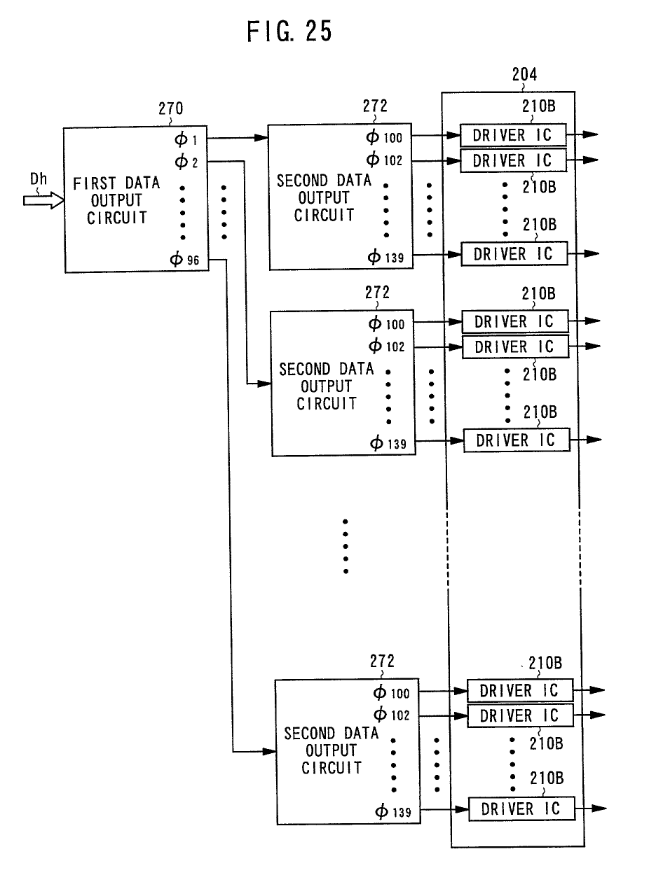

Therefore, a circuit system, which outputs the bit information for constructing the dot data Dd in conformity with the start timing of each of the linear subfields LSF1 to LSF64, is adopted for the data transfer section 230. For example, as shown in FIG. 25, the system includes one first data output circuit 270 and second data output circuits 272 of a number corresponding to a number of output terminals of the first data output circuit 270.

The first data output circuit 270 is constructed as follows. That is, all of the driver IC's 210B are divided into those belonging to a plurality of groups. It is assumed that k represents the number of outputs per one driver IC 210B (number of dots outputted by the driver IC 210B), m represents the number of allotment of the driver IC's in one group, and n represents the number of bits corresponding to the maximum gradation. On this assumption, a data group constructed by k×m×n is allotted to each of the output terminals in the period T of one frame. The data group is outputted in a unit of dot at every predetermined timing at each of the output terminals.

The second data output circuit 272 has output terminals of a number corresponding to the allotment number m of the driver IC's. The data, which is supplied from the first data output circuit 270, is outputted in parallel to the allotted driver IC 210B via the plurality of output terminals.

For example, it is assumed that the number of outputs (number of dots outputted by the driver IC 210B) per one driver IC 210B is 240, 40 individuals of driver IC's 210B are allotted to each group, and the number of the output terminals of the first data output circuit 270 is 96. On this assumption, the second data output circuits 272, each of which has 40 individuals of output terminals φ100 to φ139, are connected to the respective output terminals φ1 to φ96 of the first data output circuit 270. In this arrangement, it is possible to make the parallel output of 96×40=3840 individuals.

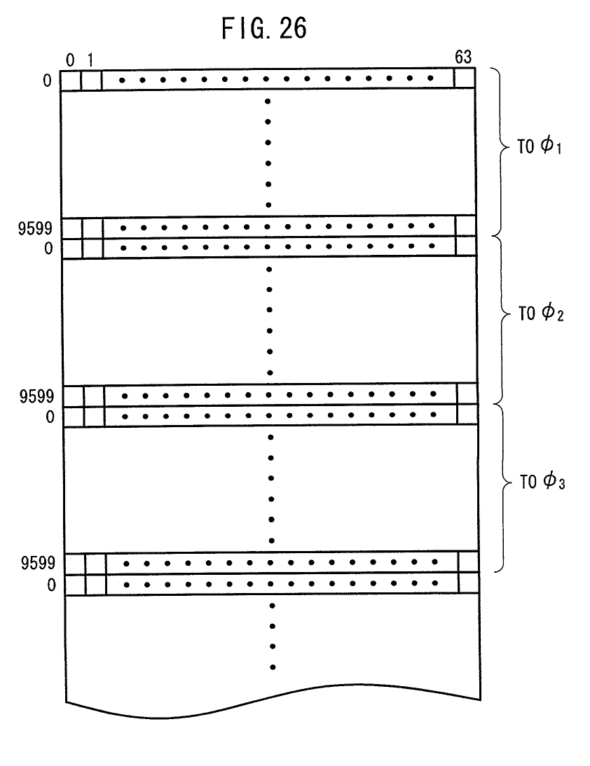

As shown in FIG. 26, the first data output circuit 270 divides the corrected image data Dh supplied from the display controller 228 for each dot data of 240×40 individuals=9600 individuals to allot 9600 individuals of dot data to each of the output terminals φ1 to φ96.

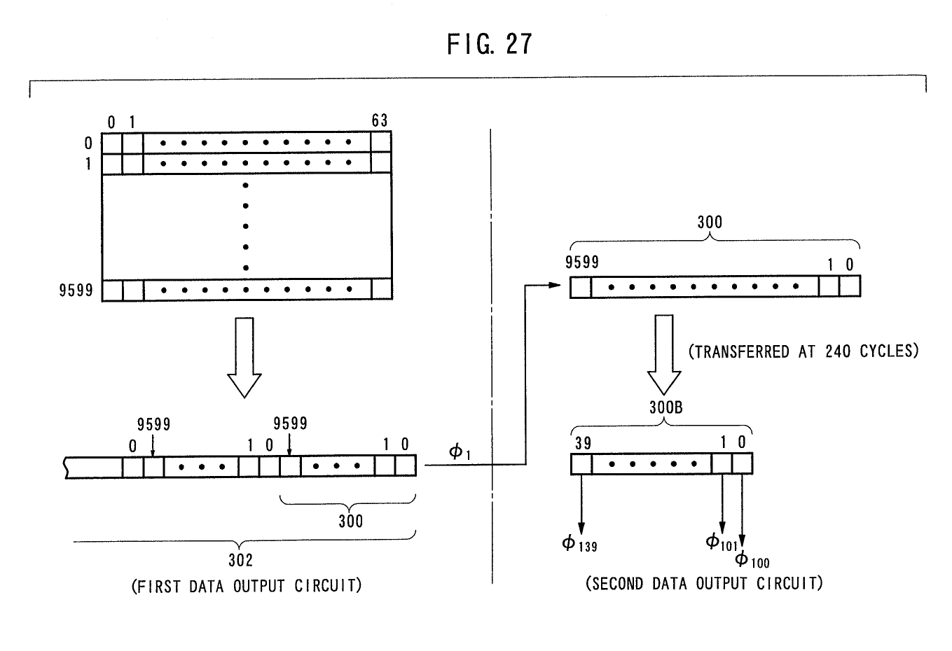

As for one output terminal (for example, the output terminal φ1), as shown in FIG. 27, a bit string 300 of 9600 bits is prepared for 0-bit to 63-bit of the dot data Dd, in which the bit information located at the same bit position of the 9600 individuals of the dot data Dd is aligned in a unit of dot. Further, the bit string data 302 is prepared, in which the bit strings are arranged in an order of 0-bit to 63-bit.

The bit string data 302 is outputted from the output terminal φ1 while effecting bit shift in synchronization with the reference clock of the first data output circuit 270 by 240×40=9600 bits (length of the bit string 300) within a period of time of T/64. When the reference clock is, for example, 40 MHz, the transfer frequency for the bit string 300B of 40 bits for constructing the bit string 300 of 9600 bits is 1 MHz, which is successfully the same as the transfer frequency of the column electrode-driving circuit 204. Therefore, when an IC, which has a reference clock of not less than 40 MHz (for example, 44.9 MHz), is used for the first data output circuit 270, it is possible to transfer the bit string 300 with a sufficient temporal margin.

The second data output circuit 272 makes the output to 40 individuals of the corresponding driver IC's 210B of the column electrode-driving circuit 204 in parallel from 40 individuals of the output terminals φ100 to φ139 every time when the bit string 300B of 40 bits is latched. The series of operation is repeated 240 times, and thus the bit string of 240 bits is stored in the shift register 212 of each of the driver IC's 210B.

Each bit information of the bit string stored in the shift register 212 serves as the dot data Dd. At this point of time, 240 individuals of dot data Dd are outputted in parallel from the shift register 212 to 240 individuals of the corresponding driver outputs 210. The driver output 210 makes conversion into the data signal based on the bit information contained in the dot data Dd, and it makes output to each of the corresponding dots via the data line 72.

The operation described above is successively repeated for all of the dots. Accordingly, a color screen image corresponding to the image data is displayed on the screen of the display 10.

As described above, also in the driving unit 200B according to the second embodiment, in the same manner as in the driving unit 200A according to the first embodiment, it is easy to realize the custom IC architecture for the row electrode-driving circuit 202, it is possible to increase the degree of freedom for the design and the production of the driving unit 200B, and it is possible to realize low electric power consumption as well.

Further, as for the column driver IC, it is unnecessary to use, for IC itself, any expensive one such as those having the high function, for example, PWM modulation. Basically, it is possible to use multiple-output low price IC merely having a data input shift register and a level shifter. These components are also advantageous to miniaturize the mounting contour size of bare chip, TCP or the like. It is easy to save the space for the portion on which the driving IC is mounted. Therefore, it is also easy to realize a thin type of the display 10. This results in the reduction of the production cost of the display 10.

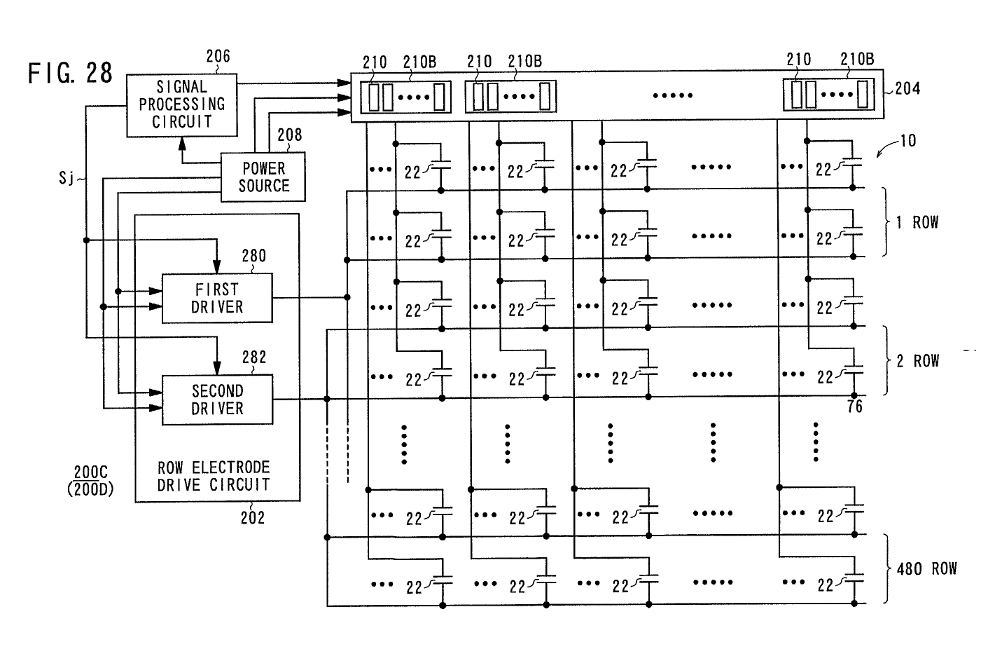

Next, a driving unit 200C according to a third embodiment will be explained with reference to FIGS. 28 to 33.

As shown in FIG. 28, the driving unit 200C according to the third embodiment is constructed in the same manner as the driving unit 200A according to the first embodiment. However, the former is different from the latter in that the row electrode-driving circuit 202 is constructed so that picture elements in odd number rows and picture elements in even number rows are alternately selected in conformity with an image signal based on the interlace system, and that the number of driver outputs 210 for constructing the column electrode-driving circuit 204 is ½ of the number of all dots, i.e., the number of driver IC's 210 is ½ of the number of those in the driving unit 200A according to the first embodiment. One driver output 210 is in charge of the driving for two dots aligned in the vertical direction.

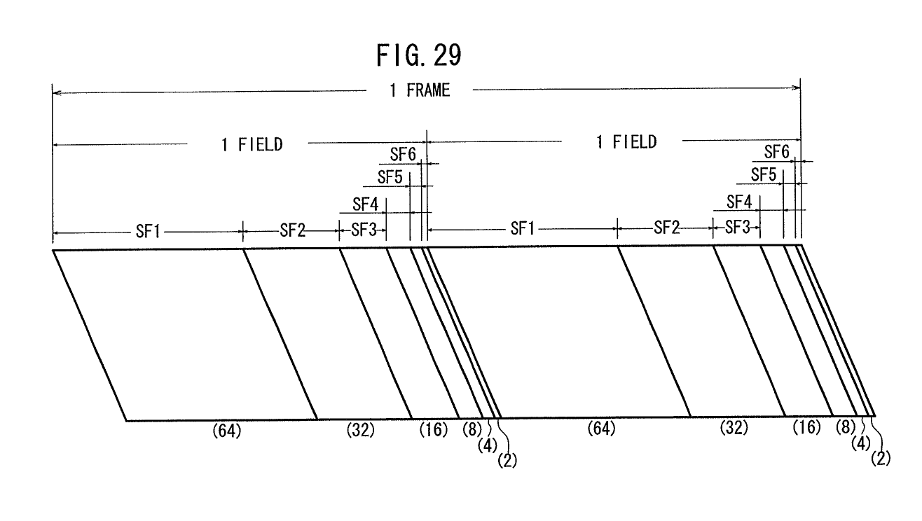

As shown in FIG. 29, the gradation control based on the temporal modulation system in the signal processing circuit 206 of the driving unit 200C according to the third embodiment is performed as follows. That is, it is assumed that the display period for one sheet of image is one frame, a period obtained by dividing the one frame into two is one field, and one divided period obtained by dividing the one field, for example, into six is a subfield. On this assumption, the setting is made such that the initial subfield (first subfield SF1) is the longest, and the length is shortened at a ratio of ½ as the number of subfield increases.

The row electrode-driving circuit 202 includes a first driver which is commonly provided for the odd number rows, and a second driver 282 which is commonly provided for the even number rows. Each of the drivers 280, 282 is constructed such that the select signal and the nonselect signal are alternately outputted for every one field. When the odd number row is selected, the select signal and the nonselect signal are outputted from the first and second drivers 280, 282 respectively. When the even number row is selected, the nonselect signal and the select signal are outputted from the first and second drivers 280, 282 respectively.

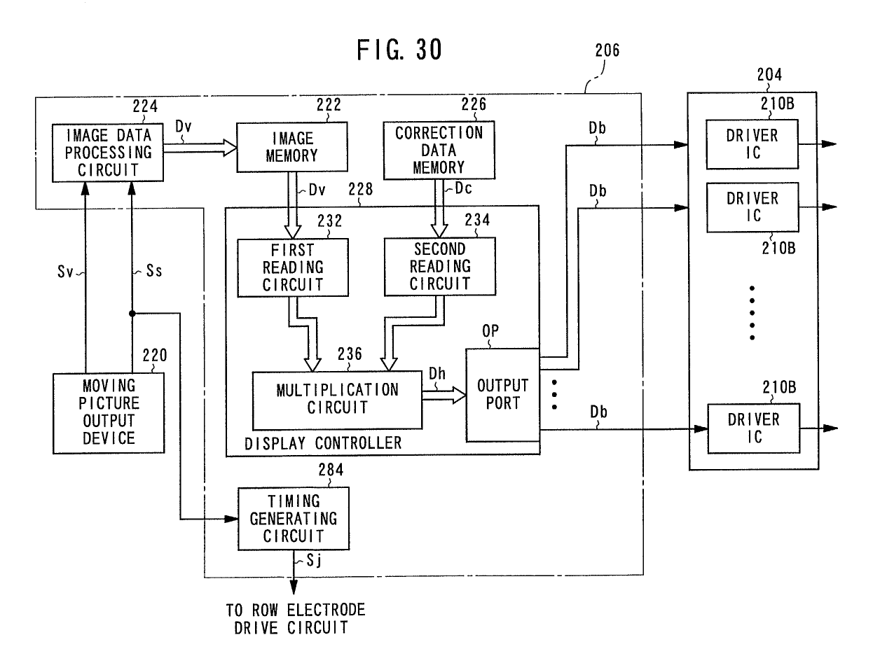

As shown in FIG. 30, the select signal and the nonselect signal are switched in the first and second drivers 280, 282 on the basis of the input of a detection signal Sj from a timing generating circuit 284 provided for the signal processing circuit 206. The timing generating circuit 284 is a circuit for detecting the start timing for the field period on the basis of a synchronization signal Ss supplied from the moving picture output device 220.

The data transfer section 230 (see FIG. 16) of the driving unit 200A according to the first embodiment can be used as the data transfer section 230 which is provided corresponding to the driver output 210 of the column electrode-driving circuit 204. One driver output 210 is allotted to two dots which are aligned in the vertical direction. Therefore, the dot data Dd outputted from the data transfer section 230 is the data corresponding to two dots. That is, the dot data Dd is provided for every two dots.

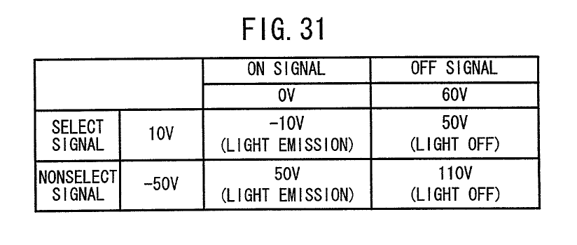

As shown in FIG. 31, the driving unit 200C according to the third embodiment is illustrative of the following case. That is, the select signal to be used is 10 V, and the nonselect signal to be used is −50 V, the signals being outputted from the first and second drivers 280, 282 of the row electrode-driving circuit 202. The ON signal to be used is 0 V, and the OFF signal to be used is 60 V, the signals being outputted by the aid of the respective driver outputs 210 of the column electrode-driving circuit 204.

Therefore, the low level voltage (−10 V) is applied between the column electrode 48b and the row electrode 48a in the actuator element 22 in which the select signal is applied to the row electrode 48a, and the ON signal is applied to the column electrode 48b. The concerning actuator element 22 is in the natural state, i.e., in the light emission state.

The high level voltage (50 V) is applied between the column electrode 48b and the row electrode 48a in the actuator element 22 in which the select signal is applied to the row electrode 48a, and the OFF signal is applied to the column electrode 48b. The concerning actuator element 22 makes the bending displacement in the field diaphragm, giving the light off state.

The high level voltage (50V or 110 V) is applied between the column electrode 48b and the row electrode 48a irrelevant to the ON signal or the OFF signal applied to the column electrode 48b in the actuator element 22 in which the nonselect signal is applied to the row electrode 48a. The concerning actuator element 22 makes the bending displacement in the field diaphragm, giving the light off state.

The driving unit 200C according to the third embodiment is basically constructed as described above. Next, its function and effect will be explained.

At first, as shown in FIG. 30, the synchronization signal Ss and the moving picture signal Sv (for example, the analog moving picture signal) based on, for example, the interlace system are inputted from the moving picture output device 220 into the image data processing circuit 224. The synchronization signal Ss from the moving picture output device 220 is inputted into the timing generating circuit 284.

The image data processing circuit 224 converts the inputted moving picture signal Sv into the digital image data Dv in a unit of field on the basis of the synchronization signal Ss. The digital image data Dv is written into the image memory 222 (field buffer). The timing generating circuit 284 detects the start timing for the one field period Tf from the synchronization signal Ss to make output as the detection signal Sj to the row electrode-driving circuit 202.

The display controller 228 reads the image data Dv from the image memory 222 and the gradation correction data Dc from the correction data memory 226 to multiply them to obtain the corrected image data Dh (image data in which 6-bit dot data is arranged in 2-dot unit).

The corrected image data Dh is rearranged into a data form corresponding to the output terminals respectively at the output port OP, followed by being outputted at a transfer rate of 1 bit/1 MHz in parallel of 238 from the output port OP to be supplied to the corresponding driver IC's 210 respectively.

The bit strings are sent in parallel to the corresponding data transfer section 230 respectively at the stage at which 240 individuals of the bit strings are aligned in the shift register 212 of each of the driver IC's 210B.

The data transfer section 230, which is provided in 2-dot unit, performs the following operation. That is, the dot data Dd sent from the display controller 228 is read at a constant clock (Tf/6). The dot data Dd is outputted at the timing corresponding to the start timing of the subfield SF1 to SF6. The dot data Dd, which is outputted for every 2 dots, is supplied to the corresponding driver outputs 210 respectively.

On the other hand, in the row electrode-driving circuit 202, the odd number row and the even number row are alternately selected for each one field on the basis of the input of the detection signal Sj from the timing generating circuit 284.

The column electrode-driving circuit 204 makes conversion into the data signal based on the bit information contained in the dot data Dd to make output in 2-dot unit aligned in the vertical direction via the data line 72.

That is, the bit information contained in the corresponding dot data Dd is supplied as the data signal to the two dots aligned in the vertical direction while being subjected to increment in synchronization with the start timing for the subfield SF1 to SF6. The data signal is substantially supplied to the dot in the row selected by the row electrode-driving circuit 202, of the two dots aligned in the vertical direction. In the next field period, the data signal is substantially supplied to the dot in the row which is previously unselected.

The operation as described above is successively repeated, and thus a color screen image corresponding to the image data Dv is displayed on the screen of the display 10.

As described above, in the driving unit 200C according to the third embodiment, one dot 26 is constructed by one or more actuator elements 22, and one picture element 28 is constructed by one or more dots 26, wherein there are provided the row electrode-driving circuit 202 for alternately selecting the picture element in the odd number row and the picture element in the even number row, the column electrode-driving circuit 204 for outputting the data signal composed of the light emission signal and the light off signal for each dot on the basis of the image signal to the picture element on the selected row, and the signal processing circuit 206 for controlling the row electrode-driving circuit 202 and the column electrode-driving circuit 204. The row electrode-driving circuit 202 and the column electrode-driving circuit 204 are controlled so that the gradation control is effected at least on the basis of the temporal modulation system by the aid of the signal processing circuit 206. Therefore it is enough to use two types of power source voltages as the power source voltage to be supplied to the row electrode-driving circuit 202. Accordingly, it is easy to realize the custom IC architecture for the row electrode-driving circuit 202. It is possible to increase the degree of freedom for the design and the production of the driving unit 200C. It is possible to realize low electric power consumption as well.

Further, as for the column driver IC, it is unnecessary to use, for IC itself, any expensive one such as those having the high function, for example, PWM modulation. Basically, it is possible to use multiple-output low price IC merely having a data input shift register and a level shifter. These components are also advantageous to miniaturize the mounting contour size of bare chip, TCP or the like. It is easy to save the space for the portion on which the driving IC is mounted. Therefore, it is also easy to realize a thin type of the display 10. This results in the reduction of the production cost of the display 10.

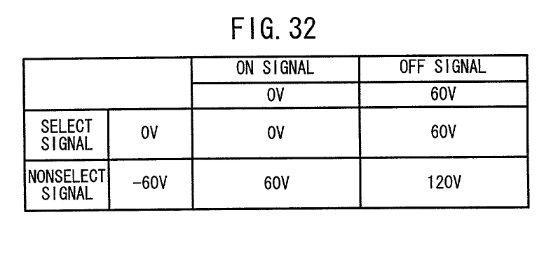

The embodiment described above is illustrative of the case in which the select signal of 10 V and the nonselect signal of −50 V are used, which are outputted from the first and second drivers 280, 282 of the row electrode-driving circuit 202. Alternatively, as shown in FIG. 32, the select signal may be 0 V, and the nonselect signal may be −60 V. In this case, the ground electric potential may be used as the electric potential of the select signal. Therefore, it is possible to decrease the number of power sources by one.

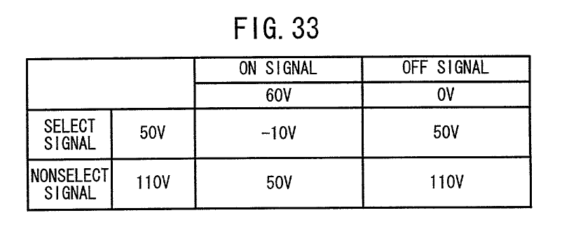

Further alternatively, as shown in FIG. 33, it is also preferable that the polarization of the voltage application is inverted. For example, the select signal to be used may be 50V, the nonselect signal to be used may be 110 V, and the respective potentials of the ON signal and the OFF signal may be 60 V and 0 V. In this case, the polarization direction of the shape-retaining layer 46 is also inverted.

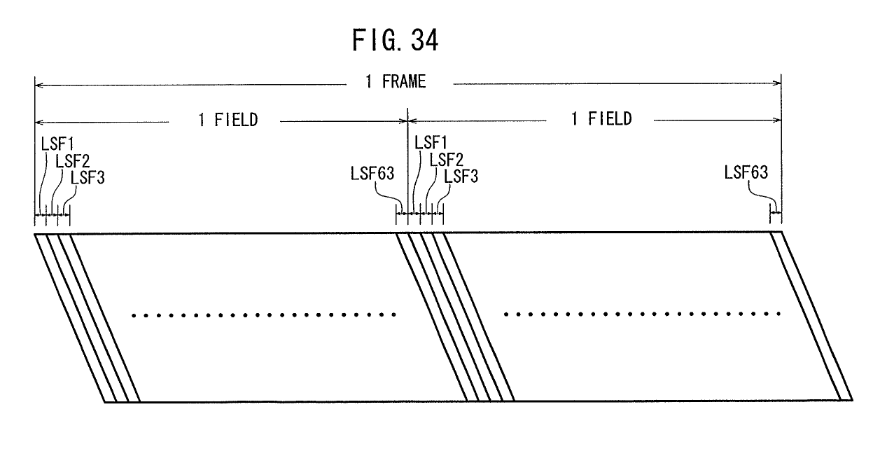

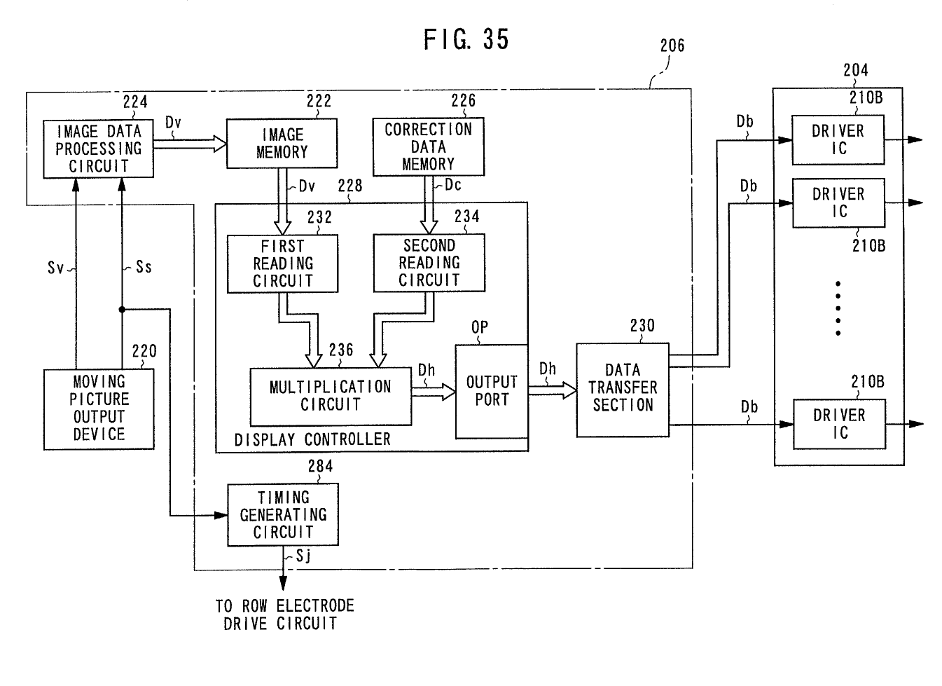

Next, a driving unit 200D according to a fourth embodiment will be explained with reference to FIGS. 34 and 35.

In the driving unit 200D according to the fourth embodiment, the gradation control based on the temporal modulation system in the signal processing circuit 206 is partially different. As shown in FIG. 34, it is assumed that the display period for one sheet of image is one frame, the period obtained by dividing the one frame into two is one field, and one divided period obtained by equally dividing the one field into a plurality of individuals is a linear subfield. On this assumption, the signal processing circuit 206 prepares the dot data by continuously allotting the display period corresponding to each of the gradation levels to the necessary linear subfield for every two dots.

As shown in FIG. 35, the signal processing circuit of the driving unit 200D according to the fourth embodiment is constructed in approximately the same manner as the signal processing circuit 206 of the driving unit 200B according to the second embodiment (see FIG. 23). However, the former is different from the latter in that a timing generating circuit 284 is provided for detecting the start timing for the field period on the basis of the synchronization signal Ss supplied from the moving picture output device 220.

The data transfer section 230 of the driving unit 200B according to the second embodiment can be used for the data transfer section connected to the downstream stage of the display controller 228.

Also in the driving unit 200D according to the fourth embodiment, in the same manner as in the driving unit 200B according to the second embodiment, it is easy to realize the custom IC architecture for the row electrode-driving circuit 202. It is possible to increase the degree of freedom for the design and the production of the driving unit 200D. It is possible to realize low electric power consumption as well.

Further, as for the column driver IC, it is unnecessary to use, for IC itself, any expensive one such as those having the high function, for example, PWM modulation. Basically, it is possible to use multiple-output low price IC merely having a data input shift register and a level shifter. These components are also advantageous to miniaturize the mounting contour size of bare chip, TCP or the like. It is easy to save the space for the portion on which the driving IC is mounted. Therefore, it is also easy to realize a thin type of the display 10. This results in the reduction of the production cost of the display 10.

In the driving units 200C, 200D according to the third and fourth embodiments described above, the picture element in the odd number row and the picture element in the even number row are alternately selected in the row electrode-driving circuit 202. Alternatively, picture elements in three or more rows may be selected one after another in the row electrode-driving circuit 202.

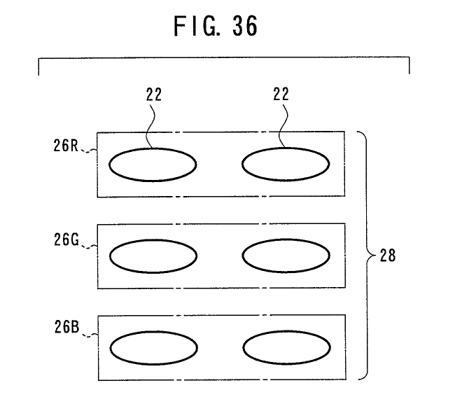

Next, a driving unit 200E according to a fifth embodiment will be explained with reference to FIGS. 36 to 39.

Picture elements of a display component, to which the driving unit 200E according to the fifth embodiment is applied, are constructed and arranged, for example, as shown in FIG. 36. That is, one dot 26 is constructed by two actuator elements which are aligned in the horizontal direction. One picture element 28 is constructed by three dots 26 aligned in the vertical direction (red dot 26R, green dot 26G, and blue dot 26B).

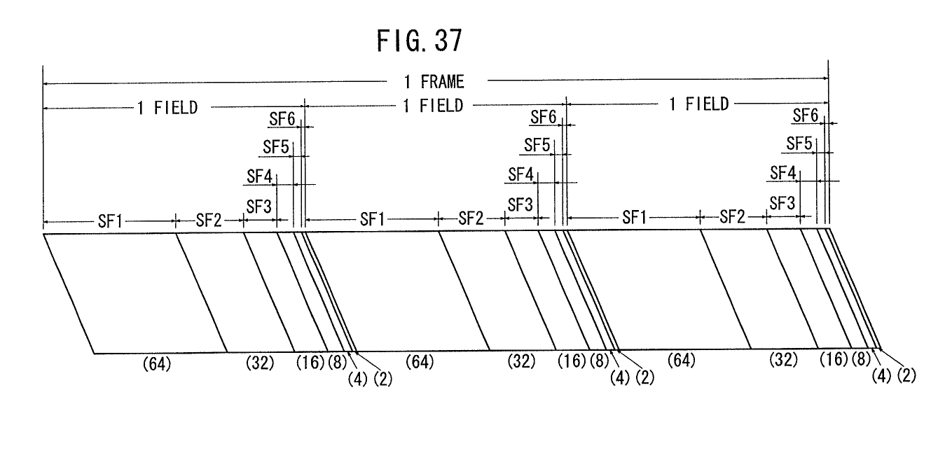

The gradation control, which is based on the temporal modulation system, is performed in the signal processing circuit 206 of the driving unit 200E according to the fifth embodiment as shown in FIG. 37. It is assumed that the display period for one sheet of image is one frame, the period obtained by separating the one frame into three is one field (first field, second field, and third field), and one divided period obtained by dividing the one field, for example, into six is a subfield. On this assumption, the setting is made such that the initial subfield (first subfield SF1) is the longest, and the length is shortened at a ratio of ½ as the number of subfield increases.

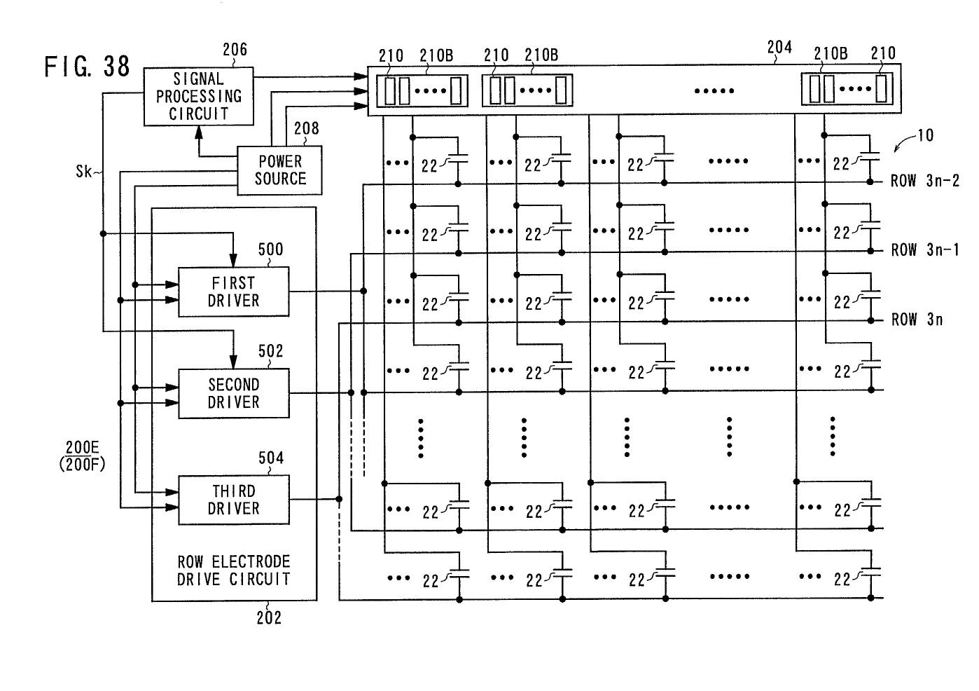

As shown in FIG. 38, the row electrode-driving circuit 202 includes a first driver 500 which is commonly provided for (3n−2) rows, a second driver 502 which is commonly provided for (3n−1) rows, and a third driver 504 which is commonly provided for 3n rows. Each of the drivers 500, 502, 504 is constructed to output the select signal and the nonselect signal for every one field one after another.

When the (3n−2) row is selected, the select signal, the nonselect signal, and the nonselect signal are outputted from the first, second, and third drivers 500, 502, 504 respectively. When the (3n−1) row is selected, the nonselect signal, the select signal, and the nonselect signal are outputted from the first, second, and third drivers 500, 502, 504 respectively. When the 3n row is selected, the nonselect signal, the nonselect signal, and the select signal are outputted from the first, second, and third drivers 500, 502, 504 respectively.

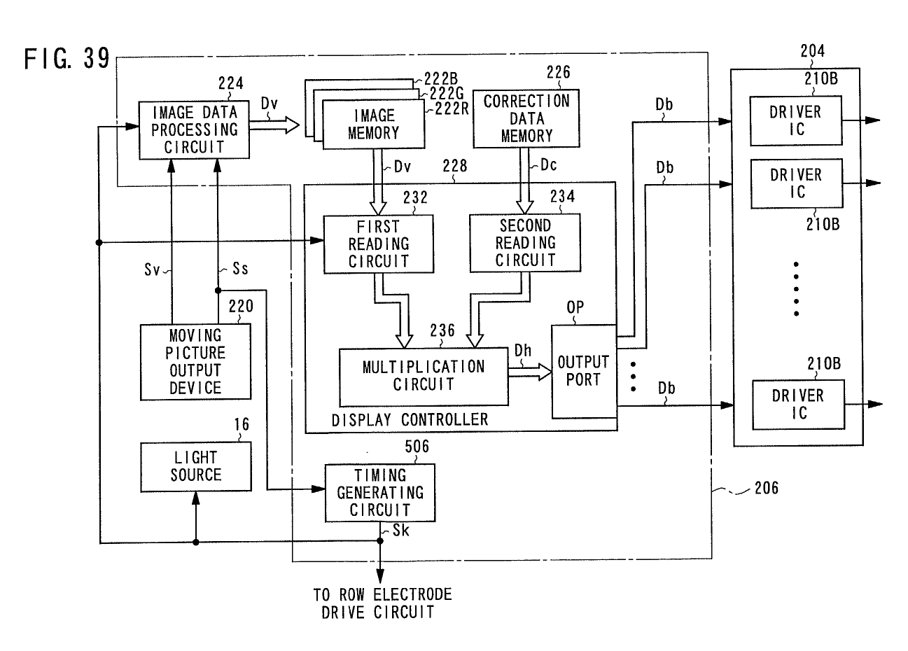

As shown in FIG. 39, the select signal and the nonselect signal are switched in the first, second, and third drivers 500, 502, 504 on the basis of the input of the detection signal Sk from a timing generating circuit 506 provided for the signal processing circuit 206. That is, the row electrode-driving circuit 202 successively selects the dot in the (3n−2) row, the dot in the (3n−1) row, and the dot in the 3n row (n=1, 2, . . .) respectively in conformity with the synchronization signal Ss from the timing generating circuit 506.

The timing generating circuit 506 generates and outputs the detection signal Sk for the timing in which one frame period is divided into three on the basis of the synchronization signal Ss supplied from the moving picture output device 220.

The moving picture signal Sv based on, for example, the progressive system (for example, the analog moving picture signal) from the moving picture output device 220 and the detection signal Sk from the timing generating circuit 506 are inputted into the image data processing circuit 224 of the signal processing circuit 206 to make conversion into the digital image data Dv, for example, in the unit of three primary colors (red, green, and blue) to be written into the image memory for red 222R, the image memory for green 222G, and the image memory for blue 222B respectively.

The first reading circuit 232 is constructed such that the image data Dv is successively read from the three types of the image memories 222R, 222G, 222B on the basis of the input of the detection signal Sk from the timing generating circuit 506.

The light source 16 is constructed such that the three types of light beams (for example, red light beam, green light beam, and blue light beam) are successively switched and radiated on the basis of the input of the detection signal Sk from the timing generating circuit 506.

The column electrode-driving circuit 204 is constructed as follows. That is, the number of driver outputs 210 is ⅓ of the total number of dots, and the number of driver IC's 210B is ⅓ of the number in the driving unit 200A according to the first embodiment. One driver output 210 is in charge of the driving of three dots aligned in the vertical direction.

The data transfer section 230 of the driving unit 200A according to the first embodiment (see FIG. 16) can be used as the data transfer section which is provided corresponding to the driver output 210 of the column electrode-driving circuit 204. One driver output 210 is allotted to three dots aligned in the vertical direction. Therefore, the dot data Dd, which is outputted from the data transfer section 230, is the data for three dots. That is, the dot data Dd is given for every three dots.

In the driving unit 200E according to the fifth embodiment, for example, as shown in FIG. 31, the select signal of 10V and the nonselect signal of −50 V, which are outputted from the first, second, and third drivers 500, 502, 504 of the row electrode-driving circuit, can be used. The ON signal of 0 V and the OFF signal of 60 V, which are outputted from the respective driver outputs 210 of the column electrode-driving circuit 204, can be used.

The driving unit 200E according to the fifth embodiment is basically constructed as described above. Next, its function and effect will be explained.

At first, as shown in FIG. 39, the synchronization signal Ss and the moving picture signal Sv (for example, the analog moving picture signal) based on, for example, the progressive system from the moving picture output device 220 are inputted into the image data processing circuit 224. The synchronization signal Ss from the moving picture output device 220 is inputted into the timing generating circuit 506. The timing generating circuit 506 generates and outputs the detection signal Sk with the timing in which one frame period is divided into three on the basis of the inputted synchronization signal Ss.

The image data processing circuit 224 converts the inputted moving picture signal Sv into the digital image data Dv in the unit of three primary colors (red, green, and blue) on the basis of the detection signal Sk from the timing generating circuit 506. The digital image data Dv is written into the image memory for red 222R, the image memory for green 222G, and the image memory for blue 222B respectively.

The display controller 228 reads the image data Dv from the respective image memories 222R, 222G, 222B and the gradation correction data Dc from the correction data memory 226 to multiply them to obtain the corrected image data Dh (image data in which 6-bit dot data is arranged in 3-dot unit).

The corrected image data Dh is rearranged into a data form corresponding to the output terminals respectively at the output port OP, followed by being outputted at a transfer rate of 1 bit/1 MHz in parallel of 238 from the output port OP to be supplied to the corresponding driver IC's respectively.

The bit strings are sent in parallel to the corresponding data transfer section 230 respectively at the stage at which 240 individuals of the bit strings are aligned in the shift register 212 of each of the driver IC's 210B.

The data transfer section 230, which is provided in the 3-dot unit, performs the following operation. That is, the dot data Dd sent from the shift register 212 is read at a constant clock (Tf/6). The dot data Dd is outputted at the timing corresponding to the start timing of the subfield SF1 to SF6. The dot data Dd, which is outputted for every 3 dots, is supplied to the corresponding driver outputs 210 respectively.

On the other hand, in the row electrode-driving circuit 202, the (3n−2) row, the (3n−1) row, and the 3n row are successively selected for every one field on the basis of the input of the detection signal Sk from the timing generating circuit 506. At this time, the red light beam, the green light beam, and the blue light beam are radiated one by one for every one field from the light source 16 on the basis of the input of the detection signal Sk from the timing generating circuit 506.

The column electrode-driving circuit 204 makes conversion into the data signal based on the bit information contained in the dot data Dd to make output in the 3-dot unit aligned in the vertical direction via the data line 72.

That is, the bit information contained in the corresponding dot data Dd is supplied as the data signal to the three dots aligned in the vertical direction while being subjected to increment in synchronization with the start timing for the subfield SF1 to SF6. The data signal is substantially supplied to the dot in the (3n−2) row (row concerning the red color) selected by the row electrode-driving circuit 202, of the three dots aligned in the vertical direction, in the period of the first field (for example, the period in which the red light beam is radiated). In the next second field period (for example, the period in which the green light beam is radiated), the data signal is substantially supplied to the dot in the (3n−1) row (row concerning the green color) which is previously unselected. In the next third field period (for example, the period in which the blue light beam is radiated), the data signal is substantially supplied to the dot in the 3n row (row concerning the blue color) which is previously unselected.

The operation as described above is successively repeated, and thus a color screen image corresponding to the image data Dv is displayed on the screen of the display 10.

As described above, in the driving unit 200E according to the fifth embodiment, one dot 26 is constructed by one or more actuator elements 22, and one picture element 28 is constructed by one or more dots 26, wherein there are provided the row electrode-driving circuit 202 for successively selecting the picture element in the (3n−2) row, the picture element in the (3n−1) row, and the picture element in the 3n row (n=1, 2 . . .), the column electrode-driving circuit 204 for outputting the data signal composed of the light emission signal and the light off signal for each dot on the basis of the image signal to the picture element on the selected row, and the signal processing circuit 206 for controlling the row electrode-driving circuit 202 and the column electrode-driving circuit 204. The row electrode-driving circuit 202 and the column electrode-driving circuit 204 are controlled so that the gradation control is effected at least on the basis of the temporal modulation system by the aid of the signal processing circuit 206. Therefore it is enough to use two types of power source voltages as the power source voltage to be supplied to the row electrode-driving circuit 202. Accordingly, it is easy to realize the custom IC architecture for the row electrode-driving circuit 202. It is possible to increase the degree of freedom for the design and the production of the driving unit 200E. It is possible to realize low electric power consumption as well.

Further, as for the column driver IC (column electrode-driving circuit 204), it is unnecessary to use, for IC itself, any expensive one such as those having the high function, for example, PWM modulation. Basically, it is possible to use multiple-output low price IC merely having a data input shift register and a level shifter. These components are also advantageous to miniaturize the mounting contour size of bare chip, TCP or the like. It is easy to save the space for the portion on which the driving IC is mounted. Therefore, it is also easy to realize a thin type of the display 10. This results in the reduction of the production cost of the display 10.

Especially, in the driving unit 200E according to the fifth embodiment, the light beams of the three primary colors are radiated from the light source 16. Therefore, the blank luminance (light emission luminance caused, for example, by any defect of the optical waveguide plate other than the picture element light emission portion) is ⅓ as compared with a case in which a white light source is used. Thus, it is possible to improve the contrast.

Further, for example, when the red light beam is radiated from the light source 16, the dot concerning the red color is allowed to emit light. Therefore, the color purity is improved, and it is possible to effectively improve the image quality.

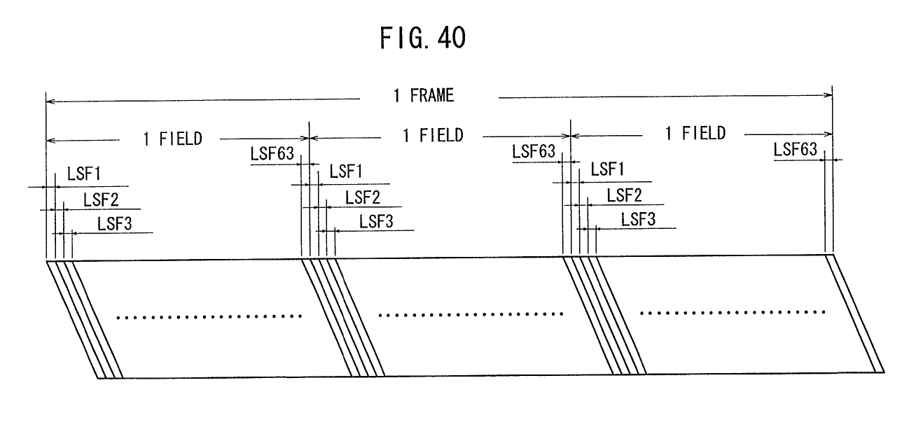

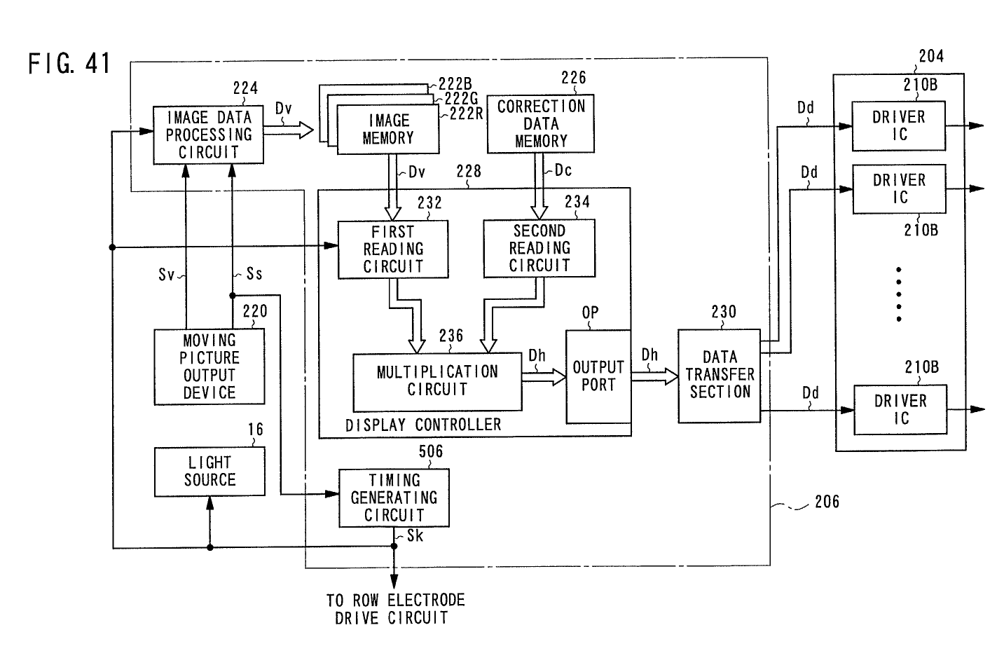

Next, a driving unit 200F according to a sixth embodiment will be explained with reference to FIGS. 40 and 41.

In the driving unit 200F according to the sixth embodiment, the gradation control based on the temporal modulation system in the signal processing circuit 206 is partially different. As shown in FIG. 40, it is assumed that the display period for one sheet of image is one frame, the period obtained by separating the one frame into three is one field, and one divided period obtained by equally dividing the one filed into a plurality of individuals is a linear subfield. On this assumption, the signal processing circuit 206 continuously allots the display time corresponding to each of the gradation levels to the necessary linear subfield for every three dots to prepare the dot data.

As shown in FIG. 41, the signal processing circuit of the driving unit 200F according to the sixth embodiment is constructed in approximately the same manner as the signal processing circuit 206 of the driving unit 200D according to the fourth embodiment (see FIG. 35). However, the former is different from the latter in that a timing generating circuit 506 is provided for outputting the detection signal Sk corresponding to the start timing for the field period on the basis of the synchronization signal Ss supplied from the moving picture output device 220.

The data transfer section 230 of the driving unit 200B according to the second embodiment can be used for the data transfer section which is connected to the downstream stage of the display controller 228.

Also in the driving unit 200F according to the sixth embodiment, in the same manner as in the driving unit 200B according to the second embodiment, it is easy to realize the custom IC architecture for the row electrode-driving circuit 202. It is possible to increase the degree of freedom for the design and the production of the driving unit 200F. It is possible to realize low electric power consumption as well.

Further, as for the column driver IC (column electrode-driving circuit 204), it is unnecessary to use, for IC itself, any expensive one such as those having the high function, for example, PWM modulation. Basically, it is possible to use multiple-output low price IC merely having a data input shift register and a level shifter. These components are also advantageous to miniaturize the mounting contour size of bare chip, TCP or the like. It is easy to save the space for the portion on which the driving IC is mounted. Therefore, it is also easy to realize a thin type of the display 10.

For example, as shown in FIG. 2, the display 10 or the display component 14, to which the driving units 200A to 200F according to the first to sixth embodiments are applied, is operated as follows. That is, the light emission is effected in the natural state of the actuator element 22. When the high level voltage is applied between the row electrode 48a and the column electrode 48b of the actuator element 22, the actuator element 22 is allowed to make the bending displacement to be convex toward the hollow space 34 to effect the light off. Alternatively, the following arrangement may be used. That is, when the actuator element 22 is subjected to the ON operation/OFF operation by allowing the picture element assembly 30 to make contact or separation with respect to the back surface of the optical guide plate 20, the static electricity is generated between the back surface of the optical guide plate 20 and the contact surface (end surface) of the picture element assembly 30, in addition to the strain generated by applying the voltage to the shape-retaining layer 46. The attractive force and/or the repulsive force caused by the static electricity may be utilized for the ON operation/OFF operation of the actuator element 22.

As a result, the following arrangement is available. That is, the dielectric polarization is generated during the driving of the actuator element 22 to improve the ON characteristic of the actuator element 22 (for example, the contact performance of the picture element assembly 30 and the response performance in the contact direction) by utilizing the attractive force caused by the static electricity. Further, the OFF characteristic other than the ON characteristic of the actuator element 22 (for example, the separation performance of the picture element assembly 30 and the response performance in the separation direction) can be also improved by utilizing not only the attractive force but also the repulsive force caused by the static electricity.

For example, when it is intended to improve only the ON characteristic of the actuator element 22, a coating material is simply arranged on the contact surface (end surface) of the picture element assembly 30 and the optical guide plate 20 itself or the back surface of the optical guide plate 20 so that they are subjected to the dielectric polarization.

Further, for example, when both of the ON characteristic and the OFF characteristic of the actuator element 22 are improved, a transparent electrode or a metal thin film is arranged at the back surface of the optical guide plate 20 to switch the electric polarization so that both of the attractive force and the repulsive force by the static electricity are generated with respect to the contact surface of the picture element assembly 30 subjected to the dielectric polarization.

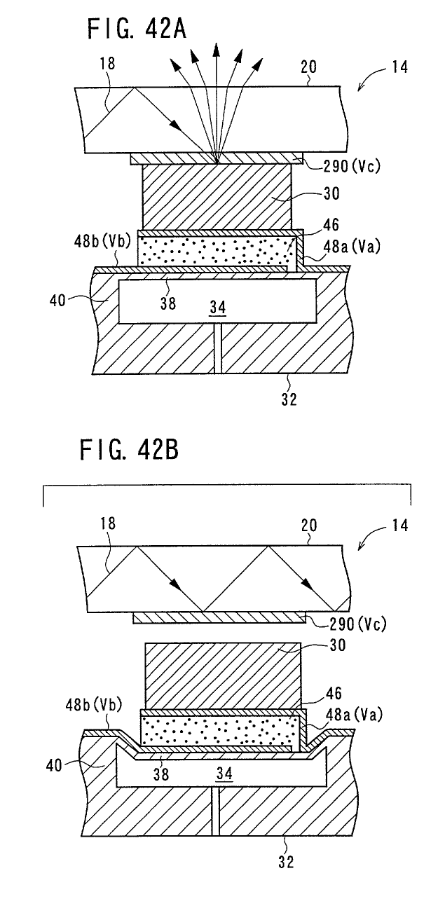

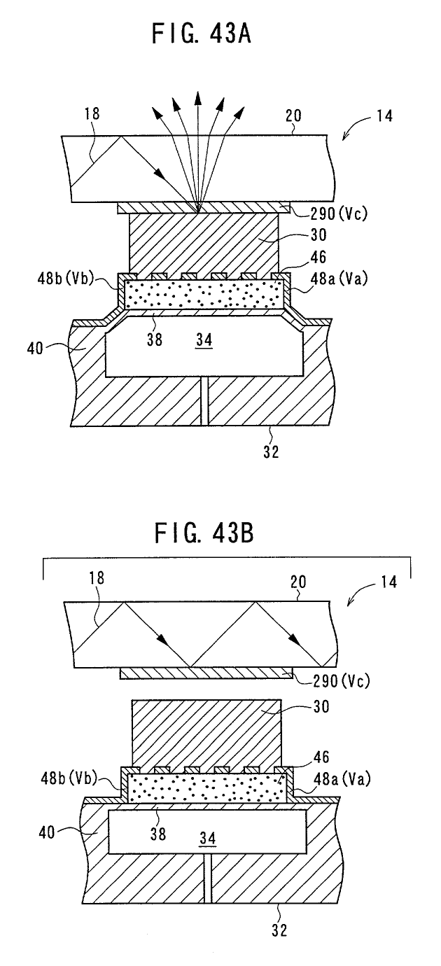

Specifically, the arrangement described above will be explained with reference to FIGS. 42A to 43B. In a display component 14 shown in FIGS. 42A and 42B, the light emission is effected in the natural state of the actuator element 22, the row electrode 48a is formed on the upper surface of the shape-retaining layer 46, and the column electrode 48b is formed on the lower surface thereof, for example, as shown in FIG. 4. In the display component 14, a transparent electrode 290 is formed at each of positions corresponding to the actuator elements 22, of the back surface of the optical guide plate 20.

As shown in FIG. 42A, when the actuator element 22 is subjected to the ON operation to emit light, then the voltage (Vc>Va) is applied between the row electrode 48a and the transparent electrode 290 corresponding to the concerning actuator element 22, and the voltage between the row electrode 48a and the column electrode 48b is approximately zero (Va≈Vb).

Accordingly, the picture element assembly 30 is pressed toward the optical guide plate 20 by the aid of the electrostatic attracting force effected between the transparent electrode 290 and the row electrode 48a. Owing to the pressing force, it is possible to improve the luminance, and it is possible to improve the response speed.

On the other hand, as shown in FIG. 42B, when the actuator element 22 is subjected to the OFF operation to turn off the light, then the voltage between the row electrode 48a and the transparent electrode 290 corresponding to the concerning actuator element 22 is approximately zero (Vc≈Va), and the voltage (Va<Vb) is applied between the row electrode 48a and the column electrode 48b.

Accordingly, the actuator element 22 makes the bending displacement to be convex toward the hollow space 34, and thus the picture element assembly 30 is separated from the optical guide plate 20.

The transparent electrode 290 may be formed on either the back surface of the optical waveguide plate 30 or the end surface of the picture element assembly 30. However, it is preferable that the transparent electrode 290 is formed on the end surface of the picture element assembly 30, because of the following reason. That is, the distance with respect to the row electrode 48a on the actuator element 22 is decreased, and it is possible to generate larger electrostatic force.

The transparent electrode 290 which is formed on the back surface of the optical guide plate 20, is effective to improve the separation performance of the picture element assembly 30. In general, any local surface charge is generated on the picture element assembly 30 and the optical guide plate 20 in accordance with the contact or separation of the picture element assembly 30. The generation of the surface charge facilitates the picture element assembly 30 to make contact with the optical guide plate 20. However, in this case, an inconvenience tends to occur such that the picture element assembly 30 is stuck to the optical guide plate 20.

Accordingly, when the transparent electrode 290 is formed on the back surface of the optical guide plate 20, then the generation of the local surface charge is mitigated, the inconvenience (sticking) is reduced, and the separation performance of the picture element assembly 30 is improved.

The arrangement, in which the transparent electrode 290 is formed to utilize the static electricity, is also applicable to a display component 14 as shown in FIGS. 43A and 43B, i.e., a display component 14 in which a pair of electrodes (row electrode 48a and column electrode 48b) are formed on the upper surface of the shape-retaining layer 46.

That is, when the transparent electrode 290 is formed on the back surface of the optical guide plate 20, and the voltage (Vc>Va, Vc>Vb) is applied between the transparent electrode 290 and the pair of electrodes 48a, 48b provided on the upper surface of the actuator element 22, then the static electricity is generated between the both.

A case is now considered, in which the light off is effected in the natural state of the actuator element 22. When the concerning actuator element 22 is subjected to the ON operation to emit light, then the actuator element 22 makes the bending displacement toward the optical guide plate 20 by the aid of the voltage (Va<Vb<Vc) between the pair of electrodes 48a, 48b, and the picture element assembly 30 quickly approaches the optical guide plate 20 by the aid of the attracting force of the static electricity to give the light emission state. On the other hand, in a state in which no voltage is applied between the transparent electrode 290 and the pair of electrodes 48a, 48b (Va≈Vb≈Vc), the actuator element 22 is subjected to the OFF operation to make separation from the optical guide plate 20 in accordance with the rigidity of the actuator element 22. Thus, the light off state is given.

The driving units 200A to 200F according to the first to sixth embodiments are also applicable to a display 10 constructed by arranging a large number of display components 14 based on the use of the static electricity as described above.

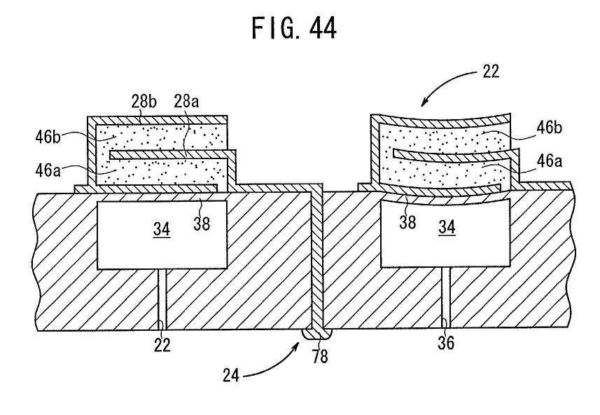

In the display 10 to which the driving units 200A to 200F according to the first to sixth embodiments are applied, the actuator element 22, especially the shape-retaining layer 46 is constructed to have the one-layered structure. Alternatively, as shown in FIG. 44, the shape-retaining layer 46 may have a multilayered structure, and a pair of electrodes 48a, 48b are alternately formed on each of the layers. The embodiment shown in FIG. 44 is illustrative of a case in which the column electrode 48b is formed on the lower surface of the first layer of the shape-retaining layer 46a and the upper surface of the second layer of the shape-retaining layer 46b, and the row electrode 48a is formed between the first layer and the second layer. When the shape-retaining layer 46 is allowed to have the multiple layers to alternately form the pair of electrodes 48a, 48b as described above, then it is possible to improve the power (displacement force) of the actuator element 22, and it is possible to improve the separation performance of the picture element assembly 30 (see FIG. 2).

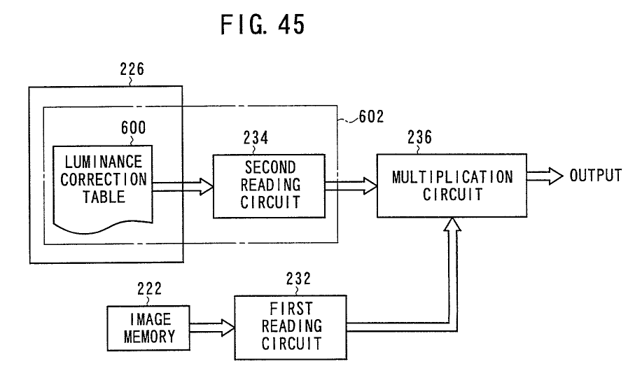

In the driving units 200A to 200F according to the first to sixth embodiments, as shown in FIG. 45, a luminance correction table 600, in which at least the luminance correction data for correcting the luminance dispersion for each dot is developed, may be used as the information for the correction to be stored in the correction data memory 226. In this case, the luminance correction table 600 developed in the correction data memory 226 and the second reading circuit 234 function as the luminance-correcting means 602.

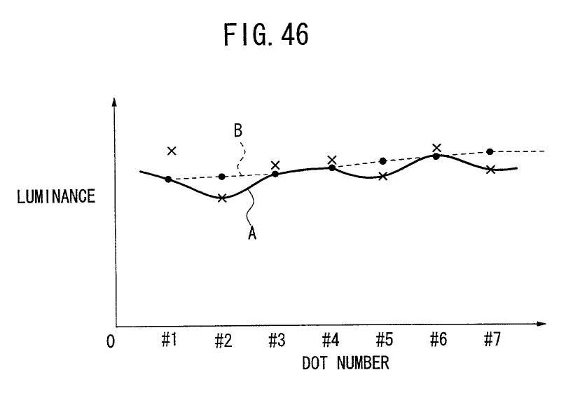

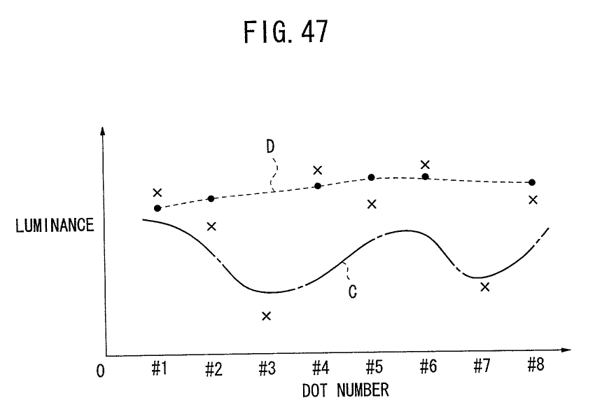

The luminance-correcting function will now be explained with reference to FIGS. 46 and 47. At first, the luminance correction table 600 is prepared. However, as a prerequisite therefor, the luminance dispersion is measured for each dot of the display 10.

Specifically, for example, a signal of an intermediate level of the gray scale (for example, the gradation level of 128 provided that the full scale resides in the gradation level of 256) is given to all of the dots of the display 10 to make display. In this state, for example, a CCD camera is used to measure the respective luminances of all of the dots to determine the measured luminance distribution of the display 10.

After that, the smoothing process is performed for the measured luminance distribution on the basis of the actually measured value of the luminance of each of the measured dots to determine the theoretical luminance distribution. The smoothing process includes, for example, the averaging process, the least square method, and the higher-order curve approximation.

FIGS. 46 and 47 show, for example, the luminance distribution of the respective dots in the first row. In these drawings, the plot indicated by cross marks represents the actually measured luminance distribution, and the plot indicated by circles represents the theoretical luminance distribution.

As shown in FIG. 46, when the dispersion of the actually measured luminance values of the respective dots in the actually measured luminance distribution is small, and the smooth theoretical luminance distribution (see curve B) is obtained by the smoothing process, then the luminance correction is performed for all of the dots.

A specified technique for correcting the luminance will be explained. For example, as shown with the dots #1, #3, #4, and #6 in FIG. 46, when the measured luminance value is larger than the theoretical luminance value, a value less than 1 is used as the correction coefficient for the following expression.

Measured luminance value×Correction coefficient≈Theoretical luminance value

The correction coefficient, which satisfies the foregoing expression, is registered as the luminance correction data for the concerning dot in the luminance correction table 600.

On the other hand, for example, as shown with the dots #2, #5, and #7 in FIG. 46, when the measured luminance value is smaller than the theoretical luminance value, 1 is used as the correction coefficient. The correction coefficient is registered as the luminance correction data in the luminance correction table 600. As a result, it is possible to obtain a luminance distribution (see curve A) which is uniformized as compared with the measured luminance distribution in which those of cross marks are plotted.

In some of the completed displays 10, as shown in FIG. 47, the actually measured luminance value is locally low in some cases. In FIG. 47, the dots #3 and #7 are extremely low. Even when the smoothing process is performed as they are, the theoretical luminance distribution is not smoothened as shown by the curve C. Further, the average luminance is unnecessarily lowered in some cases.

In such a case, the dots having the extremely low measured luminance values are ignored to perform the smoothing process. Accordingly, the theoretical luminance distribution having a smooth curve is determined as shown by the curve D. The specified technique for correcting the luminance is carried out in the same manner as described above.

As described above, when the luminance-correcting means 602 is used, then the luminance dispersion of the respective dots upon the production is absorbed, and it is possible to improve the image quality.

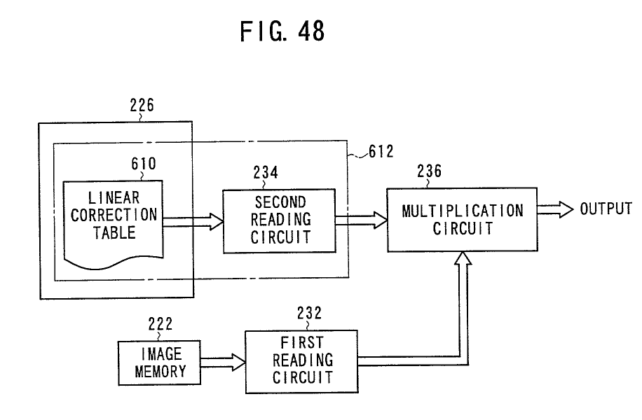

Alternatively, in the driving units 200A to 200F according to the first to sixth embodiment, as shown in FIG. 48, it is also preferable that a linear correction table 610, in which the linear correction data is developed to allow the display characteristic for the gradation level of each of the dots to be linear, is used as the information for the correction to be stored in the correction data memory 226. In this case, the linear correction table 610 developed in the correction data memory 226 and the second reading circuit 234 function as a linear correcting means 612.

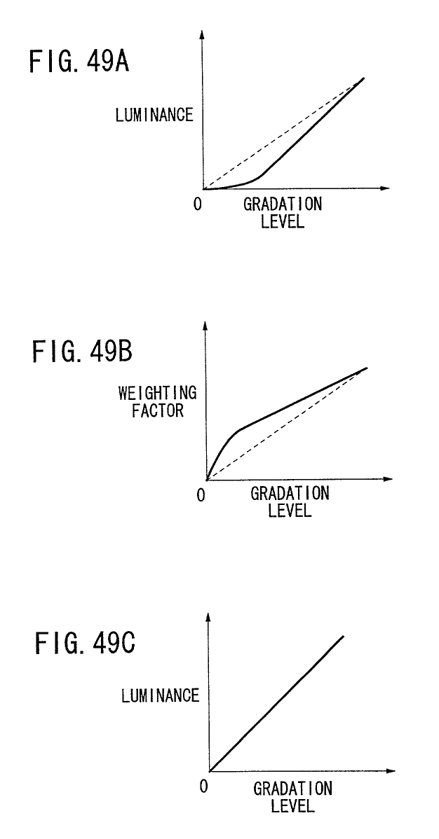

The linear correcting function will now be explained with reference to FIGS. 49A to 49C. At first, the linear correction table 610 is prepared. However, as a prerequisite therefor, the luminance of each of the dots of the display 10 is measured in the same manner as in the luminance correction described above.

Specifically, for example, a signal, in which the gray scale is increased in a stepwise manner, is given to all of the dots of the display 10 to make display. In this state, for example, a CCD camera is used to measure the characteristic of the change of luminance (light emission luminance characteristic) with respect to the change of the gradation level of the gray scale for all of the dots. The number of plots for the respective dots is determined depending on the capacity and the operation speed of the correction data memory 226. FIG. 49A shows a light emission luminance characteristic for a certain dot.

After that, the weighting factor for linearizing the light emission luminance characteristic is determined for each of the dots respectively on the basis of the measured light emission luminance characteristic of each of the dots. FIG. 49B shows a characteristic of the change of the weighting factor corresponding to the light emission luminance characteristic of a certain dot.

The weighting factor for each dot is determined in an amount of the plot made to determine the light emission luminance characteristic described above. The array of the weighting factors of the number corresponding to the number of the plots is defined as a look-up table for the linearization in relation to the concerning dot. The look-up table as described above is determined for each of the dots to be registered as the linear correction table 610 in the correction data memory 226. The weighting factor between the plots may be determined, for example, in accordance with the first-order approximation (line approximation) at the display stage.

At the actual display stage, the input gradation level of a certain dot is read by the aid of the first reading circuit 232. The weighting factor corresponding to the input gradation level read from the look-up table or the weighting factor determined by the first-order approximation in relation to the concerning dot is read by the aid of the second reading circuit 234. The value of (input gradation data value×weighting factor) is calculated by the multiplication circuit 236 disposed at the downstream stage to make output as the linearized gradation data (see FIG. 49C).

As described above, when the linear correcting means 612 is used, the display characteristic is changed linearly depending on the change of the gradation level in each of the dots. Therefore, it is possible to make the correct image display. Further, it is possible to improve the contrast. It is possible to allow the display image to have sharp feeling.

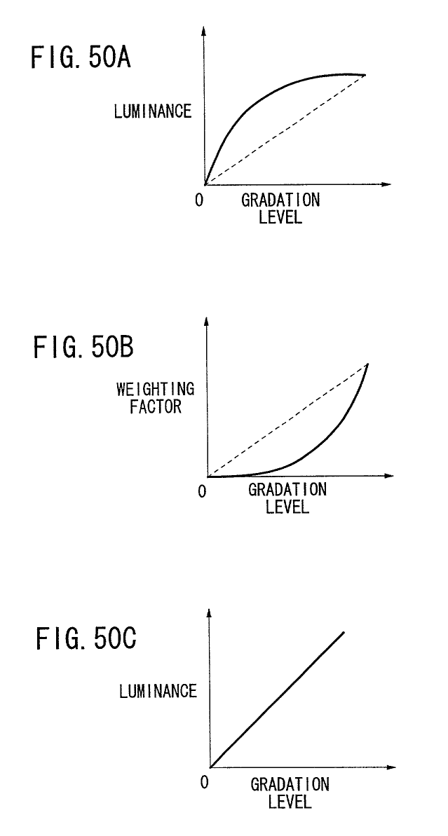

When a screen image of the television signal is displayed by the aid of the display 10, the linear correction process is performed as follows. That is, for example, in the case of the presently used color television system, the gamma control is performed on the image transmission side (sending side) in order to reduce the cost of the television receiver. The gamma control is persistently directed to the Braun tube. Therefore, a light emission luminance characteristic is given as shown in FIG. 50A. For this reason, if the screen image of the television signal applied with the gamma control is displayed as it is by using the display 10, the following problems arise. That is, the resolution is lowered at portions of the image having high chroma, and the sharp feeling disappears.

In view of the above, in the embodiment of the present invention, as shown in FIG. 50B, the array of weighting factors to counteract the gamma control may be defined as a look-up table for the linearization concerning the respective dots.

Accordingly, as shown in FIG. 50C, the display characteristic (display characteristic applied with the gamma control) with respect to the gradation level in the sending system (image transmission system) can be linearly corrected. Therefore, even when the television signal applied with the gamma control is displayed, the decrease in resolution of the high chroma portion of the image disappears. It is possible to allow the displayed image to have the sharp feeling.

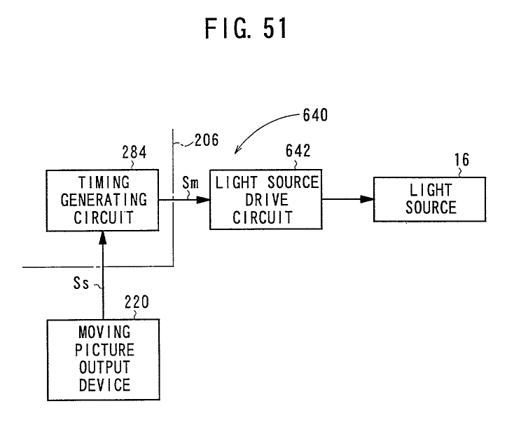

As shown in FIG. 51, the driving units 200A to 200F according to the first to sixth embodiments may have a dimming control means 640 for switching, at least at two stages, the power of the light source 16 at an arbitrary timing in one frame.

The power of the light source 16 may be switched by the dimming control means 640 by using a light source-driving circuit 642 on the basis of the input of a detection signal Sm from the timing generating circuit 284 provided for the signal processing circuit 206. The timing generating circuit 284 detects the switching timing for the power of the light source 16 on the basis of the synchronization signal Ss supplied from the moving picture output device 220.

For example, explanation will be made on the basis of the driving unit 200B according to the second embodiment. As shown in FIG. 21, the driving unit 200B according to the second embodiment is operated as follows. That is, it is assumed that the display period for one sheet of image is one frame, and one divided period, which is obtained by equally dividing the one frame, for example, into 63 individuals, is a linear subfield. On this assumption, the signal processing circuit 206 continuously allots the display time corresponding to each of the gradation levels to the necessary linear subfield for each dot to prepare the dot data.

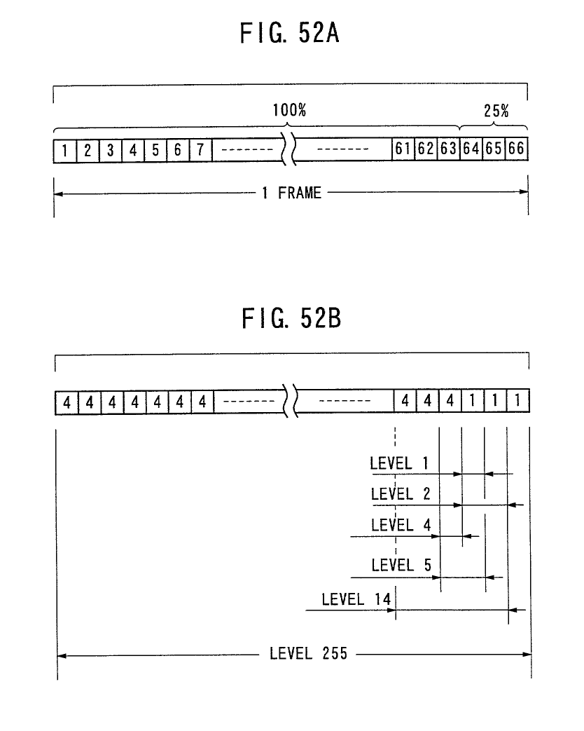

Accordingly, in this embodiment, as shown in FIG. 52A, three linear subfields are added to the end of 63 individuals of the linear subfields. The power of the light source 16 is 100% for the period ranging from the first linear subfield LSF1 to the 63rd linear subfield LSF63. The power of the light source 16 is 25% for the period ranging from the 64th linear subfield LSF64 to the 66th linear subfield LSF66 disposed thereafter.

Accordingly, even when all of the display periods of the respective linear subfields are identical, each of the linear subfields ranging from the first linear subfield LSF1 to the 63rd linear subfield LSF63 has the luminance which is four times that of each of the linear subfields ranging from the 64th linear subfield LSF64 to the 66th linear subfield LSF66.

Therefore, as shown in FIG. 52B, when the gradation level of 1 is expressed, the ON signal is outputted to the 64th linear subfield LSF64. When the gradation level of 2 is expressed, the ON signal is continuously outputted to the 64th and 65th linear subfields LSF64 and LSF65. When the gradation of 4 is expressed, the ON signal is outputted to the 63rd linear subfield LSF63. When the gradation level of 5 is expressed, the ON signal is continuously outputted to the 63rd and 64th linear subfields LSF63 and LSF64. When the gradation level of 14 is expressed, the ON signal is continuously outputted to the 61st and 65th linear subfields LSF61 and LSF65.

That is, in this embodiment, the expression can be made up to the 256 gradations (0 to 255) only by adding the three linear subfields LSF64 to LSF66, although the expression is otherwise successful for only the 64 gradations. Because only the three linear subfields LSF64 to LSF66 are added, it is almost unnecessary to change the display period for one linear subfield as compared with the construction in which one frame is formed by 64 individuals of the linear subfields. The problem concerning the design change scarcely arises. Further, the luminance is hardly lowered when the white color is displayed, because the period, in which the power of the light source 16 is 25%, is the short period which is 3/66 of one frame.

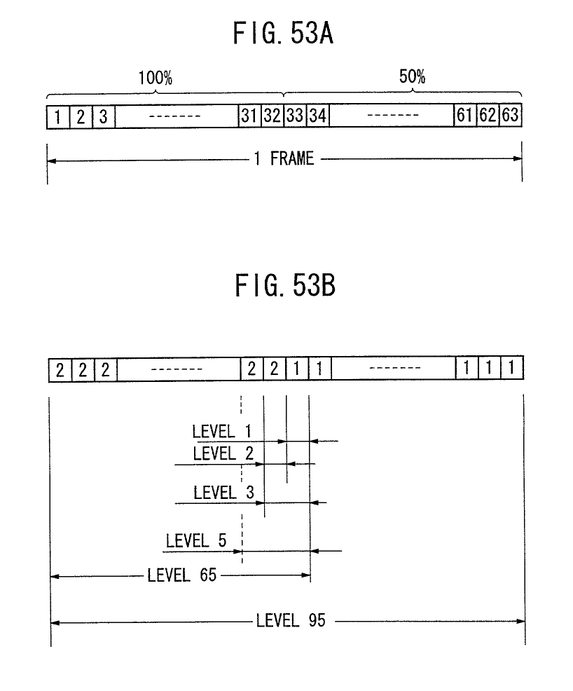

In the embodiment described above, the three linear subfields LSF64 to LSF66 are added after 63 individuals of the linear subfields LSF1 to LSF63 to switch the power of the light source 16 between 100% and 25%. Alternatively, as shown in FIG. 53A, the power of the light source 16 may be 100% for the former half 32 individuals of the linear subfields LSF1 to LSF32 of the 63 individuals of the linear subfields LSF1 to LSF63, and the power of the light source 16 may be 50% for the latter half of the 31 individuals of the linear subfields LSF33 to LSF63.

In this case, even when all of the display periods for the respective linear subfields are identical, each of the linear subfields of the former half of the 1st to 32nd linear subfields LSF1 to LSF32 has the luminance which is twice that of each of the linear subfields of the latter half of the 33rd to 63rd linear subfields LSF33 to LSF63.

Therefore, as shown in FIG. 53B, when the gradation level of 1 is expressed, the ON signal is outputted to the 33rd linear subfield LSF33. When the gradation level of 2 is expressed, the ON signal is outputted to the 32nd linear subfield LSF32. When the gradation of 3 is expressed, the ON signal is continuously outputted to the 32nd and 33rd linear subfields LSF32 and LSF33. When the gradation of 5 is expressed, the ON signal is continuously outputted to the 31st to 33rd linear subfields LSF31 to LSF33.

That is, in this embodiment, the expression can be made for the 96 gradations (0 to 95), although the expression is otherwise successful for only the 64 gradations. When the power of the light source 16 is 100% for all of the 63 individuals of the linear subfields LSF1 to LSF63, it is possible to realize low electric power consumption, because the period, in which the power of the light source 16 is 50%, is added at an arbitrary timing in this embodiment, as compared with a case in which the power of the light source 16 is 100% even when the gradational expression is made for the low level.

In this embodiment, the following procedure may be available. That is, the average luminance of the image of the next frame accumulated in the image memory 22 is analyzed. If the image has the high average luminance, the power of the light source 16 is fixed to 100% for the next frame to perform the gradational expression with the 63 individuals of the linear subfields LSF1 to LSF63. In this case, it is possible to avoid a phenomenon in which the image is viewed while the luminance is lowered as a whole.

Those usable as the light source 16 include a high speed cold cathode tube excellent in response characteristic (with a rising speed within 0.1 ms), LED (with a rising speed within 20 ns), and a fluorescent tube arranged for a cathode with carbon nano tube-field emitter.

Next, the driving method as described below may be adopted for the driving units 200A to 200F according to the first to sixth embodiments.

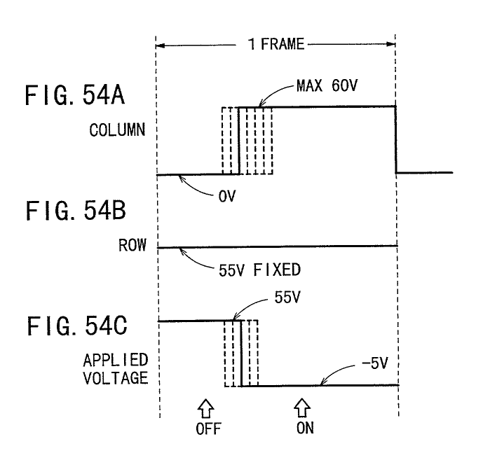

At first, explanation will be made, for example, for the ordinary driving in the driving unit 200B according to the second embodiment. As shown in FIG. 54A, when the consideration is made for one dot, the period in which the OFF signal is to be outputted and the period in which the ON signal is to be outputted are determined depending on the gradation level of the concerning dot.

In the period in which the OFF signal is to be outputted, for example, 0 V is applied to the column electrode 48b as shown in FIG. 54A, and for example, 55 V (fixed) is applied to the row electrode 48a as shown in FIG. 54B. The difference in electric potential therebetween, i.e., 55 V is applied to the concerning dot as shown in FIG. 54C, resulting in the light off state. At the point of time of approach to the period in which the ON signal is to be outputted, for example, maximum 60 V is applied to the column electrode 48b as shown in FIG. 54A, and for example, 55 V (fixed) is applied to the row electrode 48a as shown in FIG. 54B. The difference in electric potential therebetween, i.e., −5 V is applied to the concerning dot as shown in FIG. 54C, giving the light emission state.

In the ordinary operation as described above, the gradational expression is made from the point of the start of one frame for each dot. Therefore, it is necessary that the picture element assembly 30 is sufficiently separated from the optical guide plate 20 at the point of time of the start of the frame. However, there may be the following possibility. That is, the response upon the separation of the picture element assembly 30 becomes slow, due to the slow response during the separation of the picture element assembly 30 or due to any deterioration of the separation performance of the picture element assembly 30 in a time-dependent manner. In the worst case, no separation occurs, while maintaining the state in which the picture element assembly 30 is stuck to the optical guide plate 20.

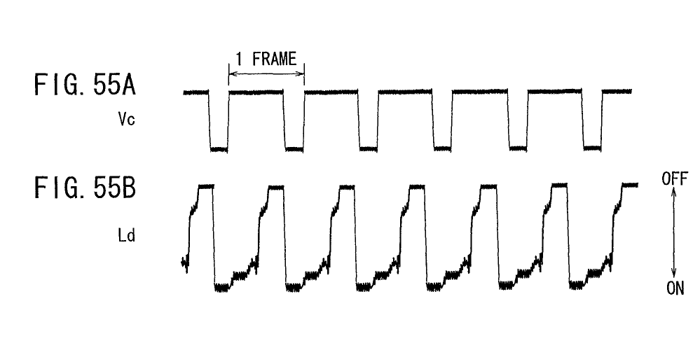

FIGS. 55A and 55B show an experimental result obtained by measuring the light emission characteristic of the dot 26 in the ordinary operation as described above. This experiment was performed such that the change of intensity of light (Ld) scattered from the concerning dot 26 was measured with an avalanche photodiode (APD), while measuring the waveform of the applied voltage Vc to the certain dot 26 (see FIG. 55A). According to FIG. 55B, it is understood that the light emission characteristic slowly goes toward the OFF state from the point of time of the start of one frame, and the OFF response in one frame is slow.

In order to avoid such a situation, for example, when the voltage to be applied to the row electrode 48a is 100 V, it is necessary that the voltage to be applied to the column electrode 48b during the period of the ON signal is 105 V, in order to realize the light emission state during the output period of the ON signal. In this case, it is necessary to increase the voltage resistance of the driver IC 210B. The driver IC 210B is increased in size, and it becomes expensive corresponding thereto.

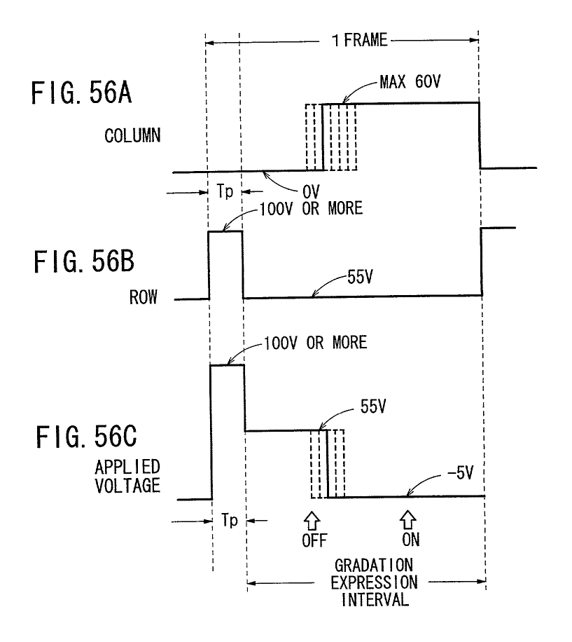

In view of the above, in this embodiment, as shown in FIGS. 56A to 56C, the voltage (separation voltage) to reliably separate all of the dots is applied in an initial predetermined period (preparatory period Tp) of one frame. A period of time of a degree (for example, 1 msec), in which the light emission luminance is scarcely affected, is allotted to the preparatory period Tp, with respect to the entire one frame (for example, 1/60 Hz=16.7 ms).

The preparatory period Tp is started, for example, when one frame is started. For example, 0 V is applied to the column electrodes 48b of all of the dots as shown in FIG. 56A, and the separation voltage, for example, not less than 100 V is applied to the row electrode 48a as shown in FIG. 56B. The difference in electric potential therebetween, i.e., not less than 100 V is applied to all of the dots as shown in FIG. 56C. Accordingly, all of the dots are reliably in the light off state simultaneously with the start of one frame. It is possible to improve the separation characteristic of the picture element assembly 30 without substantially adding any part. It is possible to improve the yield of the display 10.

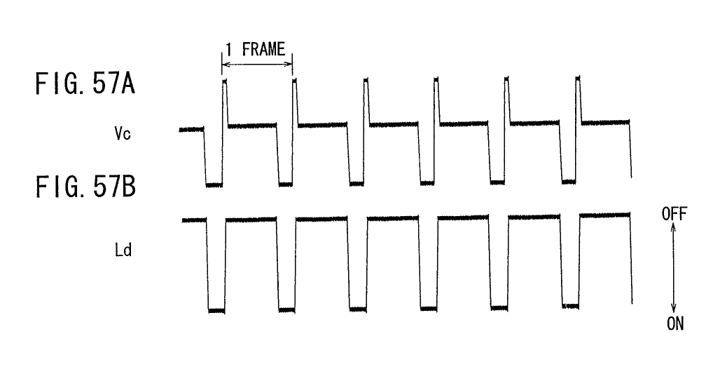

FIGS. 57A and 57B show an experimental result obtained by measuring the light emission characteristic of the dot 26 in the case of the provision of the preparatory period as described above. This experiment was also performed such that the change of intensity of light (Ld) scattered from the concerning dot 26 was measured with an avalanche photodiode (APD), while measuring the waveform of the applied voltage Vc to the certain dot 26 (see FIG. 57A). According to FIG. 57B, it is understood that the light emission characteristic steeply goes toward the OFF state from the point of time of the start of one frame, and the OFF response in one frame is extremely quick.

The separation voltage applied in the preparatory period Tp is generated by the row driver. Accordingly, it is possible to set the voltage which is not less than the voltage resistance of the driver IC 210B, i.e., the voltage which sufficiently displaces the picture element assembly 30 in the separation direction. Therefore, it is unnecessary to change the driver IC 210B.

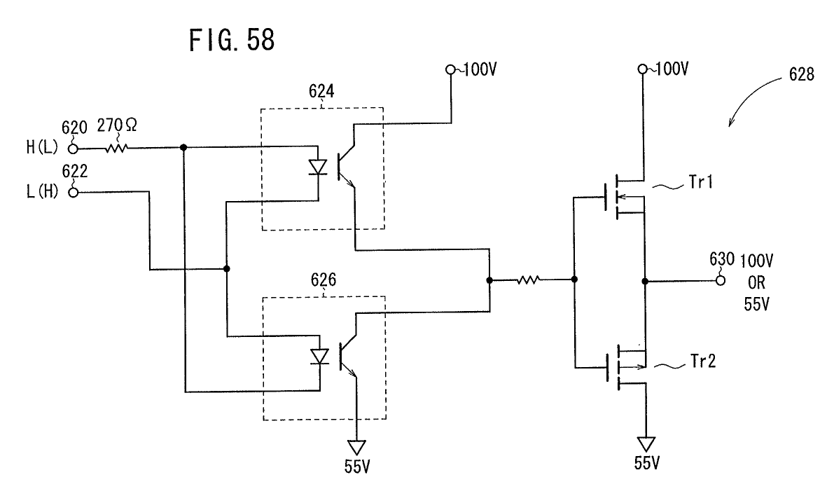

For example, as shown in FIG. 58, the row electrode-driving circuit 202 is a circuit which makes it possible to commonly drive all of the dots, which can be realized easily and inexpensively. The operation of the circuit shown in FIG. 58 will be briefly explained. In the preparatory period Tp, the high level signal is inputted into a first input terminal 620, and the low level signal is inputted into a second input terminal 622. Accordingly, a first photocoupler 624 is in the ON state, and a second photocoupler 626 is in the OFF state. The high level signal is applied to the respective gates of a CMOS transistor 628 disposed at the downstream stage. As a result, an NMOS transistor Trl is turned on, and the high level signal (100 V) is outputted from an output terminal 630.

On the other hand, in the period other than the preparatory period Tp, the low level signal is inputted into the first input terminal 620, and the high level signal is inputted into the second input terminal 622. Accordingly, the first photocoupler 624 is in the OFF state, and the second photocoupler 626 is in the ON state. The low level signal is applied to the respective gates of the CMOS transistor 628 disposed at the downstream stage. As a result, a PMOS transistor Tr2 is turned on, and the low level signal (55 V) is outputted from the output terminal 630.

Further, the number of expressible gradations can be increased by adding the multiple-gradation procedure based on the image processing (for example, the error diffusion method and the dither method) in the subfield driving effected by the driving units 200A, 200C, 200E according to the first, third, and fifth embodiments described above and in the linear subfield driving effected by the driving units 200B, 200D, 200F according to the second, fourth, and sixth embodiments described above.

The respective dots are fixed in the ON state or the OFF state by using only the gradational expression based on the image processing without using the subfield driving and the linear subfield driving as described above. Therefore, it is possible to display a still picture with low electric power consumption. This procedure is preferably used, for example, for an electronic poster. In this case, the dots may be driven and displaced only when the displayed still picture is rewritten with another image. Therefore, it is possible to greatly reduce the electric power consumption.

An area in which a constant still picture is displayed and an area in which a moving picture is displayed are allowed to exist in a mixed manner depending on the display pattern in some cases. In order to respond to such a display pattern, the display controller may be prepared for two lines, i.e., a circuit system corresponding to the moving picture (subfield driving or linear subfield driving) and a circuit system corresponding to the still picture (only gradational expression based on image processing). Accordingly, it is possible to perform the mixed display of moving picture/still picture, while greatly suppressing the electric power consumption.

The display forms as described above are preferred, for example, for the advertisement to which the contents (digital contents and/or analog contents) are delivered, for example, from a central facility of the ground wave, the internet, the telephone line, the artificial satellite, or the cable television.

Especially, when the internet is used, it is preferable that the still picture file or the moving picture file subjected to the compression process is delivered from a central facility for delivering the contents. The file delivered from the central facility is expanded on the side of the display connected to the internet, and it is converted into the display data. In this case, a compressed file decoder circuit may be provided at the upstream stage of the image data processing circuit 224. When an external storage unit such as a hard disk is provided on the display side (contents-receiving side), the image contents may be stored. Upon the display, the image contents may be read from the external storage unit. In this case, the contents delivered from the central facility may be once accumulated in the external storage unit on the display side.

When a plurality of displays and the central facility are connected to one another by means of the internet or the like in accordance with the method as described above, the display of the optimum contents, which conforms, for example, to the installation place of the display and the time zone, can be collectively managed in a centralized manner from the central facility.

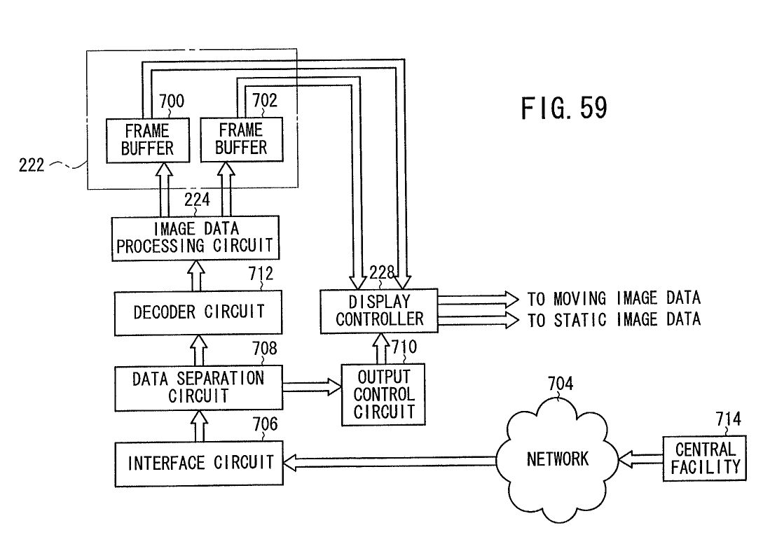

A form of use (display system according to a first embodiment), which realizes the function as described above, will now be explained on the basis of FIG. 59.

As shown in FIG. 59, the display system according to the first embodiment is installed with, for example, a frame buffer 700 for the still picture and a frame buffer 702 for the moving picture as the image memory 222. The display system according to the first embodiment can be realized by providing, for example, an interface circuit 706 for receiving various data from a network 704 to make output to a circuit system disposed at the downstream stage, a data separation circuit 708 for separating the data outputted from the interface circuit 706 into the file concerning the image (still picture file and moving picture file) and the control data, an output control circuit 710 for controlling the display controller 228, for example, in the unit of display component 14 (performing control corresponding to the still picture and control corresponding to the moving picture) on the basis of the control data from the data separation circuit 708, and a compressed file decoder circuit 712 arranged at the upstream stage of the image data processing circuit 224, for expanding the compressed file concerning the image and making restoration into the still picture data and the moving picture data.

Accordingly, the data, which is received by the interface circuit 706 via the network 704 from the central facility 714, is separated by the data separation circuit 708 into the file concerning the image and the control data which are supplied to the compressed file decoder circuit 712 and the output control circuit 710 respectively.

The compressed file decoder circuit 712 expands the supplied file concerning the image to make restoration into the still picture data and the moving picture data which are outputted to the image data processing circuit 224 disposed at the downstream stage. The image data processing circuit 224 stores the restored still picture data in the frame buffer 700 for the still picture, and it stores the moving picture data in the frame buffer 702 for the moving picture.

On the other hand, the output control circuit 710 controls the display controller 228 on the basis of the control data from the data separation circuit 708. In this case, for example, the address data for the display component 14 for displaying the still picture can be used as the control data. The output control circuit 710 separates the data transfer section 230 and the first and second reading circuits 232, 234 in the display controller 228 into those for the still picture and for the moving picture on the basis of the control data.

Accordingly, the still picture data is read from the frame buffer 700 for the still picture by the circuit system designated for the still picture, of the display controller 228. The still picture is displayed by the aid of a plurality of display components 14 indicated by the address data. The animation image data is read from the frame buffer 702 for the moving picture by the circuit system designated for the moving picture. The moving picture is displayed by the aid of a plurality of display components 14 other than the plurality of display components 14 indicated by the address data.

Further, a display system according to a second embodiment is also available. That is, for example, the power source current is monitored in each of the displays 10. Obtained results are periodically transmitted to the central facility 714 as the status information of the respective displays 10.

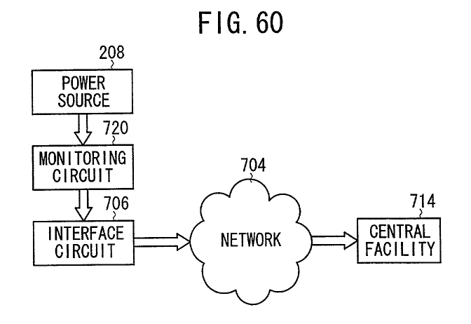

As shown in FIG. 60, this arrangement is realized by providing a monitoring circuit 720 for the power source 208, and providing an interface circuit 706 for transmitting the output of the monitoring circuit 720 as the status information. Accordingly, it is possible to manage whether or not a plurality of displays 10 disposed at remote locations are out of order, from the central facility 714.

Next, a display system according to a third embodiment corrects the decrease in luminance which is caused in a time-dependent manner. That is, when the display is driven for a long period of time, it is feared that the ON characteristic of the dot (characteristic of the picture element assembly 30 to make contact with the first principal surface of the optical guide plate 20) is deteriorated as the elapse of time, and the decrease in display luminance is caused. In order to avoid such an inconvenience, the display luminance can be maintained at approximately the same level as that of the initial stage by decreasing the ON voltage of the dot (increasing the absolute value).

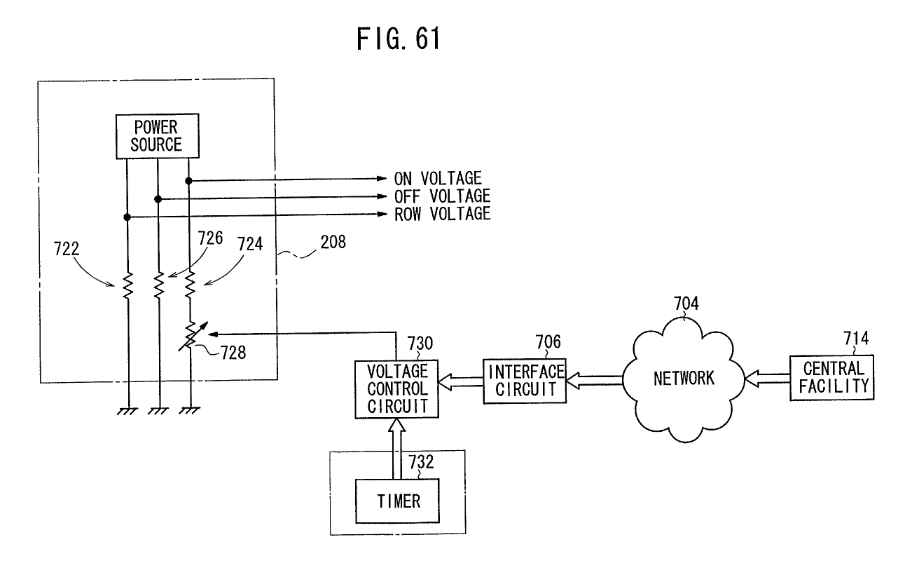

A specified circuit arrangement is shown in FIG. 61. That is, the arrangement makes it possible to generate a variable voltage, for example, in an ON voltage-generating system 724 of various voltage-generating systems installed in the power source 208 (a row voltage-generating system 722 for generating the row voltage to be applied to the row electrode 48a, an ON voltage-generating system 724 for generating the ON voltage to be applied to the column electrode 48b, and an OFF voltage-generating system 726 for generating the OFF voltage to be applied to the column electrode 48b). The embodiment shown in FIG. 61 is illustrative of a case in which a variable resistor 728 is provided. An interface circuit 706 for receiving the information concerning the voltage change from the central facility 714, and a voltage control circuit 730 for controlling the variable resistor 728 to set the ON voltage to a desired voltage on the basis of the information from the interface circuit 706 are provided at the upstream stage of the power source 208.

The central facility 714 manages the result of the measurement performed with the display 10 to be used to monitor the decrease in luminance in a factory. The information concerning the voltage change is transmitted via the network 704 to the display 10 which conforms to the timing at which the luminance is decreased, of the displays 10 installed at the respective districts. On the side of the display 10, the information from the central facility 714 is received via the interface circuit 706, and the ON voltage, which is generated by the ON voltage-generating system 724, is changed to a desired voltage.

For example, when the row voltage is 50 V and the ON voltage is 50 V at the point of time of installation, then 0 V is applied to the dot if the ON operation is to be performed. The information on the voltage change is supplied at the timing at which the luminance begins to be lowered due to the time-dependent change. Accordingly, the ON voltage is changed, for example, to 52 V. Accordingly, −2 V, which is lower than 0 V, is applied to the dot which is to perform the ON operation. The picture element assembly 30 makes further displacement toward the optical guide plate 20. Thus, the luminance in the ON state is improved.

The information on the voltage change is supplied again at the timing at which the luminance is lowered as the time further elapses. Accordingly, the ON voltage is changed, for example, to 54 V. Accordingly, −4 V, which is lower than 0 V, is applied to the dot which is to perform the ON operation. The picture element assembly 30 makes further displacement toward the optical guide plate 20. Thus, the luminance in the ON state is improved.

In the form of use described above, the timing, at which the luminance is lowered, is deduced by using the monitoring display 10 in the factory. Alternatively, the following method is also preferably adopted. That is, a manager at the operation site is made to communicate the fact that the luminance is lowered, by using, for example, electronic mail or telephone. Based on the communication of the decrease in luminance, the information on the voltage change is transmitted from the central facility 714 to the concerning display 10.

The embodiment described above is illustrative of the case in which the remote control is performed by using the network 704. Of course, it is also preferable that the display 10 itself is allowed to have a function to change the voltage. For example, the temporal information to indicate the timing of the decrease in luminance and the voltage value to be supplied to the variable resistor 728 are previously stored in a plurality of registers installed in the voltage control circuit 730 respectively. When the temporal information from a timer 732 (see FIG. 61) connected to the upstream stage of the voltage control circuit 730 coincides with one of the temporal information in the registers, the variable resistor 728 is controlled by the voltage value stored in the concerning register to give a desired ON voltage. Thus, it is possible to suppress the decrease in luminance.

Alternatively, another embodiment is also available. That is, for example, a dummy actuator element 22 is constructed and incorporated into the display component 14 arranged at the periphery of the display screen beforehand. The displacement state of the actuator element 22 is detected with a sensor (for example, a strain gauge). It is judged whether or not the luminance is lowered on the basis of the displacement upon the ON operation in the dummy actuator element 22.

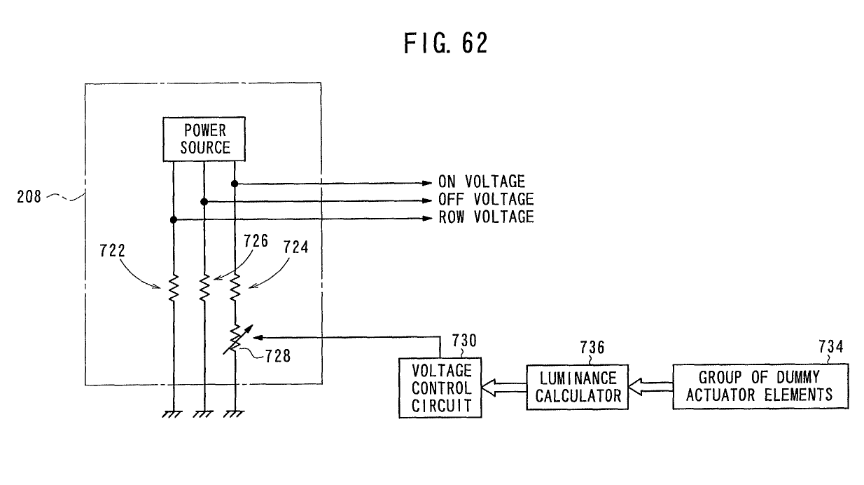

The following judgement technique is available as shown in FIG. 62. That is, detection signals, which are outputted by the aid of the sensors respectively from a group 734 of a large number of dummy actuator elements 22, are supplied to a light emission luminance calculator 736. The light emission luminance calculator 736 is used to approximately calculate the luminance of the entire display screen from the flux of the detection signals. On the other hand, a threshold value is stored in a register in the voltage control circuit 730. The voltage control circuit 730 judges that the entire luminance is lowered, when the approximate value supplied from the light emission luminance calculator 736 is decreased to be lower than the threshold value. The variable resistor 728 of the ON voltage-generating system 724 is controlled to give a desired ON voltage. Accordingly, it is possible to maintain the light emission luminance to be in the initial state.

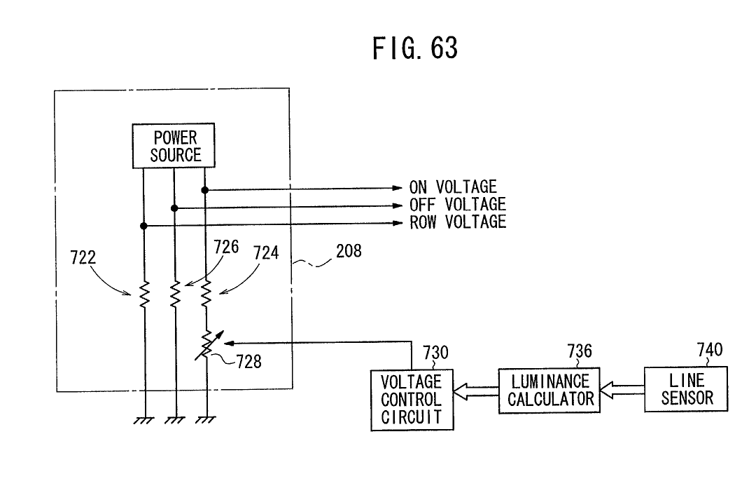

As still another embodiment, the following technique is also adopted preferably as shown in FIG. 63. That is, a line sensor 740, which is movable rightwardly and leftwardly on the display plane of the display 10, is installed. The line sensor 740 is periodically driven, while performing the white display on the display 10. The light emission luminance is detected with the line sensor 740.

Also in this case, the image pickup signal, which is successively outputted from the line sensor 740, is supplied to the light emission luminance calculator 736. The light emission luminance calculator 736 is used to calculate the luminance of the entire display screen on the basis of the image pickup signals continuously supplied. A threshold value is stored in a register in the voltage control circuit 730. It is judged that the entire luminance is lowered when the calculated value supplied from the light emission luminance calculator 736 is decreased to be lower than the threshold value. The variable resistor 728 of the ON voltage-generating system 724 is controlled to give a desired ON voltage. Accordingly, it is possible to maintain the light emission luminance to be in the initial state.

The embodiment described above is illustrative of the case in which the luminance is corrected by controlling the ON voltage applied to the column electrode 48b. Alternatively, the correction of the luminance can be also realized by controlling the light source 16 (display system according to a fourth embodiment).

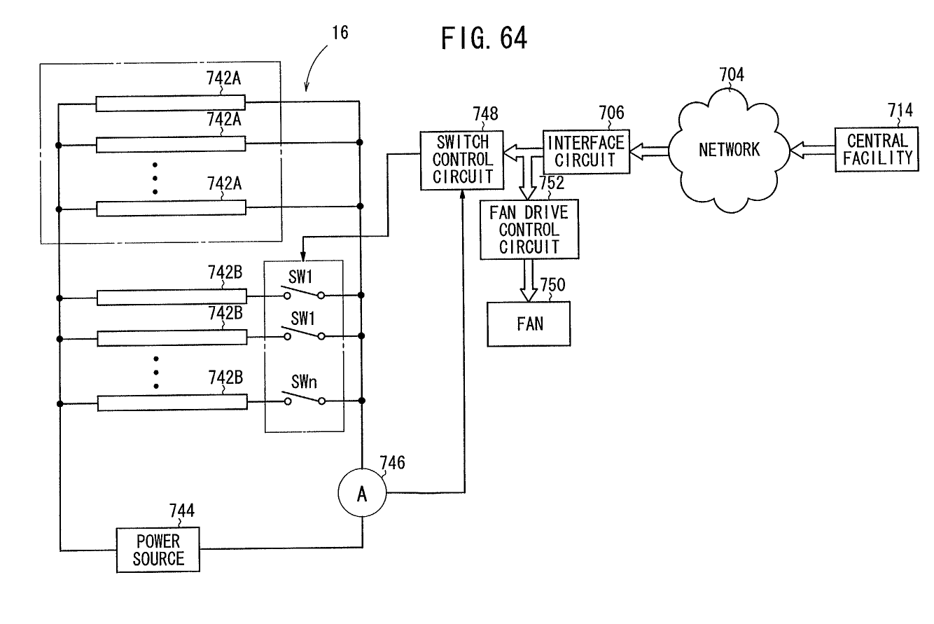

As shown in FIG. 64, for example, when a cold cathode tube or the like is used as the light source 16, one light source 16 can be constructed by bundling a plurality of cold cathode tubes 742 and installing them in a reflector (not shown). In this case, in addition to a prescribed number (for example, twelve) of cold cathode tubes 742A, a plurality (for example, four) of preparatory cold cathode tubes 724B are installed. Switches Sw1, Sw2, . . . , Swn are inserted and connected beforehand between the preparatory cold cathode tubes 724B and the power source 744 respectively. The current of the light source 16 is monitored by using a current-detecting means 746. It is judged whether or not the amount of light emitted from the light source 16 is lowered, on the basis of the current value supplied from the current-detecting means 746. When the current is lowered, a switch, which corresponds to a predetermined number (for example, one) of cold cathode tube 742B of the preparatory cold cathode tubes 742B, is turned on by the aid of a switch control circuit 748 to increase the light amount.

Of course, the following technique may be adopted to correct the luminance by the aid of the light source 16. At first, a manager at the operation site is made to communicate the fact that the luminance is lowered. Based on the communication, the information that the luminance is to be corrected is delivered from the central facility 714 via the network. The concerning display 10 receives the information by the aid of the interface circuit 706 to supply the information to the switch control circuit 748. The switch control circuit 748 turns on the switch corresponding to a predetermined number (for example, one) of cold cathode tube 742B of the preparatory cold cathode tubes 742B on the basis of the supplied information. Accordingly, the light amount of the light source 16 is increased, and the luminance is improved.

It is known that the fading of the fluorescent pigment of the color filter proceeds as the time of use elapses. Especially, it is known that the fading of the blue color filter proceeds. Accordingly, at least one cold cathode tube to emit blue light is installed as the preparatory cold cathode tube 742B beforehand. Based on the communication from the operation site that the fading occurs, the blue cold cathode tube as the preparatory one may be turned on.

In addition to the selective turning on of the preparatory cold cathode tube 742B, the output of a fan 750 for cooling the light source 16 may be adjusted. Accordingly, it is possible to suppress any quick temperature change, and it is possible to use the system for a long period of time. Further, it is possible to suppress the uneven illuminance or the like which would be otherwise cause by the temperature change. In this case, as shown in FIG. 64, for example, it is also preferable to provide a fan drive control circuit 752 for driving and controlling the fan 750 on the basis of the information concerning the selective turning on from the interface circuit 706.

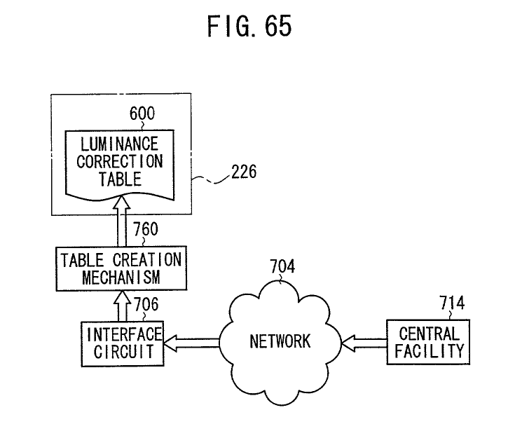

The embodiment described above is illustrative of the case in which the luminance is adjusted by controlling the peripheral units of the display controller 228. Alternatively, as shown in FIG. 65, the luminance may be adjusted by changing the value in the luminance correction table 600 logically allotted in the correction data memory 226 of the display controller 228 (display system according to a fifth embodiment).

In this case, as shown in FIG. 65, a group of luminance correction values, which are to be used when the luminance is lowered, are transmitted via the network 704, for example, from the central facility 714 to the concerning display 10 at the point of time at which the luminance of the certain display 10 is lowered. The concerning display 10 receives the correction values from the central facility 714 via the interface circuit 706. A table creation mechanism 760, which is disposed at the downstream stage, prepares a new luminance correction table on the basis of the received correction value. The luminance correction table 600 having been stored in the correction data memory 226 is rewritten therewith.

The respective dots are operated so that the decrease in luminance is suppressed in accordance with the various luminance correction values supplied from the new luminance correction table 600. Therefore, it is possible to maintain the display luminance at approximately the same level as that at the initial stage.

The technique for rewriting the luminance correction table 600 is not limited to the procedure based on the supply from the central facility 714. In the same manner as in FIG. 61, a new luminance correction table 600 may be prepared by the table creation mechanism 760 on the basis of the temporal information from the timer 732. Alternatively, in the same manner as in FIGS. 62 and 63, a new luminance correction table 600 may be prepared by the table creation mechanism 760 on the basis of the calculated value outputted from the group 734 of dummy actuator elements 22 or the line sensor 740 by the aid of the light emission luminance calculator 736.

When the luminance correction table 600 is rewritten, then the compensating means for the luminance decrease is not only effected, but also the white balance caused by the fading can be compensated. For example, when the blue color is subjected to fading, the luminance correction coefficient is rewritten so that the luminance level is improved for only the blue color. By doing so, it is possible to maintain the white balance at approximately the same level as that at the initial stage.

As described above, the maintenance for the display 10 can be performed by utilizing the network 704 or automatically in a self-diagnosis manner by adopting the display systems according to the second to fifth embodiments shown in FIGS. 60 to 65. Usually, in the maintenance for the display 10 arranged with a large number of display components 14, a maintenance operator goes hurriedly to the operation site in principle to perform the repair even in the case of the simple operation. Therefore, the cost required for the maintenance is enormous, which is unfavorable to popularize the display 10.

However, when the display systems according to the second to fifth embodiments described above are adopted, the simple maintenance operation such as the luminance adjustment can be automatically performed. It is possible to greatly reduce the cost required for the maintenance. When the maintenance charge is set depending on the various forms of use even in the case of one type of the luminance adjustment, it is possible to provide careful maintenance service. It is possible to contribute to the popularization of the display 10.

The display 10 according to the embodiment of the present invention has a wide angle of visibility of approximately 180° owing the principle that the scattered light is emitted from the optical waveguide plate 12. Further, it is possible to obtain the wide angle of visibility without substantially lowering the luminance.

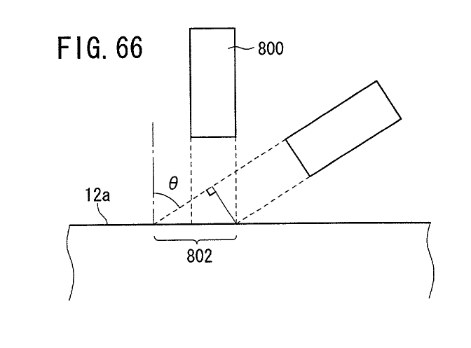

An illustrative experiment will now be explained. This illustrative experiment relates to Working Example and Comparative Example in which the luminance value was measured at an angle of visibility of θ. The luminance measurement was performed as shown in FIG. 66. That is, the luminance was measured with a luminance meter 800 with the angle of visibility θ as a parameter for a certain area on the display surface 12a of the display. In Working Example, the display 10 was constructed in the same manner as in the embodiment of the present invention. In Comparative Example, an ordinary CRT was used.

As shown in FIG. 66, the larger the angle of visibility θ is, the larger the aerial size 802 measured by the luminance meter 800 is. As for the luminance value at the angle of visibility θ, assuming that the measured value obtained with the luminance meter 800 is Ka [cd/m²], the corrected luminance value dKa, which is obtained with a constant aerial size of the measurement, is Ka×sin(90°-|θ|).

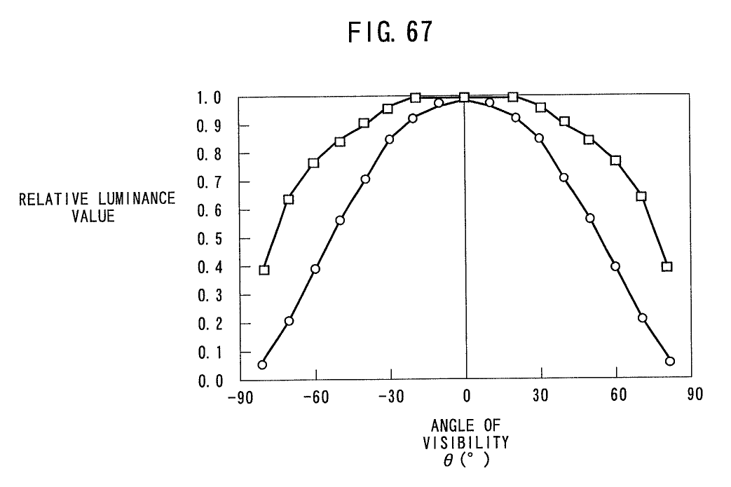

A result of the measurement is shown in FIG. 67. FIG. 67 is obtained by plotting the corrected luminance values dKa. It is understood that Working Example (indicated by squares) has a wide angle of visibility of approximately 180°, in which the luminance is scarcely lowered, and the wide angle of visibility is obtained, as compared with the Comparative Example (indicated by circles).

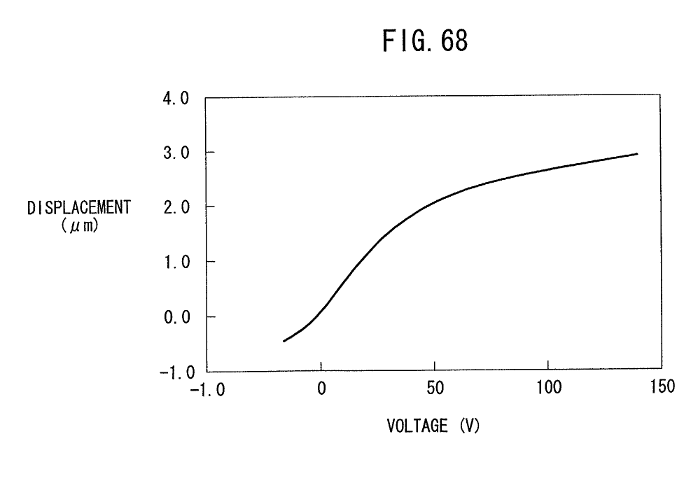

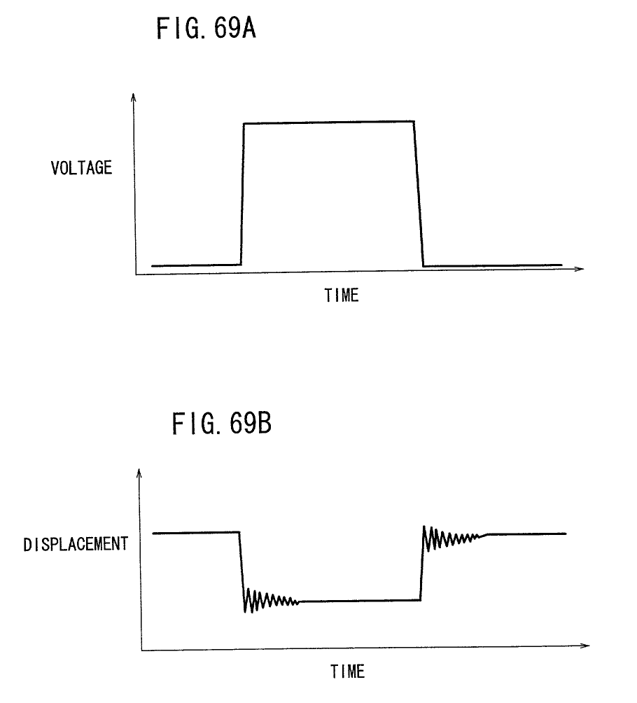

The actuator element 18 has the displacement characteristic as shown in FIG. 68 with respect to the applied voltage. In this case, the positive direction of the displacement corresponds to the separation direction of the picture element assembly 30. The response characteristics of the actuator element 18 are shown in FIGS. 69A and 69B. FIG. 69A shows the voltage waveform applied to the actuator element 18, in which the control is made such that the applied voltage rises from 0 V to 60 V, and then it falls from 60 V to 0 V. In this case, any one of the rising time and the falling time is 5 μsec.

FIG. 69B shows the change of the displacement of the actuator element 18 with respect to the applied voltage. It is understood that the displacement is made downwardly by about 2 μm at the stage at which the applied voltage is 60 V.

According to the displacement characteristic of the actuator element 18 shown in FIG. 68, it is understood that the displacement of not less than the wavelength of visible light is realized at the voltage resistance of the driver IC of the fluorescent display tube or LCD, and thus the ON/OFF operation of the picture element assembly 30 is achieved.

According to the response characteristics shown in FIGS. 69A and 69B, it is understood that the full colors, in which each color has not less than 256 gradations, are achieved by only the temporal gradation.

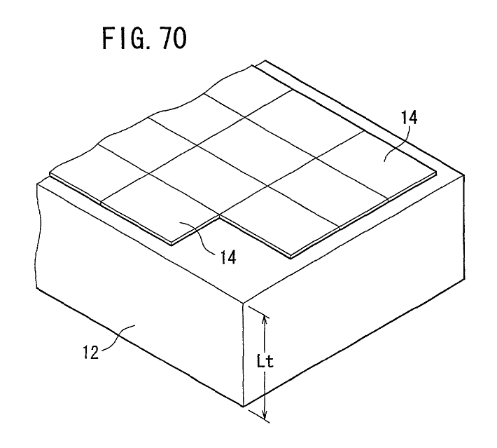

As shown in FIG. 70, the display 10 according to the embodiment of the present invention is a display based on the so-called divided panel system constructed by mutually sticking a large number of display components 14 to the optical guide plate having a large size. Therefore, it is possible to freely design, for example, the size of the screen, the aspect ratio, the shape, and the resolution.

As shown in FIG. 70, the thickness of the display 10 is dominantly determined by the thickness Lt of the large-sized optical waveguide plate 12 (for example, an acrylic plate), rather than the thickness of the display component 14. Therefore, it is possible to construct a thin type large screen display. For example, it is possible to realize a thickness of 10 to 13 cm in the case of a display of 80-inch type.

In the display 10 according to the embodiment of the present invention, the picture element assembly 30 is formed by using a color material composed of a pigment, a staining material, a fluorescent pigment, or a combination thereof, for example, by means of the thick film printing. Accordingly, it is possible to inexpensively provide the chromaticity which is uniform over all of the display components 14 stuck to the optical guide plate.

For example, when a white picture element is formed in addition to those of the three primary colors of red, green, and blue, the letters are preferably displayed with a high luminance. Further, other colors can be also formed.

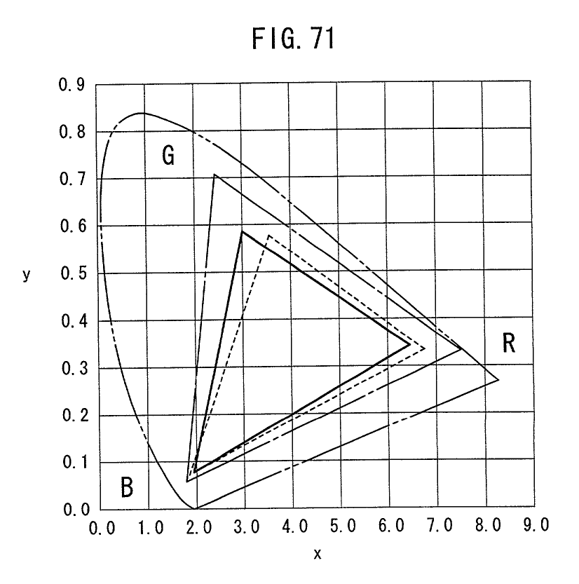

As shown in FIG. 71, the chromaticity characteristic, which is possessed by the display 10 according to the embodiment of the present invention, is a characteristic corresponding to that of CRT. In FIG. 71, solid lines indicate the chromaticity characteristic of the display 10 according to the embodiment of the present invention, broken lines indicate the chromaticity characteristic of CRT, dashed lines indicate the chromaticity characteristic based on the NTSC standard, and two-dot chain lines indicate CIE.

The display 10, which is constructed by arranging a large number of display components 14, is preferably used, for example, for a display board which is installed at a shopfront of a retail store or in an automatic vending machine.

That is, the currently used display board uses a display constructed by arranging a large number of LED's. However, in this case, it is necessary to prepare the display data with an exclusive interface and an exclusive software, because of the following reason. That is, the display, which is constructed by arranging a large number of LED's, has a low resolution. Therefore, for example, when letters are displayed, it is necessary to edit the letter data into a data structure in which LED's to be turned on are designated one by one.

Further, in the case of LED, the following problem arises. That is, if the resolution is increased, then it is necessary to use more LED chips corresponding thereto, and thus the price becomes expensive.

The conventional display based on LED with a dot pitch of 6 to 9 mm is capable of displaying letters and simple patterns. However, the conventional display involves such problems that it is impossible to make colorful display including, for example, computer graphics and complicated patterns, and it is necessary to provide a control unit and a picture element memory to make connection to the exclusive interface.

On the other hand, in the display 10 according to the embodiment of the present invention, the actuator element 18 is formed in an integrated manner on the actuator substrate 32, and the picture element assemblies 30 corresponding to the respective colors are also formed in an integrated manner by means of the printing. Therefore, it is possible to inexpensively manufacture a display screen having a high resolution, for example, with a dot pitch of 2 to 3 mm. Further, any message, which is prepared with a DTP software for the personal computer, can be incorporated as it is. It is unnecessary to use any exclusive software. That is, it is enough to use a general-purpose PC interface.

The display 10 according to the embodiment of the present invention is a display based on the so-called divided panel system in which a large number of display components 14 are arranged. Therefore, it is possible to realize the following illustrative arrangements and forms of use.

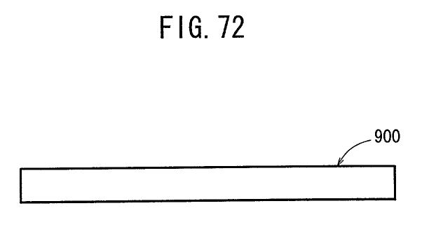

At first, as shown in FIG. 72, a first illustrative arrangement resides in a case in which a display 900 which is slender in the lateral direction or the longitudinal direction is provided. A form of use based on the display 900 is such that the display 900 is installed, for example, on a wall of a passage, and a sensor for sensing a passing person is also installed.

A person passing beside the display 900 is sensed by the sensor. A message such as an advertisement is scroll-displayed in conformity with the advancing direction of the person. Accordingly, a form is realized, in which the message displayed on the display 900 follows in conformity with the advance of the person.

As shown in FIG. 73, a second illustrative arrangement resides in a case in which a large number of display components 14 are stuck, in a variety of combinations, to a large-sized optical waveguide plate 12. The case shown in FIG. 73 is illustrative of an example in which a laterally long display block 902 constructed by combining a large number of display components 14, and a display block 904, for example, of a wide type of 16:9 obtained by combining a large number of display components 14 are stuck to a large-sized optical waveguide plate 12. A small-sized laterally long display block 906, which is constructed by combining several tens of displays, may be fitted to an arbitrary position of the wide type display block 904.

The laterally long display block 902 and the small-sized laterally long display block 906 are used, for example, as message display areas of single color (for example, white color). The wide type display block 904 is used, for example, as a high definition color moving picture display area.

In this case, in the laterally long display block 902 and the small-sized laterally long display block 906, it is possible to obtain a high luminance even when the row scanning is performed, because the white picture element has a high light emission efficiency. Therefore, it is enough to incorporate the driver IC's of 1/(number of row scanning). As for the interface, RS-422 or 485 or LAN may be used to display a still picture based on JPEG. When the high definition is unnecessary, the picture element size may be increased.

On the other hand, the wide type display block 904 displays the high definition moving picture. Therefore, it is preferable to use the driving units 200A to 200F according to the first to sixth embodiments described above. In this case, as for the interface, those corresponding to the video signal and the RGB signal can be used. Further, a moving picture based on MPEG may be displayed by means of LAN.

In place of the small-sized laterally long display block 906, a simple display board (for example, a board on which a logotype of an advertisement owner is displayed) may be stuck.

Conventionally, in order to obtain a message display area and a moving picture area with one large screen display, it is necessary to combine three of an LED display for displaying letters, a high definition PDP for color moving picture, and a fixed message advertisement board. However, in the second illustrative arrangement described above, it is possible to easily manufacture the display which simultaneously has both of the message display area and the moving picture area by combining the large number of display components 14 in various forms.

In the display of the so-called divided panel system constructed by sticking the large number of display components 14 to the large-sized optical waveguide plate 12 as in the display 10 according to the embodiment of the present invention, it is possible to freely design the number, the amount, and the sticking positions of the display components 14 stuck to the optical waveguide plate 12. Therefore, for example, the size of the display 10, the aspect ratio, and the shape can be freely designed.

The embodiment described above is illustrative of the case in which the optical waveguide plate 12 having the flat principle surface is used as the optical waveguide plate 12 as shown in FIG. 1. Alternatively, an optical waveguide plate, in which the principle surface has a curved surface, may be used.

When such an optical waveguide plate is used, it is possible to respond to the shape standard for the display principally based on the curved surface or the installation space. For example, the curved surface is required for a large screen display for displaying celestial bodies in the planetarium. It is also possible to respond to such a display. In this case, it is necessary to control the angle of incidence so that the light incoming from the end surface of the optical waveguide plate does not leak from the principal surface having the curved surface configuration.

When the display principle of the display 10 according to the embodiment of the present invention is used, it is possible to exactly construct an optical switch which performs ON/OFF of light output and selective light output. That is, it is possible to construct an optical switch comprising an optical waveguide to function as an optical waveguide passage into which light is introduced to be transmitted without any leakage, and a driving section which is provided opposingly to one side of the optical waveguide and which is arranged with actuator elements of a number corresponding to one or a large number of optical switch contacts, wherein light output is turned ON/OFF and the light is selectively led to only a specified output by controlling a displacement action of the actuator element in a direction to make contact or separation with respect to the optical waveguide in response to an optical switch control signal to be inputted so that leakage light is controlled at a predetermined portion of the optical waveguide.

It is a matter of course that the display system and the method for managing the display according to the present invention are not limited to the embodiments described above, which may be embodied in other various forms without deviating from the gist or essential characteristics of the present invention.

As explained above, according to the display system and the method for managing the display according to the present invention, it is possible to make the display in which the still picture and the moving picture exist in the mixed manner.

Further, it is possible to easily perform the maintenance, for example, for the single large screen display or a plurality of the large screen displays, for example, by the aid of the network. It is possible to contribute to the popularization of the large screen display.

What is claimed is:

1. A display system comprising:
a display; and
a display area-separating section for separating a display area of said display into a moving picture display area and a still picture display area.

2. The display system according to claim 1, wherein:
said display is constructed by arranging a large number of display components; and
said display area-separating section separates said display area of said display into said moving picture display area and said still picture display area on the basis of address data to indicate said display components.

3. The display system according to claim 1, wherein said display area-separating section is subjected to collective centralized control by a central facility connected to a network.

4. The display system according to claim 1, wherein said display is a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate.

5. A display system comprising:
a display;
a monitoring section for monitoring a power source current of said display; and
a collective failure-diagnosing section for transmitting status information obtained by said monitoring section via a network to a central facility.

6. The display system according to claim 5, wherein said display is a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate.

7. A display system comprising:
a display; and
a driving voltage-adjusting section for adjusting a driving voltage supplied to said display to compensate decrease in luminance.

8. The display system according to claim 7, wherein said driving voltage-adjusting section is subjected to collective centralized control by a central facility connected to a network.

9. The display system according to claim 7, wherein said driving voltage-adjusting section is schedule-managed by the aid of a timer.

10. The display system according to claim 7, wherein:
said display is a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate; and
said driving voltage-adjusting section adjusts said driving voltage on the basis of a displacement state of arbitrary one of said actuator elements.

11. The display system according to claim 7, wherein said driving voltage-adjusting section adjusts said driving voltage on the basis of a light emission luminance in a predetermined state of said display.

12. The display system according to claim 11, wherein said display is a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate.

13. A display system comprising:
a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate;
a preliminary light source;
a current-monitoring section for monitoring a current of said light source; and
a preliminary light source control unit for selectively turning on or turning off said preliminary light source on the basis of information from said current-monitoring section.

14. The display system according to claim 13, wherein a part or all of said preliminary light sources are a preliminary light source provided for the purpose of countermeasure for fading.

15. The display system according to claim 13, further comprising:
a cooling fan; and
a cooling control unit for selectively driving said cooling fan on the basis of selective turning on of said preliminary light source.

16. A display system comprising:
a display;
a memory for storing luminance correction data for correcting a luminance dispersion of said display; and
a table creation mechanism for rewriting said luminance correction data.

17. The display system according to claim 16, wherein said table creation mechanism is subjected to collective centralized control by a central facility connected to a network.

18. The display system according to claim 16, wherein said table creation mechanism is schedule-managed by the aid of a timer.

19. The display system according to claim 16, wherein:
said display is a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate; and
said table creation mechanism rewrites said luminance correction data on the basis of a displacement state of arbitrary one of said actuator elements.

20. The display system according to claim 16, wherein said table creation mechanism rewrites said luminance correction data on the basis of a light emission luminance in a predetermined state of said display.

21. The display system according to claim 20, wherein said display is a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate.

22. The display system according to claim 16, wherein said table creation mechanism rewrites said luminance correction data also in consideration of color balance adjustment.

23. A display system comprising:
a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate, and wherein said actuator element makes said displacement action in a first direction when a voltage of positive polarization or negative polarization with respect to a reference electric potential is applied; and
a switching means for making changeover to said voltage of positive polarization or said voltage of negative polarization at an arbitrary timing.

24. The display system according to claim 23, wherein said switching means is subjected to collective centralized control by a central facility connected to a network.

25. The display system according to claim 23, wherein said switching means is schedule-managed by the aid of a timer.

26. A method for managing a display wherein:
said display is constructed by arranging a large number of display components; and
a display area of said display is separated into a moving picture display area and a still picture display area on the basis of address data to indicate said display component supplied from a central facility connected to a network.

27. The method for managing said display according to claim 26, wherein said display is a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate.

28. A method for managing a display comprising:
monitoring a power source current of said display; and
transmitting status information obtained by said monitoring to a central facility via a network.

29. A method for managing a display comprising adjusting a driving voltage supplied to said display to compensate decrease in luminance on the basis of collective centralized control by a central facility connected to a network or by schedule management by the aid of a timer.

30. A method for managing a display comprising rewriting luminance correction data in order to correct a luminance distribution of said display on the basis of collective centralized control by a central facility connected to a network or by schedule management by the aid of a timer.

31. A method for managing a display comprising:
using a display comprising an optical guide plate for introducing light from a light source thereinto, and a driving section provided opposingly to a first plate surface of said optical guide plate and arranged with actuator elements of a number corresponding to a large number of picture elements, wherein a screen image corresponding to an image signal is displayed on said optical guide plate by controlling a displacement action of said actuator element in a direction to make contact or separation with respect to said optical guide plate in accordance with an attribute of said image signal to be inputted so that leakage light is controlled at a predetermined portion of said optical guide plate, and wherein said actuator element makes said displacement action in a first direction when a voltage of positive polarization or negative polarization with respect to a reference electric potential is applied; and
making changeover to said voltage of positive polarization or said voltage of negative polarization at an arbitrary timing on the basis of collective centralized control by a central facility connected to a network or by schedule management by the aid of a timer.
